(19) United States
(12) Patent Application Publication
(10) Pub. No.: US 2026/0153960 A1
(43) Pub. Date: Jun. 4, 2026

(54) INPUT SYSTEM

(71) Applicant: HiDeep Inc., Seongnam-si (KR)

(72) Inventors: Seyeob KIM, Seongnam-si (KR); Bonkee KIM, Seongnam-si (KR); Yunjoung KIM, Seongnam-si (KR); Chongkuk PAEK, Seongnam-si (KR); Kiung KIM, Seongnam-si (KR); Mun Sub BYUN, Seongnam-si (KR); Kiryoung JUNG, Seongnam-si (KR)

(73) Assignee: HiDeep Inc., Seongnam-si (KR)

(21) Appl. No.: 19/408,449

(22) Filed: Dec. 4, 2025

(30) Foreign Application Priority Data
Dec. 4, 2024 (KR) 10-2024-0178951

(51) Int. Cl. G06F 3/041; G06F 3/0354; G06F 3/044; G06F 3/046

(52) U.S. Cl. CPC G06F 3/04166; G06F 3/03545; G06F 3/04162; G06F 3/04164; G06F 3/0418; G06F 3/0446; G06F 3/046; G06F 2203/04106; G06F 2203/04108

(57) ABSTRACT

The present disclosure relates to an input system, and more particularly, to an electronic device capable of sensing a stylus pen together with an object such as a finger that is in proximity or in contact with the outside, and an input system including a stylus pen including a ferrite core for a stylus pen capable of improving the magnitude of a pen signal received by the electronic device.

### CROSS-REFERENCE TO RELATED APPLICATIONS

The present application claims priority under 35 U.S.C. § 119 to Korean Patent Application No. 10-2024-0178951, filed Dec. 4, 2024, the entire contents of which are hereby incorporated by reference.

### BACKGROUND

The present disclosure relates to an input system, and more particularly, to an electronic device capable of sensing a stylus pen together with an object such as a finger that is in proximity or in contact with the outside, and an input system including a stylus pen including a ferrite core for a stylus pen capable of improving the magnitude of a pen signal received by the electronic device.

The smartphone or the tablet PC generally includes a touch screen, and a user may use a finger or a stylus pen to designate specific coordinates on the touch screen. The user may input a specific signal to the smartphone by designating specific coordinates on the touch screen.

Typically, the R-type touch screen capable of simultaneously recognizing a finger of a user and a stylus pen are widely used. However, the R-type touch screen has a limitation of reflection caused by an air layer between ITO layers. Accordingly, in recent years, the C-type touch screen is increasingly applied. The C-type touch screen operates in a method of sensing a difference between capacitances of transparent electrodes generated by contact of an object. However, the C-type touch screens has a disadvantage of generating an operational error caused by unintended contact of a hand when using a stylus pen because it is difficult to physically distinguish between the object such as the finger and the stylus pen.

Typically, in order to overcome the disadvantage, separate software that distinguishes the hand from the stylus pen based on a contact area is used, or a position measurement device in an electromagnetic resonance (EMR) method is used to distinguish the hand from the stylus pen. Here, the EMR method has an advantage of being insensitive to a display and an external noise by using a magnetic field instead of an electric field as driving force when using a touch function with the stylus pen while a touch and a display operate, thus having the advantage of being insensitive to the display and external noise.

However, the EMR method requires attaching a sensor film manufactured by using an additional separate FPCB to a bottom surface of a display panel to generate and transmit a magnetic field to the stylus pen and receive a magnetic field generated by the stylus pen again.

The sensor film is also referred to as a digitizer. When a position of the stylus pen that generates a magnetic field is changed, a separate integrated circuit detects the change of the magnetic field generated by an interaction.

FIG. 1 is a view for explaining a foldable device that is an example of the typical electronic device.

Referring to FIG. 1, the foldable device has at least one inner screen and at least one outer screen. The foldable device includes an inner touch screen 20 to realize the inner screen and an outer touch screen 25 to realize the outer screen. Also, the foldable device includes digitizers 30 and 35 disposed below inner/outer touch screens 20 and 25 for driving and sensing the stylus pen 10.

The stylus pen 10 in the inductive resonance method that is one kind of passive stylus pens receives an electromagnetic signal from the digitizers 30 and 35, and the digitizers 30 and 35 receive a resonance signal emitted from the stylus pen 10.

A coil to which a current is inducible by the electromagnetic signal to receive the electromagnetic signal from the stylus pen 10 is densely arranged on the digitizers 30 and 35. Since the foldable device further includes the digitizers 30 and 35 for respective inner/outer touch screens 20 and 25, there are a limitation in downsizing and slimness of the entire device and a limitation in designing a flexible inner structure.

Also, since a magnetic shielding material (not shown) and a copper layer (not shown), each of which has a predetermined thickness, are additionally attached on the bottom surface of each of the digitizers 30 and 35, there is an additional limitation in reducing a thickness of the entire device.

Particularly, although most of currently available foldable smartphones have the touch screens 20 and 25 on both an outer surface and an inner surface, respectively, based on a folded shape, a stylus function is supported only to the touch screen 20 on the inner surface and is not supported to the touch screen 25 on the outer surface. This is because the thickness of the entire device and manufacturing costs thereof increase when the digitizers 30 and 35 are attached to the bottom surfaces of the inner touch screen 20 and the outer touch screen 25, respectively, as illustrated in FIG. 1 to operate the stylus pen 10 in the EMR method.

A stylus pen is a pen-shaped device capable of inputting data by lightly touching a screen while dragging or clicking on the screen. A user may use the stylus pen for a precise touch input.

The stylus pen may be classified into an active stylus pen and a passive stylus pen depending on whether the stylus pen includes a battery and an electronic component therein.

In recent years, however, technologies of an electro magnetic resonance (EMR) method that is an inductive resonance method and a capacitive resonance method are proposed to realize a passive stylus pen capable of recognizing a precise touch.

Although the EMR method is excellent in writing and drawing quality that is a key function of the stylus pen, the EMR method has a disadvantage of having a great thickness and requiring more costs because a separate EMR sensor panel and a separate EMR driving IC are necessarily added in addition to a capacitance touch panel.

The capacitive resonance method uses a general capacitance touch sensor and a general touch controller IC to increase a performance of the IC and support a pen touch without additional costs.

In the EMR method or the capacitive resonance method, a resonance signal is required to have a great amplitude to more accurately distinguish a touch caused by the stylus pen. Thus, a driving signal transmitted to the stylus pen needs to have the almost same resonance frequency as that of the resonance circuit contained in the stylus pen. However, according to the typical EMR method or capacitive resonance method, although the resonance frequency is the same as a frequency of the driving signal, signal transmission is difficult because of extremely great attenuation of the signal transmission. As a result, despite a lot of attempts of many touch controller IC vendors for a long time, no companies have succeeded in mass production because a sufficient output signal is not produced.

Thus, a feature of how to design structures of an internal resonance circuit and a pen is a key factor to manufacture an EMR or capacitive resonance stylus pen capable of producing a maximum output signal.

FIGS. 2A to 2C are views for explaining one requirement of a typical stylus pen.

An outer design of the typical stylus pen including the stylus pens 10a and 10b in FIGS. 2A to 2C needs to satisfy a predetermined requirement in consideration of user's environments.

One of the requirements is that the typical stylus pens 10a and 10b may perform a drawing in a state of being inclined at a predetermined angle (e.g., 60°) with a predetermined contact surface 31.

In particular, each of the stylus pens 10a and 10b is required to perform a drawing even in a state of being inclined at a predetermined angle (e.g., 60°) as a pen tip is pressed such that, when the stylus pen contacts a surface of a display panel 300 and then a predetermined force F is applied, the pen tip is pressed, and a portion thereof is retracted into a housing 19.

As a result, when the typical stylus pen 10a or 10b is inclined to the contact surface 31, an inclination of the predetermined angle (e.g., 60°) needs not to be disturbed by an outer component (e.g., housing 19) of the stylus pen 10a or 10b.

FIG. 3 is a schematic view illustrating an inner structure of a typical stylus pen.

Each of the typical stylus pens 10c and 10d in FIG. 3 includes a pen tip 11, an inductor unit 13 and 13′, a capacitor unit 15, and a housing 19. The typical stylus pen further includes other additional components in addition to the above-described components.

The inductor unit 13 and 13′ includes a ferrite core 131 and 131′ and a coil 133. The pen tip 11 has a portion that is inserted into a through-hole of the ferrite core 131 and 131′.

The inductor unit 13 and 13′ and the capacitor unit 15 are electrically connected to form an LC resonance unit. The LC resonance unit may be resonated by a driving signal provided by a transmitter disposed outside the stylus pen 10c and 10d and emit a predetermined signal (hereinafter, referred to as a pen signal).

A ferrite core 131′ of the inductor unit 13′ of the stylus pen 10d illustrated at a right side of FIG. 3 has a shape different from that of a ferrite core 131 of the inductor unit 13 in the stylus pen 10c illustrated at a left side. Specifically, the ferrite core 131′ of the stylus pen 10d illustrated at the right side has a shape (hereinafter, referred to as a taper shape) having a width that gradually decreases in a downward direction. Through the taper shape, the ferrite core 131′ may be disposed closer to a lower end (or pen tip side) in the housing 19 by a predetermined distance H.

In the typical stylus pens 10c and 10d in FIG. 3, a magnitude of the pen signal received by the receiver disposed outside the stylus pen 10c and 10d may be varied according to a position of the inductor unit 13 and 13′ in the housing 19. The position of the inductor unit 13 and 13′ may be determined to maximize the magnitude of the pen signal.

Since the ferrite core 131′ of the stylus pen 10d at the right side is disposed closer to the pen tip than the ferrite core 131 of the stylus pen 10c at the left side, the magnitude of the pen signal received by the receiver is relatively great. However, there is a limitation in maximizing the magnitude of the pen signal received by the receiver by using only the taper shape of the ferrite core 131′ of the stylus pen 10d.

Furthermore, while maximizing the magnitude of the pen signal received by the receiver, it is required to stably accommodate the inductor unit 13 and 13′ in the housing 19.

On the other hand, since the stylus pen is used in various environments due to characteristics thereof, the stylus pen has a high possibility of being damaged by external factors. In particular, moisture ingress may significantly affect a function of the stylus pen. Since the stylus pen includes precise electronic components therein, ingress of moisture such as water or humidity may cause corrosion of the components or an electrical short-circuit between the components, thereby degrading a performance of the stylus pen. The above-described limitation may shorten a lifespan of the stylus pen and cause inconvenience of the user.

Although some stylus pens currently available on the market have a waterproof function, the stylus pens have a limitation of using an incomplete or expensive special material to increase manufacturing costs. Thus, there is a need to develop a technology capable of effectively and economically preventing moisture ingress into the stylus pens.

### SUMMARY

The present disclosure provides an input system including an electronic device that detects touch and a stylus pen with a single sensor unit, eliminating the need for a separate stylus pen sensor unit for driving and/or detecting only the stylus pen.

The present disclosure also provides an input system including an electronic device capable of double routing.

The present disclosure also provides an input system including an electronic device capable of reducing the number of channels between a sensor unit capable of sensing both an object and a stylus pen and a touch controller.

The present disclosure also provides an input system including an electronic device capable of supporting stylus pen functionality on both an internal and an external touchscreen.

The present disclosure also provides an input system including a ferrite core optimized for a housing having a specific shape and a stylus pen including the ferrite core.

The present disclosure also provides an input system including a stylus pen capable of enhancing the amplitude of the pen signal received at the receiver.

The present disclosure also provides an input system including a stylus pen capable of clearly distinguishing between hover and contact states of the stylus pen.

The present disclosure also provides an input system including a stylus pen capable of synchronizing a magnetic body with the movement of the body. Furthermore, an input system including a stylus pen capable of electrically connecting electrical components without using internal wires is provided.

The present disclosure also provides an input system including a miniaturized stylus pen is also provided.

The present disclosure also provides an input system including a stylus pen capable of stably housing an inductor unit within a housing is also provided.

The present disclosure also provides an input system including a stylus pen capable of drawing even when tilted at a predetermined angle is also provided.

The present disclosure also provides a sealing member capable of blocking a plurality of moisture ingress paths of a stylus pen and a stylus pen including the same.

The present disclosure also provides a sealing member capable of exhibiting an additional effect of blocking a moisture ingress path through a contact part and a stylus pen including the same.

The present disclosure also provides a buffer member capable of performing both a buffer function and a waterproof function, a stylus pen including the same, and a method for minimizing a size of the buffer member.

An embodiment of the present invention provides an input system comprising: an electronic device including a sensor unit and a controller configured to control the sensor unit; and a stylus pen configured to interact with the electronic device, wherein the sensor unit comprises: a plurality of first patterns extending in a first direction, wherein both ends of each of the plurality of first patterns are electrically connected to the controller; a plurality of second patterns extending in a second direction different from the first direction so as to cross the plurality of first patterns, wherein at least one of both ends of each of the plurality of second patterns is electrically connected to the controller; and a plurality of third patterns extending in the second direction, wherein each of the plurality of third patterns is disposed adjacent to a respective one of the plurality of second patterns, and wherein one ends of the plurality of third patterns are electrically connected to each other, wherein the stylus pen comprises: a core body disposed inside a housing and configured to move along a longitudinal direction of the housing by an external force applied to one end of the core body; an inductor unit including a ferrite core fixedly disposed inside the housing and having a through-hole through which the core body passes, and a coil wound around an outer surface of the ferrite core; a capacitor unit electrically connected to the inductor unit to form a resonant circuit; and a magnetic body coupled to the other end of the core body inside the housing and configured to move in conjunction with the core body, wherein an inductance of the inductor unit is configured to vary as a distance between the magnetic body and the ferrite core increases due to the external force acting on the one end of the core body, wherein the controller is configured to apply a touch driving signal to the plurality of first patterns and receive a touch sensing signal from the plurality of second patterns, wherein the controller is configured to apply a stylus pen driving signal to at least one pattern among the plurality of first to third patterns, and wherein the controller is configured to receive stylus pen sensing signals from at least one pattern among the plurality of first to third patterns

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a schematic configuration view for explaining a limitation when a function of a stylus pen is realized on inner and outer screens by applying a typical EMR pen to a display panel in the typical electronic device;

FIGS. 2A to 2C are views for explaining one requirement of a typical stylus pen;

FIG. 3 is a schematic view illustrating an inner structure of the typical stylus pen;

FIG. 4 is a schematic configuration view of an electronic device according to a first embodiment of the present invention;

FIG. 5 is a schematic configuration view of an electronic device according to a second embodiment of the present invention;

FIG. 6 is a view for explaining a first mode (or touch sensing mode) for sensing an object by the electronic device in FIG. 5;

FIGS. 7 and 8 are views for explaining a second mode (or uplink mode) for driving a stylus pen by the electronic device in FIG. 5;

FIG. 9 is a view for explaining a third mode (or downlink mode) for sensing the stylus pen by the electronic device in FIG. 5;

FIG. 10 is a view for explaining a modified example of the sensor unit 100 in FIG. 5;

FIG. 11A is a view for explaining a modified example of the controller 200 of the electronic device in FIG. 9;

FIG. 11B is a view for explaining a modified example of a differential amplifier unit 250 in FIG. 11A;

FIG. 12 is a view for explaining a modified example of the sensor unit 100 in FIG. 5;

FIG. 13 is a view for explaining a modified example of the sensor unit 100′ in FIG. 12;

FIG. 14 is a schematic configuration view of an electronic device according to a third embodiment of the present invention;

FIG. 15 is a schematic view illustrating a modified example of the sensor unit 10 in FIG. 4;

FIG. 16 is a schematic view illustrating a modified example of the sensor unit 10′ in FIG. 15;

FIG. 17 is a schematic view illustrating a modified example of the sensor unit 10″ in FIG. 16;

FIG. 18 is a schematic view illustrating another modified example of the sensor unit 10″ in FIG. 16;

FIG. 19 is a schematic view illustrating another modified example of the sensor unit 10′ in FIG. 15;

FIG. 20 is a schematic view illustrating a modified example of the sensor unit 10′″″ in FIG. 19;

FIG. 21 is a view for explaining a modified example of a third-1 pattern 103-1 and a third-2 pattern 103-2 in FIG. 20;

FIG. 22 is a schematic view illustrating another modified example of the sensor unit 10″″′ in FIG. 19;

FIG. 23 is a schematic view illustrating another modified example of the sensor unit 10″″′ in FIG. 19;

FIG. 24 is a schematic view illustrating the sensor unit 100 in FIG. 5;

FIG. 25 is a schematic view illustrating a modified example of the sensor unit 100 in FIG. 24;

FIG. 26 is a schematic view illustrating a modified example of the sensor unit 100′″ in FIG. 25;

FIG. 27 is a schematic view illustrating another modified example of the sensor unit 100′″ in FIG. 25;

FIG. 28 is a schematic view illustrating another modified example of the sensor unit 100′″ in FIG. 25;

FIG. 29 is a block diagram of an electronic device according to a fourth embodiment of the present invention;

FIG. 30 is a view for explaining a typical sensor unit having a landscape shape;

FIGS. 31A and 31B are views for explaining other typical sensor units each having a landscape shape;

FIGS. 32A and 32B are views for explaining a sensor unit of an electronic device according to a fifth embodiment of the present invention;

FIG. 33 is a block diagram of an electronic device according to a sixth embodiment of the present invention;

FIG. 34 is a view for explaining a stack-up structure of the electronic device according to various embodiments in FIGS. 4 to 33; and

FIG. 35 is a schematic view of a foldable device that is an example of the electronic device described in FIGS. 4 to 34.

FIG. 36 is a perspective view illustrating a stylus pen 100 according to an embodiment of the present invention;

FIG. 37 is a cross-sectional view illustrating portion A of the stylus pen 100 in FIG. 36;

FIG. 38 is a detailed cross-sectional view illustrating an inductor unit 120 in FIG. 37;

FIGS. 39A and 39B are views for explaining an inner configuration and an effect thereof of the stylus pen in FIGS. 37 and 38 according to an embodiment of the present invention;

FIGS. 40A to 40C are views for explaining in more detail an inner configuration and an effect thereof of the stylus pen in FIGS. 37 and 38 according to an embodiment of the present invention;

FIG. 41 is a view for explaining an amount of increase in magnitude of a pen signal according to a predetermined height S in FIGS. 40A to 40C;

FIG. 42 is a cross-sectional view illustrating a portion of the stylus pen 100 in FIG. 36;

FIG. 43A is a perspective view for explaining structures of an inner case 110 and a buffer member 115 in FIG. 42, and FIG. 43B is a perspective view illustrating only the inner case 110;

FIG. 44 is a perspective view illustrating a state in which the inner case 110 in (a) of FIG. 43 is removed;

FIGS. 45A and 45B are perspective views illustrating a first fixing member 130 in FIGS. 42 and 44 from various angles;

FIGS. 46A and 46B are perspective views illustrating a moving member 170 in FIGS. 42 and 44 from various angles;

FIGS. 47A and 47B are perspective views illustrating a second fixing member 190 in FIGS. 42 and 44 from various angles;

FIG. 48 is a perspective view illustrating some components in FIGS. 42 and 44 from one side;

FIGS. 49A and 49B are perspective views illustrating only some components in FIGS. 42 and 44;

FIGS. 50A to 50C are views for explaining an operation of the stylus pen 100 in FIGS. 42 to 49B;

FIG. 51A is a view illustrating a variation in LC value of a resonance circuit unit according to operations in FIGS. 50A to 50C;

FIG. 51B is a graph showing frequency characteristics in each of operating states of FIGS. 50A to 50C;

FIGS. 52A to 52C are views for explaining a limitation caused by an assembly deviation of a core body 102 when the stylus pen 100 in FIGS. 42 to 50C is assembled;

FIG. 53 is a graph showing a variation in resonant frequency according to pressure applied to the core body 102 in each of FIGS. 52A to 52C;

FIGS. 54A to 54C are views for explaining a limitation caused by an assembly deviation of connection terminals 165a and 165b occurring when the stylus pen 100 in FIGS. 42 to 50C is assembled;

FIG. 55 is a cross-sectional view illustrating a portion of a stylus pen according to a modified embodiment of the stylus pen 100 in FIG. 36;

FIGS. 56A and 56B are views for explaining a first elastic member 180′ in FIG. 55;

FIGS. 57A to 57C are view for explaining an operation of the stylus pen in FIGS. 55 and 55B;

FIGS. 58A and 58B are views illustrating an example of an assembly deviation occurring in the core body 102;

FIG. 59 is a graph showing a variation in resonant frequency according to pressure applied to the core body 102 in each of FIGS. 58A to 58C;

FIG. 60 is a perspective view of a modified example of a ferrite core 121 in FIGS. 37 to 38;

FIG. 61 is an enlarged front view illustrating a portion of a ferrite core 121′ in FIG. 60, and a cross-sectional view taken along line A-A′;

FIG. 62 is a cross-sectional view illustrating a stylus pen to which another modified example of the ferrite core 121 in FIG. 37 is applied;

FIG. 63 is a cross-sectional view illustrating only a ferrite core 121″ and a coil 123 in FIG. 62;

FIG. 64 is a perspective view illustrating the ferrite core 121″ in FIGS. 62 to 63;

FIG. 65 is an enlarged front view illustrating a portion of the ferrite core 121″ in FIG. 64, and a cross-sectional view taken along line B-B′;

FIG. 66 is a perspective view illustrating a stylus pen 1000 according to another embodiment of the present invention;

FIG. 67 is a cross-sectional view illustrating a portion of the stylus pen 1000 in FIG. 66;

FIG. 68 is a perspective view illustrating a state in which a housing 1010 of the stylus pen 1000 in FIG. 66 is removed;

FIG. 69 is a perspective view illustrating only a fixing bracket 1600 in FIG. 58;

FIG. 70 is a perspective view illustrating the fixing bracket 1600 in FIG. 69 viewed from a different direction;

FIG. 71 is a perspective view illustrating a portion of FIG. 68 viewed from a different direction;

FIG. 72 is a perspective view illustrating a state in which an inductor unit 1200 and a fixing bracket 1600 in FIG. 68 are removed;

FIG. 73 is a perspective view illustrating FIG. 72 viewed from a different direction;

FIG. 74 is a cross-sectional view of FIG. 72;

FIGS. 75A and 75B are perspective views illustrating only elastic member 1800 in FIG. 72;

FIG. 76 is a perspective view illustrating a substrate bracket 1900 and a substrate 2100 in FIG. 72;

FIGS. 77A and 77B are views for explaining a movement of a moving bracket 1300 according to a movement of the core body 1020 in FIGS. 68 to 76, and an electrical contact and disconnection between the fixing bracket 1600 and the moving bracket 1300;

FIGS. 78A and 78B are views schematizing each of FIGS. 77A and 77B;

FIGS. 79A to 79C are views simplifying a stylus pen according to another embodiment of the present invention and showing equivalent circuit diagrams of FIGS. 77A and 77B;

FIG. 80 is a perspective view illustrating a stylus pen 1000 in FIG. 66 according to another embodiment of the present invention viewed from the core body 1020;

FIG. 81A is a partial cross-sectional view obtained by cutting the stylus pen 1000 along line A-A′ in FIG. 80, and FIG. 81B is a partial cross-sectional view obtained by cutting the stylus pen 1000 along line B-B′ in FIG. 80;

FIG. 82 is a view illustrating cross-sectional views and side views of a ferrite core 1210 in FIGS. 80, 81A and 81B;

FIG. 83 is a view for explaining a modified example of the ferrite core 1210 in FIG. 82; and

FIG. 84 is a perspective view illustrating an inductor unit 1200′ in which a coil 1230′ is wound around an outer surface of the ferrite core 1210′ in FIG. 83.

FIGS. 85A and 85B are views illustrating a first moisture ingress path and a second moisture ingress path in which moisture enters into the stylus pen in FIG. 42 through a core opening of the housing;

FIGS. 86A and 86B are views illustrating a first moisture ingress path and a second moisture ingress path in which moisture enters into the stylus pen in FIG. 67 through a core opening of the housing;

FIGS. 87A and 87B are views illustrating an embodiment of a sealing member for blocking the first moisture ingress path in the stylus pen in FIGS. 85A and 85B;

FIGS. 88A and 88B are views illustrating an embodiment of a sealing member for blocking the first moisture ingress path in the stylus pen in FIGS. 86A and 86B;

FIGS. 89A and 89B are views illustrating another embodiment of the sealing member for blocking the first moisture ingress path in the stylus pen in FIGS. 85A and 85B;

FIGS. 90A and 90B are views illustrating another embodiment of the sealing member for blocking the first moisture ingress path in the stylus pen in FIGS. 86A and 86B;

FIGS. 91A and 91B are views illustrating an embodiment of a sealing member for blocking the second moisture ingress path in the stylus pen in FIGS. 85A and 85B;

FIGS. 92A and 92B are views illustrating an embodiment of a sealing member for blocking the second moisture ingress path in the stylus pen illustrated in FIGS. 86A and 86B;

FIGS. 93A and 93B are views illustrating addition of a first sealing member and a second sealing member to each of the stylus pens in FIGS. 85A to 86B;

FIGS. 94A and 94B are views illustrating a modified example of the sealing member in FIGS. 91A to 92B;

FIGS. 95A and 95B are views illustrating another embodiment of a sealing member for blocking the first moisture ingress path in the stylus pen in FIGS. 86A and 86B;

FIGS. 96A and 96B are views illustrating an embodiment of a buffer member for blocking the first moisture ingress path and the second moisture ingress path in the stylus pen in FIGS. 86A and 86B;

FIG. 97 is a view illustrating a stylus pen including the sealing member in FIG. 56 and the buffer member in FIG. 57;

FIGS. 98A and 98B are views illustrating a third moisture ingress path through a button part in the stylus pen in FIG. 34;

FIGS. 99A and 99B are views illustrating a fourth moisture ingress path in which moisture enters into the stylus pen in FIG. 34 through a coupling portion between a housing and a rear bracket;

FIG. 100 is a view illustrating a packing member for blocking the third moisture ingress path in the stylus pen in FIGS. 98A and 98B;

FIGS. 101A and 101B are views illustrating an embodiment of a sealing member for blocking the fourth moisture ingress path in the stylus pen in FIGS. 99A and 99B; and

FIG. 102 is a view illustrating a plurality of waterproof units in the stylus pen in FIG. 34.

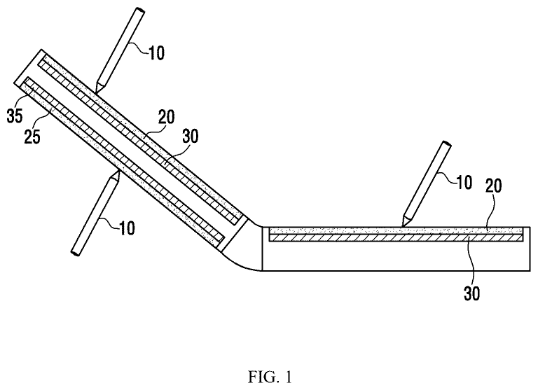

### DETAILED DESCRIPTION

The present invention will now be described more fully with reference to the accompanying drawings, in which exemplary embodiments of the invention are shown. These embodiments are provided so that this disclosure will be thorough and complete, and will fully convey the concept of the invention to those skilled in the art. The invention may, however, be embodied in many different forms and should not be construed as being limited to the embodiments set forth herein. Therefore, it will be understood that the embodiments disclosed in this specification includes some variations without limitations to the shapes as illustrated in the figures. Also, the position or the arrangement of each component in the embodiment may be varied without departing form the spirit or scope of the invention. The preferred embodiments should be considered in descriptive sense only and not for purposes of limitation. Therefore, the scope of the invention is defined not by the detailed description of the invention but by the appended claims, and all differences within the scope will be construed as being included in the present invention.

In the drawings, like reference numerals refer to like elements throughout.

An input system according to various embodiments of the present document includes an electronic device and a stylus pen.

An electronic device according to various embodiments of the present document may be an electronic device such as a typical smartphone or an electronic device having a rectangular screen that is relatively greater than a screen of the typical smartphone and having a diagonal length of about 10 inches or more to about 13 inches or less. For example, the electronic device may include at least one of a foldable smartphone, a tablet personal computer, a vehicle display device, an e-book reader, a laptop personal computer, and a netbook computer.

Also, the electronic device according to various embodiments of the present invention may detect a position of an object such as a finger disposed on a screen, output a driving signal for driving a stylus pen, and detect a position of the stylus pen disposed on the screen by sensing a signal output from the stylus pen.

Also, the electronic device according to various embodiments of the present invention includes a foldable device having at least one folded screen, and the foldable device includes a tablet personal computer (PC) or laptop PC in addition to a smartphone.

Hereinafter, various embodiments will be described in detail with reference to the accompanying drawings.

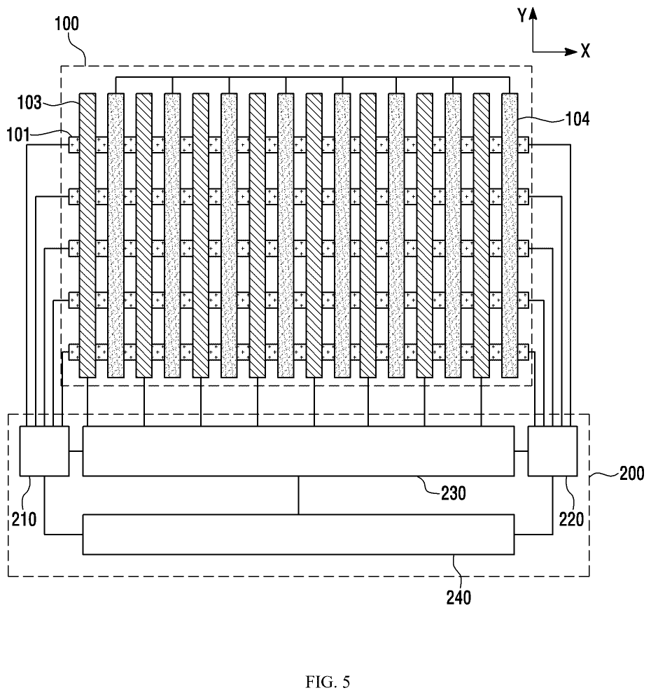

FIG. 5 is a schematic configuration view of an electronic device according to a first embodiment of the present invention.

Referring to FIG. 5, the electronic device according to the first embodiment includes a sensor unit 10 and a touch controller 20 and further include a plurality of traces that electrically connect the sensor unit 10 and the touch controller 20 or electrically connect two or more patterns of the sensor unit 20 to each other.

The sensor unit 10 may sense an object such as a finger and drive and/or sense a stylus pen.

The sensor unit 10 includes a plurality of patterns (or a plurality of electrodes).

The sensor unit 10 may include a plurality of first to fourth patterns 101, 102, 103, and 104.

The first pattern 101 has a shape extending in an arbitrary first direction X. The first direction may be a direction of a major axis of the screen of the electronic device. The first pattern 101 may be also referred to as TX (a first touch electrode or a touch driving electrode).

Each of a plurality of first patterns 101 has one end that is electrically connected to the touch controller 20 through the trace and the other end that is electrically floating.

The second pattern 102 has a shape extending in the first direction X, is disposed adjacent to the first pattern 101, and is spaced a predetermined distance from the first pattern 101.

The second pattern 102 may be also referred to as stylus TX (STX) (a first pen electrode or a pen driving electrode).

The second pattern 102 has one end that is electrically connected to one or more other second patterns through the trace and the other end that is electrically connected to the touch controller 20 through the trace.

Some of a plurality of second patterns 102 may have one ends disposed at a left side and the other ends disposed at a right side. On the contrary, the rest second patterns may have one ends disposed at the right side and the other ends disposed at the left side.

The third pattern 103 has a shape extending in a second direction Y different from the first direction. The second direction Y may be a direction perpendicular to the first direction X and a direction of a minor axis of the screen of the electronic device. The third pattern 103 may be also referred to as RX (a second touch electrode or a touch receiving electrode).

Each of a plurality of third patterns 103 has one end that is electrically connected to the touch controller 20 through the trace and the other end that is electrically floating.

The fourth pattern 104 has a shape extending in the second direction Y, is disposed adjacent to the third pattern 103, and is spaced a predetermined distance from the third pattern 103.

The fourth pattern 104 may be also referred to as stylus RX (SRX) (a second pen electrode or a pen receiving electrode).

The plurality of fourth patterns 104 have one ends electrically connected to each other through at least one trace and the other ends that are electrically floating.

The third and fourth patterns 103 and 104 are disposed on the same layer as or a different layer from the first and second patterns 101 and 102 and are spaced a predetermined distance from the first and second patterns 101 and 102.

The plurality of first patterns 101 are arranged in the second direction Y, and the plurality of second patterns 102 are also arranged in the second direction Y. The plurality of third patterns 103 are arranged in the first direction X, and the plurality of fourth patterns 104 are also arranged in the first direction X.

Since the first pattern 101 extends in the first direction X, the third pattern 103 extends in the second direction Y, and the first direction X is longer than the second direction Y, the number of the first plurality of patterns 101 is less than the number of the third plurality of patterns 103. Thus, the number of channels of the plurality of first patterns 101 is less than that of channels of the plurality of third patterns 103. Here, the number of the plurality of first patterns 101 and the number of the plurality of third patterns 103 may increase or decrease according to a size of the screen of the electronic device.

Since a display screen of a tablet PC, a laptop computer, or a foldable device, which is an example of the electronic device, has a landscape shape, the number (e.g., 8) of the channels of the plurality of third patterns 103 is relatively greater than that (e.g., 5) of the channels of the plurality of first patterns 101. Thus, the plurality of second patterns 102 for driving and/or sensing the stylus pen are required to be arranged as many as the number (5) of the channels of the plurality of first patterns 101. In this case, overall resistance of the sensor unit 100 increases by the traces that electrically connect the plurality of second patterns 102 and the controller 200. Accordingly, parasitic capacitance may be formed between the traces. For example, in a case of an 11 inch to 16 inch tablet PCs, since the number of channels of added second patterns 102 is greater than approximately 30, the parasitic capacitance may act as a significant burden on the electronic device.

An embodiment (or embodiments) of the electronic device, which may solve the above-described limitations, will be described in detail with reference to drawings below.

FIG. 5 is a schematic configuration view of an electronic device according to a second embodiment of the present invention.

Referring to FIG. 5, the electronic device according to the second embodiment includes a sensor unit 100 and a controller 200 and further include a plurality of traces that electrically connect the sensor unit 100 and the controller 200.

The sensor unit 100 includes a plurality of first patterns 101, a plurality of third patterns 103, and a plurality of fourth patterns 104, and the controller 200 includes a first circuit unit 210, a second circuit unit 220, a third circuit unit 230, and a control unit 240.

When compared with the sensor unit 10 in FIG. 5, the sensor unit 100 in FIG. 5 has a difference in that the second pattern 102 is omitted, and both ends of the first pattern 101 arranged in the first direction (or a direction of a major axis) are electrically connected to the controller 200 through the traces. More particularly, the first pattern 101 has one end connected to the first circuit unit 210 of the controller 200 through one trace (or trace pattern) and the other end connected to the second circuit unit 220 of the controller 200 through another trace (or trace pattern). Hereinafter, the above-described method of electrically connecting both the ends of each of the plurality of first patterns 101 to the controller 200 through the traces is referred to as a “double routing method”.

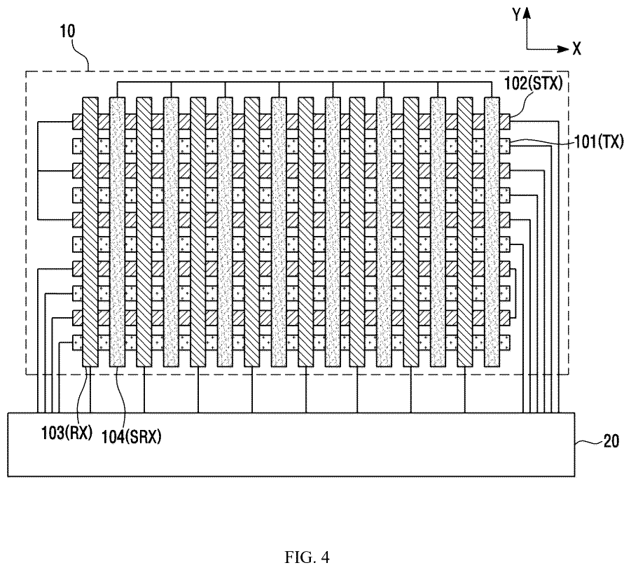

In the sensor unit 100 of FIG. 5, the first pattern 101 may be referred to as a first pattern in the first direction X, the third pattern 103 may be referred to as a first pattern in the second direction Y, and the fourth pattern 104 may be referred to as a second pattern in the second direction Y. Alternatively, the first pattern (101) may be named as the first pattern, the third pattern (103) as the second pattern, and the fourth pattern (104) as the third pattern. Hereinafter, for convenience of explanation, the drawing numbers used in FIG. 4 will be used as they are for explanation.

One end disposed more closely to the controller 200 among both ends of the third pattern 103 arranged in the second direction (or a direction of a minor axis) is electrically connected to the controller 200 through the traces, and the other end is electrically floating. Here, the one end of the third pattern 103 may be connected to the third circuit unit 230 of the controller 200.

One end disposed more closely to the controller 200 among both ends of the fourth pattern 104 disposed adjacent to the third pattern 103 and arranged in the second direction (or the direction of the minor axis) is electrically floating, and the other end is electrically connected to the other ends of other third patterns through at least one trace.

Each of the first circuit unit 210 and the second circuit unit 220 of the controller 200 may include a touch driving circuit unit that outputs a touch driving signal, a first driving circuit unit that outputs a first driving signal, a first inverse driving circuit unit that outputs an inverse signal of the first driving signal, a ground circuit unit, and a receiving circuit unit that receives a pen signal. The third circuit unit 230 may include a receiving circuit unit that receives a touch sensing signal or a pen signal.

When compared with the sensor unit 10 in FIG. 5, the sensor unit 100 of the electronic device according to the second embodiment of the present invention may not only sense an object such as a finger, but also drive and/or sense the stylus pen although the sensor unit 100 does not include the plurality of second patterns 102. Furthermore, the number of channels between the sensor unit 100 and the controller 200 may be reduced.

The electronic device according to the second embodiment of the present invention may be a landscape-type electronic device. The sensor unit (100) of a landscape-type electronic device is configured with a width in the first direction greater than the height in the second direction, and the touch controller (200) controlling the sensor unit (100) is positioned beneath the sensor unit (100). A landscape-type electronic device corresponds to, for example, the form factor of a tablet PC or a foldable smartphone.

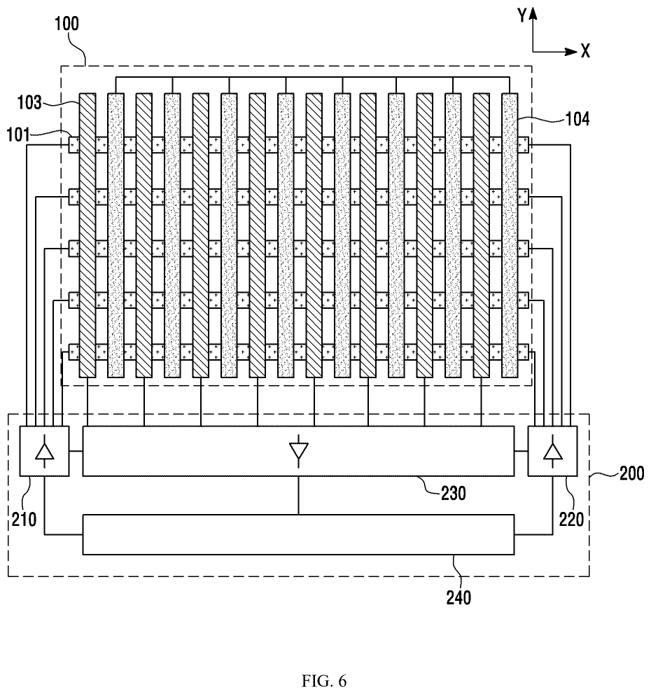

The electronic device including the sensor unit 100 and the controller 200 according to the second embodiment of the present invention may detect a position of an object such as a finger disposed on the screen of the electronic device, drive the stylus pen brought into proximity or contact with the screen, and sense a signal emitted from the stylus pen to detect the position of the stylus pen disposed on the screen. Hereinafter, an embodiment will be described in detail with reference to FIGS. 6 to 9.

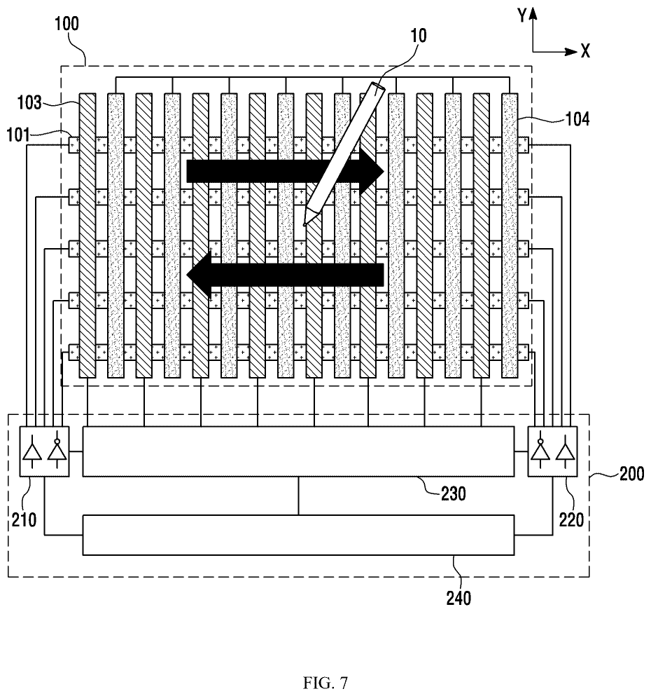

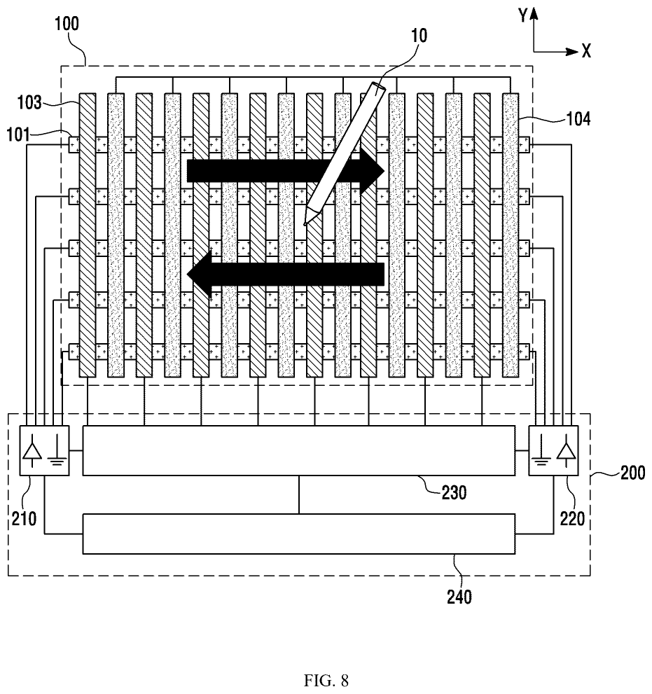

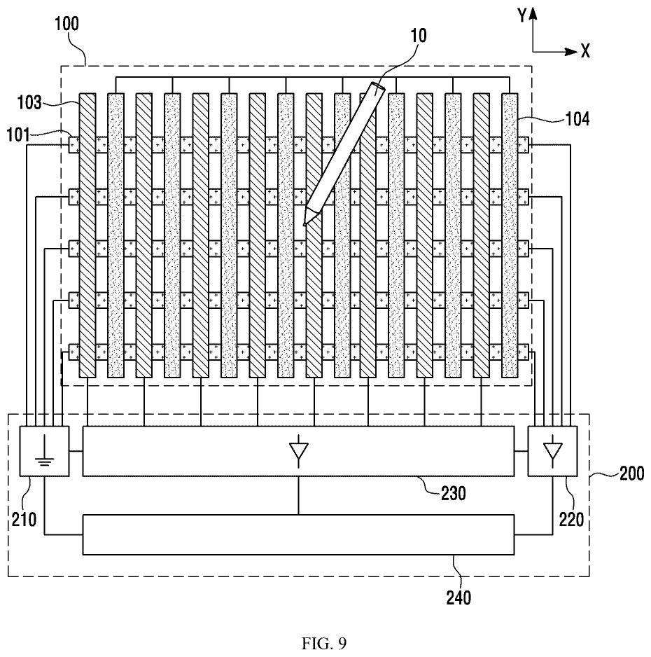

FIG. 6 is a view for explaining a first mode (or touch sensing mode) for the electronic device in FIG. 5 to sense an object, FIGS. 7 to 8 are views for explaining a second mode (or uplink mode) for the electronic device in FIG. 5 to drive the stylus pen, and FIG. 9 is a view for explaining a third mode (or downlink mode) for the electronic device in FIG. 5 to sense (or detect) the stylus pen.

The controller 200 of the electronic device according to the second embodiment of the present invention may sense an object such as a finger brought into proximity or contact with the sensor unit 100 by using the plurality of first patterns 101 and the plurality of third patterns 103 of the sensor unit 100.

Particularly, referring to FIG. 6, the controller 200 may use the plurality of first patterns 101 of the sensor unit 100 as the touch driving electrode TX to which the touch driving signal is applied and the plurality of third patterns 103 as the touch receiving electrode RX that outputs the touch receiving signal, and vice versa.

The control unit 240 of the controller 200 may control the first circuit unit 210 and the second circuit unit 220 to apply a touch driving signal to the plurality of first patterns 101. To this end, each of the first circuit unit 210 and the second circuit unit 220 may output a touch driving signal by a control signal from the control unit 240.

The control unit 240 may allow the first circuit unit 210 to apply a touch driving signal to one ends of the plurality of first patterns 101 and the second circuit unit 220 to simultaneously apply the touch driving signal to the other ends of the plurality of first patterns 101. When the same touch driving signal is applied to both ends of each of the first patterns 101 as described above, a position of maximum resistance in each of the first patterns 101 may be a central portion of the corresponding first pattern 101.

The control unit 240 may receive a touch sensing signal through the plurality of third patterns 103. Each received touch sensing signal includes information on an amount of variation in capacitance between the first pattern 101 and the third pattern 103. The control unit 240 may determine a position of an object based on the amount of variation in capacitance.

Although not shown in the drawings, the control unit 240 may control so that the touch driving signal is applied to each of the first pattern 101 and the third pattern 103, and the touch sensing signal is output from each of the first pattern 101 and the third pattern 103.

The controller 200 of the electronic device according to the second embodiment of the present invention may form a current loop for driving the stylus pen using the plurality of first patterns 101.

The controller 200 may form a current loop in the sensor unit 100 for driving the stylus pen by using one of two methods that will be described with reference to FIGS. 7 and 8 below.

First, as illustrated in FIG. 7, the controller 200 controls a preset current to flow through one or more first patterns among the plurality of first patterns 101 along the first direction X and controls the current to simultaneously flow through one or more first patterns along a direction −X that is a direction opposite to the first direction X. Here, the controller 200 may select the one or more first patterns and the one or more other first patterns according to a position of the stylus pen brought into proximity or contact with the screen. Based on the position of the stylus pen 10, the first pattern(s) disposed thereabove are the one or more first patterns, and the first pattern(s) disposed therebelow are the one or more other first patterns.

The control unit 240 may control the first circuit unit 210 so that a first driving signal is applied to one end of the one or more first patterns among the plurality of first patterns 101 and the second circuit unit 220 so that a first inverse driving signal that is an inverse signal of the first driving signal is applied to the other end of the one or more first patterns, thereby allowing the current in the first direction X to flow through the one or more first patterns. Here, the first driving signal may be a pulse waveform signal or a sine waveform signal.

At the same time, the control unit 240 may control the first circuit unit 210 so that the first inverse driving signal is applied to the one end of the one or more other first patterns among the plurality of first patterns 101 and the second circuit unit 220 so that the first driving signal is applied to the other end of the one or more other first patterns, thereby allowing the current in the direction −X opposite to the first direction to flow through the rest first patterns.

The current in the first direction X, which flows through some first patterns, and the current in the direction −X opposite to the first direction, which flows through other first patterns, may form at least one current loop around the stylus pen 10. The formed current loop may generate a magnetic field, and the generated magnetic field may allow a resonance circuit unit disposed in the stylus pen 10 to resonate, thereby driving the stylus pen 10.

Next, as illustrated in FIG. 8, the control unit 240 may control the first circuit unit 210 so that a first driving signal is applied to one ends of some first patterns among the plurality of first patterns 101 and the second circuit unit 220 so that the other ends of the some first patterns are grounded, thereby allowing the current in the first direction X to flow through the some first patterns.

At the same time, the control unit 240 may control the first circuit unit 210 so that the first driving signal is applied to one ends of the rest first patterns among the plurality of first patterns 101 and the second circuit unit 220 so that the other ends of the rest first patterns are grounded, thereby allowing the current in the direction −X opposite to the first direction to flow through the rest first patterns.

The current in the first direction X, which flows through some first patterns, and the current in the direction −X opposite to the first direction, which flows through other first patterns, may form at least one current loop around the stylus pen 10. The formed current loop may generate a magnetic field, and the generated magnetic field may allow a resonance circuit unit disposed in the stylus pen 10 to resonate, thereby driving the stylus pen 10.

The controller 200 of the electronic device according to the second embodiment of the present invention may receive a stylus pen signal (hereinafter referred to as a pen signal) emitted from the stylus pen using the plurality of first patterns 101 and the plurality of third patterns 103 and determine a position of the stylus pen based on the received pen signal.

As illustrated in FIG. 9, the pen signal may be sensed by using the plurality of first patterns 101 and the plurality of third patterns 103.

The control unit 240 may control the third circuit unit 230 to receive a pen signal from each of the plurality of third patterns 103. The control unit 240 may determine the position of the stylus pen in the first direction X based on the pen signal received by the third circuit unit 230. Here, the pen signal may be received through the plurality of third patterns 103 because an induction signal induced to the fourth pattern 104 is transmitted to the third pattern 103 disposed adjacent to the fourth pattern 104 through capacitive coupling formed between the third pattern 103 and the fourth pattern 104, which are disposed adjacent to each other.

Also, the control unit 240 may control the first circuit unit 210 so that one ends of the plurality of first patterns 101 are electrically grounded and the second circuit unit 220 receives a pen signal from the other end of each of the plurality of first patterns 101. The control unit 240 may determine the position of the stylus pen in the second direction Y based on the pen signal received by the second circuit unit 220.

In FIG. 9, the first circuit unit 210 allows the one ends of the plurality of first patterns 101 to be electrically grounded, and the second circuit unit 220 receives the pen signal from the other ends of the plurality of first patterns 101, and vice versa.

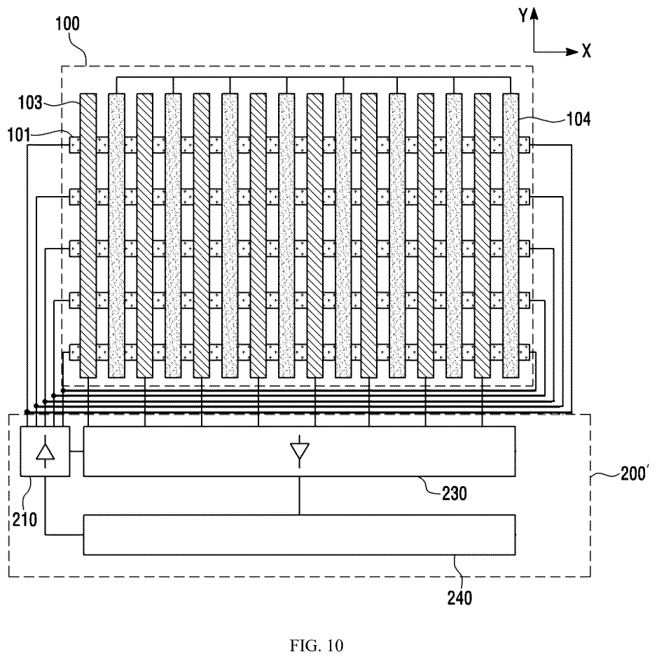

FIG. 10 is a view for explaining a modified example of the electronic device in FIG. 5.

When compared with the electronic device in FIG. 5, both ends of each of the first patterns 101 of the sensor unit 100 in FIG. 10 are electrically connected to each other through the conductive traces and then connected to a controller 200′.

The controller 200′ may apply a touch driving signal to the plurality of first patterns 101 using one first circuit unit 210 and receive a touch sensing signal from the plurality of third patterns 103 using the third circuit unit 230.

Although not shown in FIG. 10, a multiplexer (not shown) may be disposed between the sensor unit 100 and the controller 200′. The multiplexer (not shown) may include a switch that allows both ends of each of the first patterns 101 to be electrically shorted or opened according to a control signal. When the switch is turned on by the control signal, both the ends of each of the first patterns 101 may be electrically shorted as illustrated in FIG. 10, and when the switch is turned off by the control signal, both the ends of each of the first patterns 101 may be electrically opened from each other.

FIG. 11A is a view for explaining a modified example of the controller 200 of the electronic device in FIG. 9.

Referring to FIG. 11A, a controller 200′ includes a third circuit unit 230, a control unit 240, and a differential amplifier unit 250.

The controller 200′ in FIG. 11A is configured such that the first circuit unit 210 and the second circuit unit 220 in FIG. 9 are replaced with one differential amplifier unit 250.

As illustrated in FIG. 11A, the third circuit unit 230 may receive a stylus pen signal from the plurality of third patterns 103, and the control unit 240 may determine the position of the stylus pen in the first direction X based on a signal detected by the third circuit unit 230.

Also, the differential amplifier unit 250 may receive and differentially amplify the stylus pen signal from both ends of each of the first patterns 101, and the control unit 240 may determine the position of the stylus pen in the second direction Y based on the differential signal output from the differential amplifier unit 250.

FIG. 11B is a view for explaining a modified example of the differential amplifier unit 250 in FIG. 11A.

As illustrated in FIG. 111B, a differential amplification unit 250′ may include a plurality of differential amplifiers DP1, DPn, and DP1n. A pair of input terminals of a first differential amplifier DPi is connected to both ends of one first patterns 101-1, respectively, and a pair of input terminals of a second differential amplifier DPn is connected to both ends of another first pattern 101-n, respectively. A pair of input terminals of the third differential amplifier DP1n is connected to an output terminal of the first differential amplifier DP1 and an output terminal of the second differential amplifier DPn, respectively. The output terminal of the third differential amplifier DP1n is connected to the control unit 240 of FIG. 10A.

Here, the another first pattern 101-n may be disposed directly adjacent to the one first pattern 101-1.

Alternatively, the another first pattern 101-n may be spaced a predetermined distance from the one first pattern 101-1. For example, one or more another first pattern (not shown) may be disposed between the another first pattern 101-n and the one first pattern 101-1.

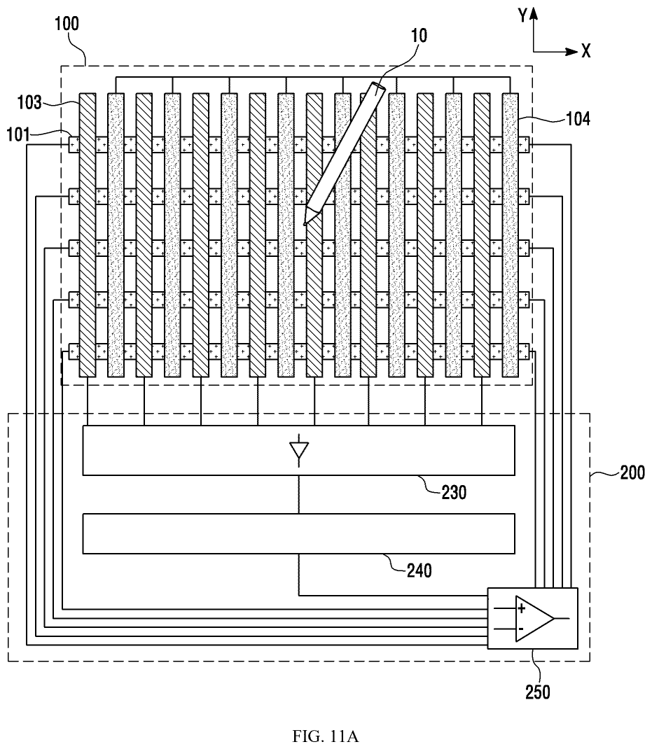

FIG. 12 is a view for explaining a modified example of the sensor unit 100 in FIG. 5.

A sensor unit 100′ in FIG. 12 includes a plurality of first patterns 101, a plurality of third patterns 103, and a plurality of fourth patterns 104 as with the sensor unit 100 in FIG. 5 and further includes uplink channels UC1 and UC2. For reference, the plurality of first patterns 101, the plurality of third patterns 103, and the plurality of fourth patterns 104 are expressed by lines in FIG. 12 unlike those in FIG. 5.

The plurality of first patterns 101, the plurality of third patterns 103, and the plurality of fourth patterns 104 are disposed on an active area AA of a display panel. On the other hand, the uplink channels UC1 and UC2 are disposed on a dead space (or bezel) of the display panel.

Each of the uplink channels UC1 and UC2 may include uplink traces disposed in the first direction X that is the same direction as the plurality of first patterns 101, and a pair of connection traces that connect both ends of the corresponding uplink trace to a pad PAD. Here, the uplink traces and the connection traces may be integrated with each other.

The uplink traces of the first uplink channel UC1 may be disposed on the plurality of first patterns (101), and the uplink traces of the second uplink channel UC2 may be disposed below the plurality of first patterns 101. The plurality of first patterns 101 may be disposed between the uplink traces of the first uplink channel UC1 and the uplink traces of the second uplink channel UC2.

In a case of the sensor unit 100 of FIG. 5, when the stylus pen 10 is brought into proximity or contact with an upper end area or a lower end area of the active area AA, the current loop is hardly formed around the stylus pen 10 because a separate pattern or trace through which a current flows is not provided in the dead space outside the active area AA.

However, in a case of a sensor unit 100′ of FIG. 12, since the uplink channels UC1 and UC2 are additionally provided in the dead space, a current loop may be formed around the corresponding stylus pen 10 by allowing a predetermined current to flow through the uplink channels UC1 and UC2 although the stylus pen is brought into proximity or contact with the upper end area or the lower end area of the active area AA.

FIG. 13 is a view for explaining a modified example of the sensor unit 100′ in FIG. 12.

A sensor unit 100″ in FIG. 13 is the same as the sensor unit 100′ in FIG. 12 except for a second uplink channel UC2′.

An uplink trace of the second uplink channel UC2′ may be relatively longer than the uplink trace of the second uplink channel UC2 of FIG. 12.

The uplink trace of the second uplink channel UC2′ may be relatively longer than an uplink trace of the first uplink channel UC1.

The uplink trace of the second uplink channel UC2′ may include some parallel traces P′ disposed in parallel to the uplink trace of the second uplink channel UC2′. In this case, the some parallel traces P′ may be spaced as far as possible from the connection trace of the second uplink channel UC2′. For example, traces connected to one ends of the plurality of first patterns 101 may be arranged between the uplink trace and the some of the parallel traces P′ of second uplink channel UC2′. A reason for this will be described with reference to FIG. 12.

When a predetermined current flows through the second uplink channel UC2 of the sensor unit 100′ in FIG. 12, as the current flowing through the uplink trace of the second uplink channel UC2 has a direction opposite to that of a current flowing through some parallel traces P of the second uplink channel UC2, a magnetic field for driving the stylus pen may be partially cancelled.

However, in a case of the sensor unit 100″ in FIG. 13, since the uplink trace of the second uplink channel UC2′ is spaced relatively farther away from the some parallel traces P′, the magnetic field may be minimally cancelled.

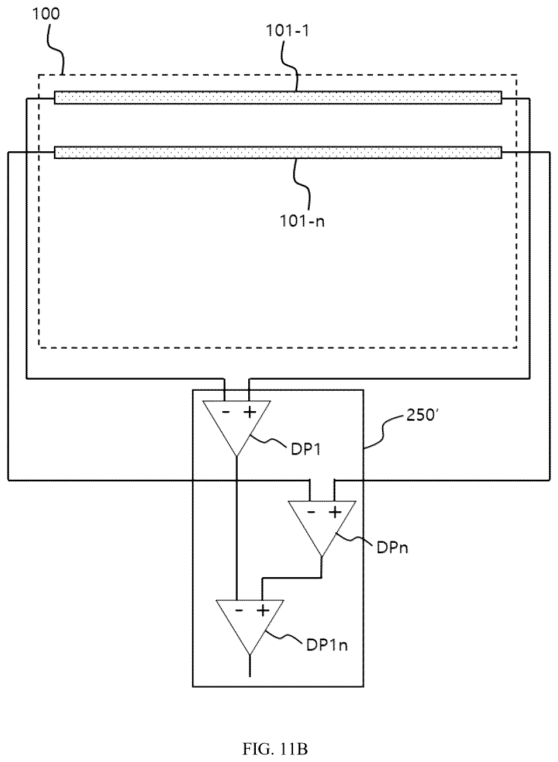

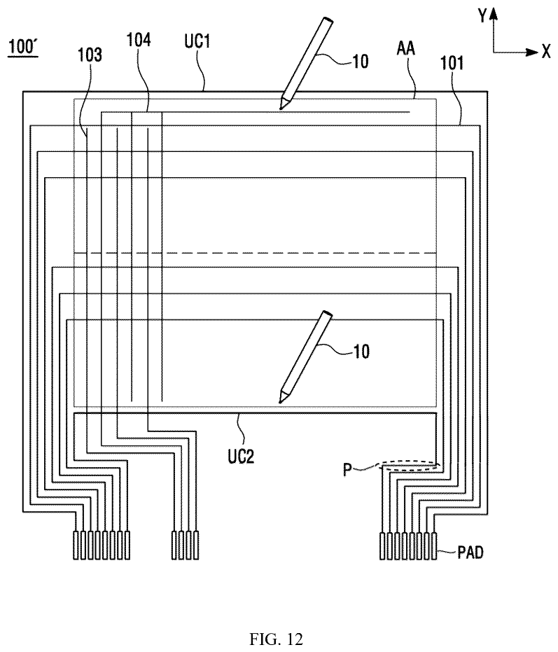

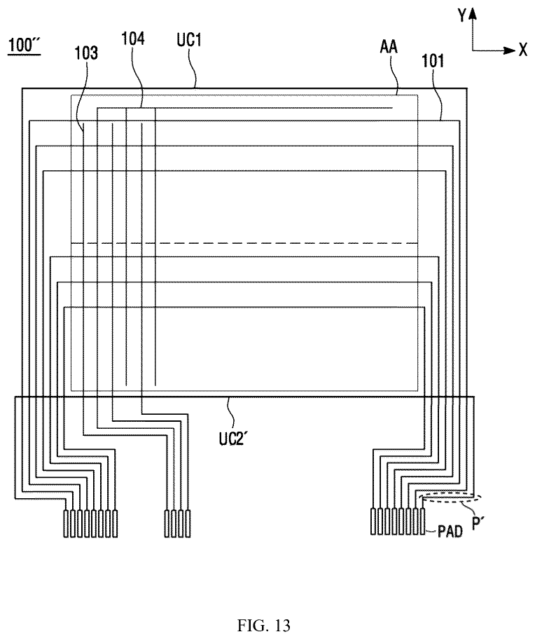

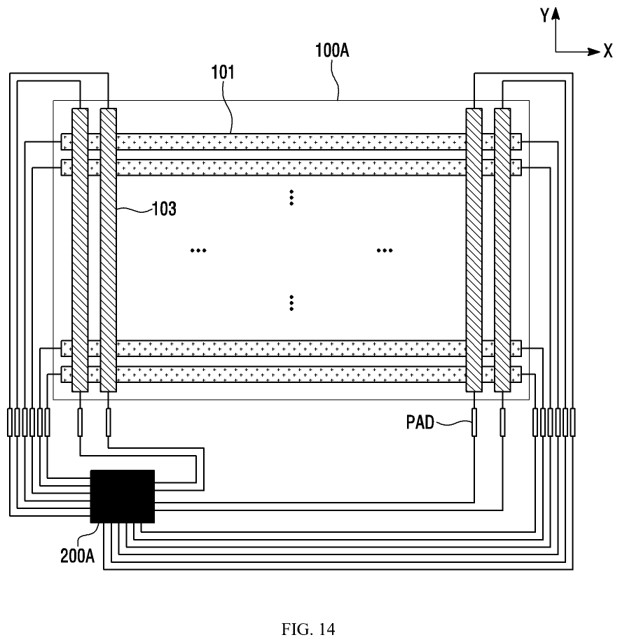

FIG. 14 is a schematic configuration view of an electronic device according to a third embodiment of the present invention.

Referring to FIG. 14, the electronic device according to the third embodiment includes a sensor unit 100A and a controller 200A and further include a plurality of traces that electrically connect the sensor unit 100A and the controller 200A.

The sensor unit 100A includes a plurality of first patterns 101 and a plurality of third patterns 103. When compared with the sensor unit 100 in FIG. 5, the sensor unit 100A in FIG. 14 has a difference in that the fourth pattern 104 is omitted, and both ends of the third pattern 103 are electrically connected to the controller 200A through the traces. That is, in the sensor unit 100A in FIG. 14, not only the plurality of first patterns 101 but also the plurality of third patterns 103 are directly connected to the controller 200A in a double routing method.

The controller 200A may include first to third circuit units 210, 220, and 230 and a control unit 240 as same as the controller 200 in FIG. 5.

In the electronic device in FIG. 14, as a landscape-type electronic device, the number of third patterns 103 may be greater than that of first patterns 101.

The sensor unit 100A and the controller 200A of the electronic device in FIG. 14 may detect a position of an object such as a finger disposed on a display screen, drive the stylus pen brought into proximity or contact with the display screen, and sense a signal emitted from the stylus pen to detect the position of the stylus pen disposed on the display screen.

Specifically, as mentioned in FIG. 6, the controller 200A may control the touch driving signal to both ends of the plurality of first patterns 101 and receive the touch sensing signal through the plurality of third patterns 103 to determine the position of the object.

As described above in FIG. 7 or 9, the controller 200A may control the current in the first direction X to flow through some first patterns distinguished based on the position of the stylus pen

and the current in the direction −X opposite to the first direction through some first patterns, thereby resonating the resonance circuit unit of the stylus pen.

As described in FIG. 9, the controller 200A may receive a pen signal emitted from the stylus pen using the plurality of first patterns 101 and the plurality of third patterns 103 and determine a position of the stylus pen based on the received pen signal. Here, since the plurality of fourth patterns 104 are not provided in the sensor unit 100A in FIG. 14, the controller 200A may control both ends of the plurality of third patterns 103 as same as both the ends of the plurality of first patterns 101 to receive the pen signal. That is, the sensor unit 100A in FIG. 14 may directly receive the pen signal through the third patterns 103 instead of using the capacitive coupling method described in FIG. 9.

Although not shown in a separate drawing, the uplink channels UC1 and UC2 in FIG. 12 or 14 may be directly applied to the sensor unit 100A in FIG. 14.

Since each of the first patterns 101 of the electronic device in FIG. 14 is connected to the controller 200A in the double routing method, when the controller 200A is driven in a third mode (or downlink mode) that senses the pen signal in FIG. 9, the controller 200A may directly receive the pen signal output through the first patterns 101. Likewise, since each of the third patterns 103 is connected to the controller 200A in the double routing method, when the controller 200A is driven in the third mode (or downlink mode), the controller 200A may directly receive the pen signal output through the third patterns 103.

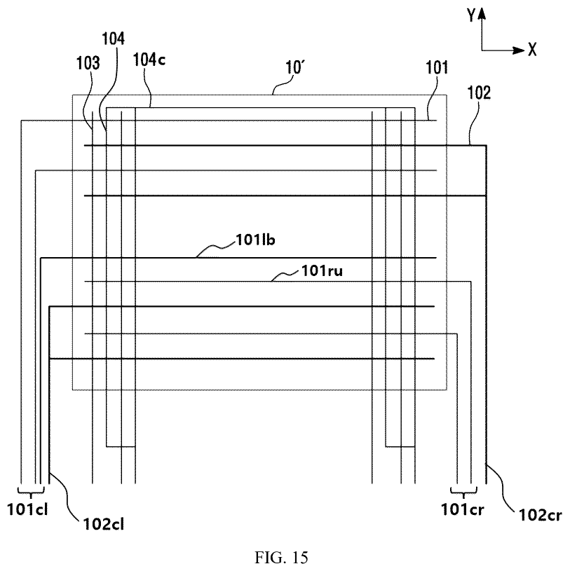

FIG. 15 is a schematic view illustrating a modified example of the sensor unit 10 in FIG. 5.

As illustrated in FIG. 15, a sensor unit 10′ includes first to fourth patterns 101, 102, 103, and 104.

Among the plurality of first patterns 101 of the sensor unit 10′ of FIG. 15, one ends (left ends) of a half of the first patterns 101 disposed above based on the second direction Y are connected to a trace 101cl for connection with the touch controller (not shown), and the other end (right end) thereof is floating. Also, the other end (right end) of each of a rest half of the first patterns 101 disposed below based on the second direction Y is connected to a trace 101cr for connection with the touch controller (not shown), and one end (left end) thereof is floating.

Among the plurality of second patterns 102 of the sensor unit 10′ of FIG. 15, right ends of a half of the second patterns 102 disposed above the second direction Y are electrically connected to each other through a trace 102cr, and left ends thereof are floating. Also, left ends of a half of the second patterns 102 disposed below the second direction Y are electrically connected to each other through a trace 102c1, and right ends thereof are floating.

Lower ends of the plurality of third patterns 103 of the sensor unit 10′ of FIG. 15 are connected to the touch controller (not shown) through a trace, and upper ends thereof are floating.

Upper ends of the plurality of fourth patterns 104 of the sensor unit 10′ of FIG. 15 are electrically connected to each other through a trace 104c. Lower ends of the plurality of fourth patterns 104 may be connected in parallel in pairs and connected to the touch controller (not shown). This is different from the sensor unit 10 of FIG. 5.

The touch controller (not shown) may operate the plurality of first patterns 101 and the plurality of third patterns 103 in a first mode (touch sensing mode) to sense an object such as a finger.

The touch controller (not shown) may operate the plurality of fourth patterns 104 in a second mode (uplink mode) for driving the stylus pen.

The touch controller (not shown) may operate the plurality of first patterns 101 and the plurality of third patterns 103 in a third mode (downlink mode) for sensing the stylus pen. In this case, the pen signal output from the plurality of first patterns 101 may be transmitted from the plurality of second patterns 102 by capacitive coupling, and the pen signal output from the plurality of third patterns 103 may be transmitted from the plurality of fourth patterns 104 by capacitive coupling.

When compared with the sensor unit 10 in FIG. 5, the sensor unit 10′ in FIG. 15 has an advantage of reducing the number of channels (or pins) of the touch controller (not shown). This is caused by parallel connection of the lower ends of the plurality of fourth patterns 104 in pairs. For example, when the number of each of the first patterns 101 and the second patterns 102 is 35, and the number of each of the third patterns 103 and the fourth patterns 104 is 42, the touch controller (not shown) requires 35 pins connected to 35 first patterns 101, 42 pins connected to 42 third patterns 103, and 21 (=42*1/2) pins connected to 42 fourth patterns 104. As a result, the touch controller (not shown) requires 98 pins. On the contrary, the sensor unit 10 of FIG. 5 requires additional 21 pins for the fourth patterns 104 because the lower ends of the fourth patterns 104 are not connected in pairs in parallel.

Since the number of channels of the touch controller (not shown) may be reduced by using the sensor unit 10′ in FIG. 15, there is an advantage of reducing a size or a manufacturing cost of the touch controller (not shown).

Also, in the sensor unit 10′ in FIG. 15, the left ends of some first patterns 101 disposed above based on the second direction Y among the plurality of first patterns 101 are connected to the touch controller (not shown), and the right ends of the rest first patterns disposed below based on the second direction Y are connected to the touch controller (not shown). This arrangement configuration may reduce the number of traces disposed on both bezel areas of the display panel.

On the other hand, in the sensor unit 10′ in FIG. 15, since a first pattern 1011b disposed lowermost among the some first patterns 101 having the left ends connected to the touch controller (not shown) and a first pattern 101ru disposed uppermost among the rest first patterns having the right ends connected to the touch controller (not shown) are connected to the trace in opposite directions, signal distortion occurs when the touch controller (not shown) differentiates a signal output from the lowermost first pattern 1011b and a signal output from the uppermost first pattern 101ru. This distortion is referred to as ‘half-half distortion’. The half-half distortion may cause an unintended ghost touch.

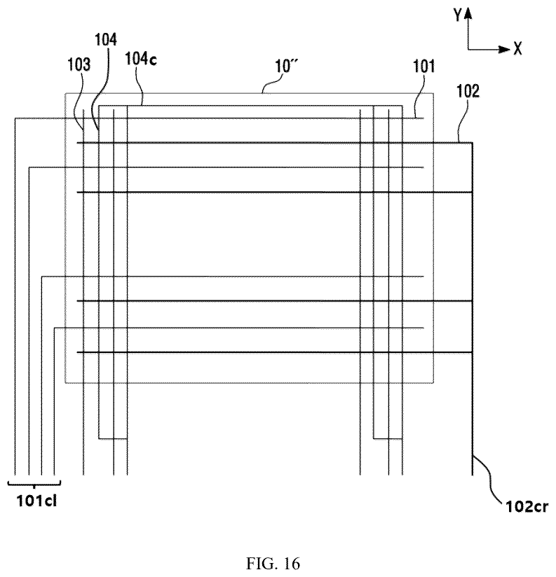

FIG. 16 is a schematic view illustrating a modified example of the sensor unit 10′ in FIG. 15.

As illustrated in FIG. 16, a sensor unit 10″ includes first to fourth patterns 101, 102, 103, and 104.

When compared with the sensor unit 10″ in FIG. 15, the sensor unit 10″ in FIG. 16 has a difference in that all left ends of the plurality of first patterns 101 are connected to the touch controller (not shown) through s trace 101cl, and all right ends of the plurality of second patterns 102 are electrically connected to each other through a trace 102cr. The difference has an advantage in that the touch controller (not shown) does not produce the above-described half-half distortion although signals output through the plurality of first patterns 101 of the sensor unit 10″ in FIG. 16 are differentiated.

The touch controller (not shown) may operate the plurality of first patterns 101 and the plurality of third patterns 103 in a first mode (touch sensing mode) for sensing an object such as a finger.

The touch controller (not shown) may operate the plurality of fourth patterns 104 in a second mode (uplink mode) for driving the stylus pen.

The touch controller (not shown) may operate the plurality of first patterns 101 and the plurality of third patterns 103 in a third mode (downlink mode) for sensing the stylus pen. In this case, the pen signal output from the plurality of first patterns 101 may be transmitted from the plurality of second patterns 102 by capacitive coupling, and the pen signal output from the plurality of third patterns 103 may be transmitted from the plurality of fourth patterns 104 by capacitive coupling.

The number of channels of the touch controller (not shown) for the sensor unit 10″ in FIG. 16 is equal to that of channels of the touch controller (not shown) for the sensor unit 10′ in FIG. 15.

However, since all left ends of the plurality of first patterns 101 of the sensor unit 10″ in FIG. 16 are connected to the touch controller (not shown) through traces 101c1, the number of traces 101c1 disposed on a left bezel area may relatively increase to cause increase in thickness of the bezel. Also, since resistance relatively increases by the traces 101c1, a touch bandwidth may be narrowed.

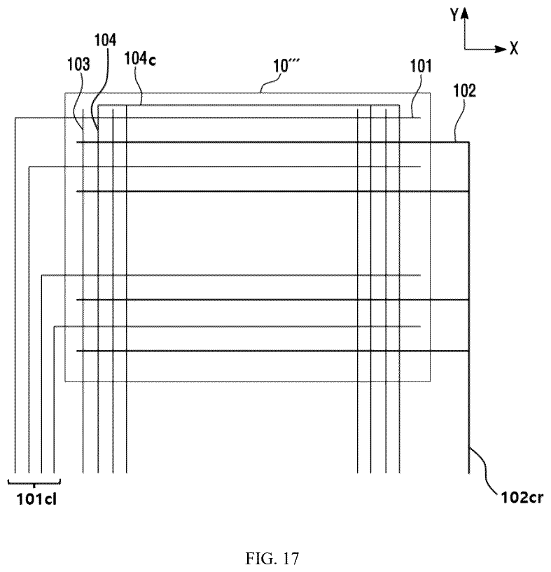

FIG. 17 is a schematic view illustrating a modified example of the sensor unit 10″ in FIG. 16.

As illustrated in FIG. 17, a sensor unit 10′″ includes first to fourth patterns 101, 102, 103, and 104.

When compared with the sensor unit 10″ in FIG. 16, the sensor unit 10′″ in FIG. 17 has a difference in that lower ends of the plurality of fourth patterns 104 are individually connected to the touch controller (not shown) instead of being connected in pairs in parallel.

The sensor unit 10′″ in FIG. 17 may directly use the plurality of fourth patterns 104 to sense the pen signal emitted from the stylus pen.

As with the sensor unit 10″ in FIG. 16, the sensor unit 10′″ in FIG. 17 has traces 101cl connected to left ends of the plurality of first patterns 101, the half-half distortion does not occur.

Also, since the sensor unit 10′″ in FIG. 17 may directly use the plurality of fourth patterns 104 to detect the pen signal emitted from the stylus pen, the sensor unit 10′″ does not use capacitive coupling Cc between the third patterns 103 and the fourth patterns 104, which are adjacent to each other. Thus, a capacitance value of the sensor unit 10′″ may be reduced to allow the touch bandwidth to be relatively expanded further than the sensor unit 10″ in FIG. 16.

Also, the number of channels of the touch controller (not shown) for the sensor unit 10′″ in FIG. 17 is greater than that of channels of the touch controller (not shown) for the sensor unit 10″ in FIG. 16. This is because each of the plurality of fourth patterns 104 is connected to the touch controller (not shown).

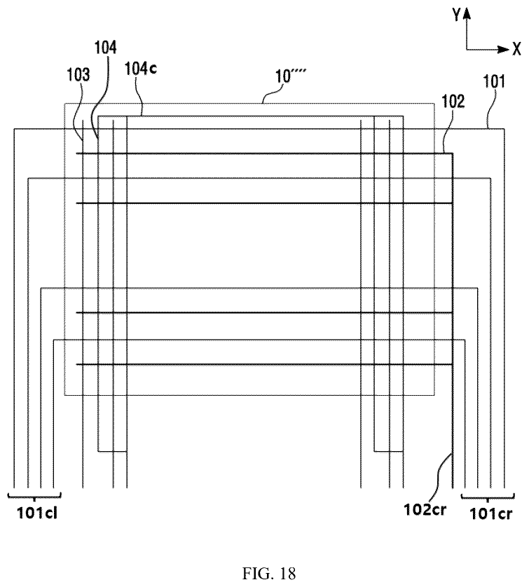

FIG. 18 is a schematic view illustrating another modified example of the sensor unit 10″ in FIG. 16.

As illustrated in FIG. 18, a sensor unit 10″″ includes first to fourth patterns 101, 102, 103, and 104.

When compared with the sensor unit (10″) shown in FIG. 16, the sensor unit 10″″ in FIG. 18 has a difference in terms of double routing method by which not only the left ends but also the right ends of the plurality of first patterns 101 are electrically connected to the touch controller (not shown) through the traces 101cl and 101cr. The difference has an advantage of expanding the touch bandwidth further than the sensor unit 10″ in FIG. 16.

Also, like the sensor unit 10″ in FIG. 16, the half-half distortion

does not occur in the sensor unit 10″″ of FIG. 18.

On the other hand, the number of channels (or pins) of the touch controller (not shown) for the sensor unit 10″″ in FIG. 18 is greater than that for the sensor unit 10″ in FIG. 16. This is because the plurality of first patterns 101 are connected to the touch controller (not shown) in the double routing method.

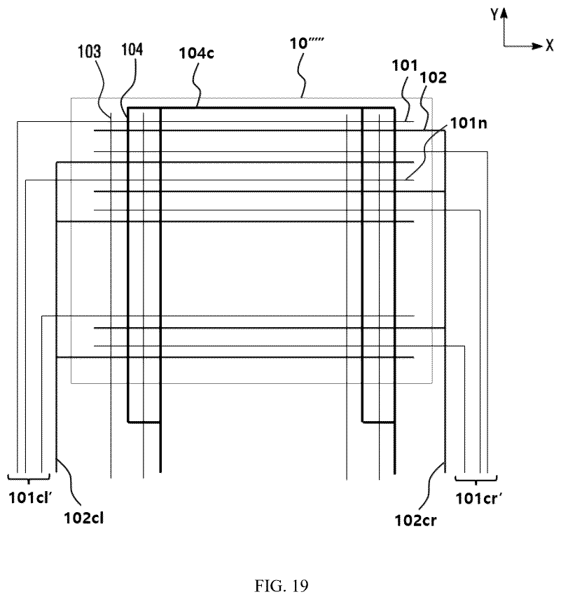

FIG. 19 is a schematic view illustrating a modified example of the sensor unit 10′ in FIG. 15.

As illustrated in FIG. 19, a sensor unit 10′″″ includes first to fourth patterns 101, 102, 103, and 104.

When compared with the sensor unit 10′ in FIG. 15, the sensor unit 10′″″ in FIG. 19 has a difference in the plurality of first patterns 101 and the plurality of second patterns 102.

The plurality of first patterns 101 include some first patterns connected to one side trace 101cl′ for connection with the touch controller (not shown) and other first patterns connected to the other side trace 101cr′. The some first patterns and the other first patterns are arranged alternately along the second direction Y.

Also, the plurality of second patterns 102 include some second patterns connected to one side trace 102c1 for connection with the touch controller (not shown) and other some second patterns connected to the other side trace 102cr′. The some second patterns and the other some second patterns are arranged alternately along the second direction Y.

When a left end of both ends of one of the plurality of first patterns 101 is connected to the trace 101cl′, a right end of both the ends of one of the plurality of second patterns 102, which is adjacent to the first pattern 101, may be connected to the trace 102cr.

Since the traces 101cl′ and 101cr′ that connect the plurality of first patterns 101 and the touch controller (not shown) of the sensor unit 10′″″ in FIG. 19 are arranged alternately, i.e., once at a left side and then at a right side, along the second direction Y, the number of traces arranged at the left side and the number of traces arranged at the right side may be the same as or similar to each other to maintain uniformity.

The touch controller (not shown) may sense (first mode) a touch of an object such as a finger, drive (second mode) the stylus pen, and sense (third mode) the pen signal from the stylus pen by using the sensor unit 10′″″ in FIG. 19. Specifically, a method by which the touch controller (not shown) operates the sensor unit 10′″″ for each mode will be described with reference to <Table 1> below.

TABLE 1

| | | | |
|---|---|---|---|
| 101 | 103 | 102 | 104 |

| | | | |
|---|---|---|---|
| Touch | Driving | Receiving | |
| | Receiving | Driving | |
| Stylus | Receiving | Receiving | Driving |
| | Receiving | | Driving/Receiving |

Referring to FIG. 19 together with <Table 1>, the touch controller (not shown) may operate the sensor unit 10′″ in the first mode (Touch).

As an example of the first mode (Touch), the touch controller (not shown) may apply a touch driving signal to at least one of the plurality of first patterns 101 of the sensor unit 10′″″ and receive a touch sensing signal from plurality of third patterns 103. Here, the touch controller (not shown) may differentiate the touch sensing signals received from the plurality of third patterns 103.

As another example of the first mode (Touch), the touch controller (not shown) may apply a touch driving signal to at least one of the plurality of third patterns 103 of the sensor unit 10′″″ and receive a touch sensing signal from plurality of first patterns 101. Here, the touch controller (not shown) may differentiate the touch sensing signal received from the plurality of first patterns 101. When the touch sensing signal is differentiated, the touch controller (not shown) may differentiate the touch sensing signal output from a n-th first pattern 101 and a n+2-th first pattern 101n in an order from the top of the plurality of first patterns 101 to prevent the above-described ‘half-half distortion’ from occurring.

The touch controller (not shown) may operate the sensor unit 10′″″ in a second mode (Stylus/Driving). For example, the touch controller (not shown) may apply a pen driving signal to at least one of the plurality of fourth patterns 104 of the sensor unit 10′″″.

The touch controller (not shown) may operate the sensor unit 10′″″ in the third mode (Stylus/Receiving).

As an example of the third mode (Stylus/Receiving), the touch controller (not shown) may receive a pen sensing signal from plurality of first patterns 101 and the plurality of third patterns 103 of the sensor unit 10′″″. The pen sensing signal output from each of the first patterns 101 is transmitted from the second pattern 102 adjacent to the corresponding first pattern 101 through capacitive coupling. Also, the pen sensing signal output from each of the third patterns 103 is transmitted from the fourth pattern 104 adjacent to the corresponding third pattern 103 through capacitive coupling Here, the touch controller (not shown) may differentiate the pen sensing signals received from the plurality of first patterns 101 (or the plurality of third patterns 103). When the touch controller (not shown) differentiates the pen sensing signals, the touch controller (not shown) may differentiate the pen sensing signals output from the n-th first pattern 101 and the n+2-th first pattern 101n in an order from the top of the plurality of first patterns 101 to prevent the above-described ‘half-half distortion’ from occurring.

As another example of the third mode (Stylus/Receive), the touch controller (not shown) may receive the pen sensing signal from the plurality of first patterns 101 and the plurality of fourth patterns 104 of the sensor unit 10′″″. The pen sensing signal output from each of the first patterns 101 is transmitted from the second pattern 102 adjacent to the corresponding first pattern 101 through capacitive coupling. The pen sensing signal output from the plurality of fourth patterns 104, which is a signal directly induced to a pen signal from an external stylus pen, is not transmitted through capacitive coupling. Here, the touch controller (not shown) may differentiate the pen sensing signals received from the plurality of first patterns 101 (or plurality of fourth patterns 104). When the touch controller (not shown) differentiates the pen sensing signals, the touch controller (not shown) may differentiate the pen sensing signals output from the n-th first pattern 101 and the n+2-th first pattern 101n in an order from the top of the plurality of first patterns 101 to prevent the above-described ‘half-half distortion’ from occurring.

Although not shown in a separate drawing, when one ends of the plurality of second patterns 102 of the sensor unit 10′″″ in FIG. 19, which are electrically floating, are electrically connected to the touch controller (not shown), the touch controller (not shown) may operate the sensor unit in a third mode (Stylus/Receiving). When operated in the third mode, the touch controller (not shown) may receive the pen sensing signal from the plurality of second patterns 102 and the plurality of third patterns 103 of the sensor unit 10′″″ or receive the pen sensing signal from the plurality of second patterns 102 and the plurality of fourth patterns 104.

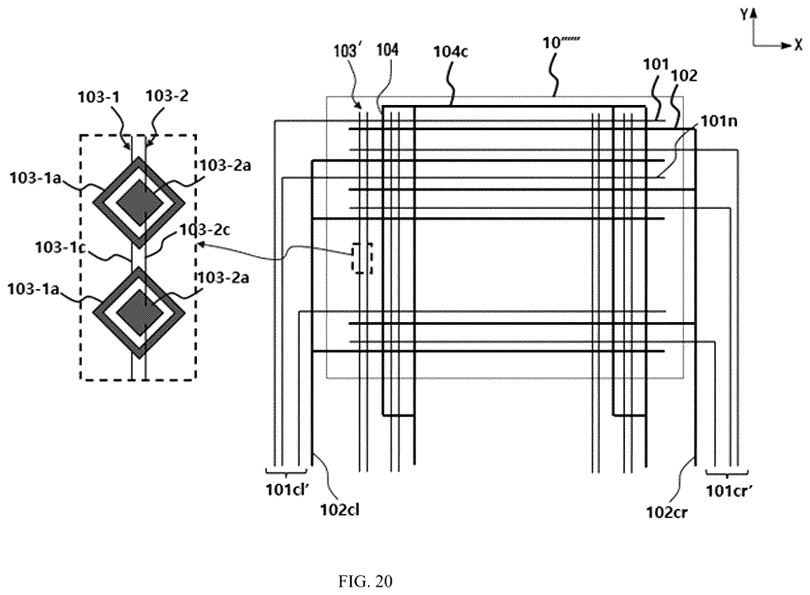

FIG. 20 is a schematic view illustrating a modified example of the sensor unit 10″″′ in FIG. 19.

As illustrated in FIG. 20, a sensor unit 10″″″ includes first to fourth patterns 101, 102, 103′, and 104.

The sensor unit 10″″″ in FIG. 20 has a difference from the sensor unit 10′″″ in FIG. 19 in terms of a plurality of third patterns 103′.

Each of the plurality of third patterns 103′ includes a third-1 pattern 103-1 and a third-2 pattern 103-2, which are adjacent to each other.

The third-1 pattern 103-1 includes a plurality of main patterns 103-1a arranged in the second direction Y and connection patterns 103-1c that connect two adjacent main patterns 103-1a among the plurality of main patterns 103-1a. Each of the main patterns 103-1a of the third-1 pattern 103-1 may have a rectangular shape, a rhombus shape, or a diamond shape and have an opening in which each of the main patterns 103-2a of the third-2 pattern 103-2 is disposed.

The third-2 pattern 103-2 includes a plurality of main patterns 103-2a arranged in the second direction Y and connection patterns 103-2c that connect two adjacent main patterns 103-2a among the plurality of main patterns 103-2a. Each of the main patterns 103-2a of the third-2 pattern 103-2 may have a rectangular shape, a rhombus shape, or a diamond shape. Each of the main patterns 103-2a of the third-2 pattern 103-2 may have a shape corresponding to that of each of the main patterns 103-1a of the third-1 pattern 103-1.

Each of the main patterns 103-1a of the third-1 pattern 103-1 is disposed relatively closer to the first pattern 101 than each of the main patterns 103-2a of the third-2 pattern 103-2.

Each of the plurality of third patterns 103′ includes the third-1 pattern 103-1 and the third-2 pattern 103-2, and each of the third-1 pattern 103-1 and the third-2 pattern 103-2 is connected to the touch controller (not shown). Thuse, although the number of pins for the plurality of third patterns (103′) in the touch controller (not shown) increases by two times when compared with the sensor unit 10′″″ in FIG. 19, in the first mode (touch driving mode), the touch controller (not shown) may apply the touch driving signal to the plurality of first patterns 101 and differentiate two touch sensing signals output from the third-1 pattern 103-1 and the third-2 pattern 103-2, respectively, to cancel a display noise and a low ground mass (LGM) caused by a poor ground of an object, which act on the sensor unit 10″″″, thereby improving sensing sensitivity.

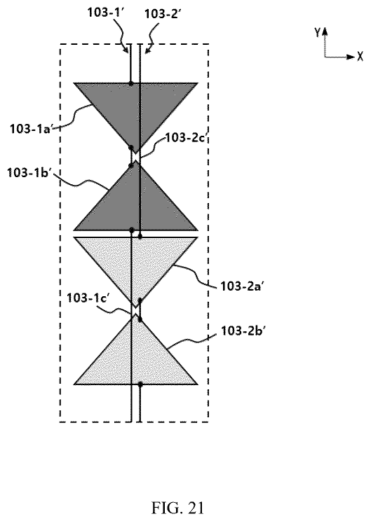

FIG. 21 is a view for explaining a modified example of the third-1 pattern 103-1 and the third-2 pattern 103-2 in FIG. 20.

Referring to FIG. 21, a third-1 pattern 103-1′ includes a plurality of main patterns 103-1a′ and 103-1b′ arranged in the second direction Y and connection patterns 103-1c′ that connect two adjacent main patterns 103-1a′ and 103-1b′ among the plurality of main patterns 103-1a′ and 103-1b′. Each of main patterns 103-1a′ and 103-1b′ of the third-1 pattern 103-1′ mayinclude a first main pattern 103-1a′ and a second main pattern 103-1b′. The first main pattern 103-1a′ and the second main pattern 103-1b′ may have shapes that are symmetric to each other in the first direction X. For example, each of the first main pattern 103-1a′ and the second main pattern 103-1b′ may have an inverted triangular shape. The first main pattern 103-1a′ and the second main pattern 103-1b′ may be electrically connected to each other.

The third-2 pattern 103-2′ includes a plurality of main patterns 103-2a′ and 103-2b′ arranged in the second direction Y and connection patterns 103-2c′ that connect two adjacent main patterns 103-2a′ and 103-2b′ among the plurality of main patterns 103-2a′ and 103-2b′. Each of the main patterns 103-2a′ and 103-2b′ of the third-2 pattern 103-2′ may include a first main pattern 103-2a′ and a second main pattern 103-2b′. The first main pattern 103-2a′ and the second main pattern 103-2b′ may have shapes that are symmetric to each other in the first direction X. For example, each of the first main pattern 103-2a′ and the second main pattern 103-2b′ may have an inverted triangular shape. The first main pattern 103-2a′ and the second main pattern 103-2b′ may be electrically connected to each other.

The plurality of main patterns 103-1a′ and 103-1b′ of the third-1 pattern 103-1′ and the plurality of main patterns 103-2a′ and 103-2b′ of the third-2 pattern 103-2′ are arranged alternately in the second direction Y.

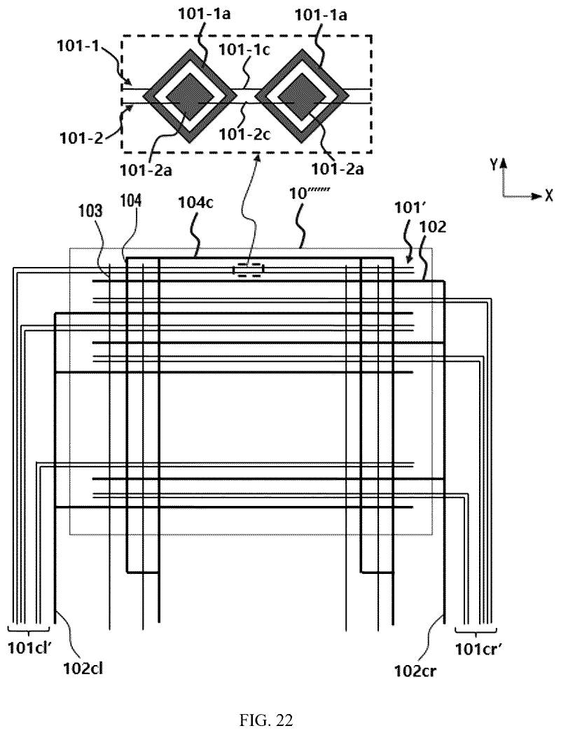

FIG. 22 is a schematic view illustrating another modified example of the sensor unit 10′″″ in FIG. 19.

As illustrated in FIG. 22, a sensor unit 10′″″″ includes first to fourth patterns 101′, 102, 103, and 104.

The sensor unit 10′″″″ of FIG. 22 has a difference from the sensor unit 10′″″ of FIG. 19 in terms of a plurality of first patterns 101′.

Each of the plurality of first patterns 101′ includes a first-1 pattern 101-1 and a first-2 pattern 101-2.

The first-1 pattern 101-1 includes a plurality of main patterns 101-1a arranged in the first direction X and connection patterns 101-1c that connect two adjacent main patterns 101-1a among the plurality of main patterns 101-1a. Each of the main patterns 101-1a of the first-1 pattern 101-1 may have a rectangular shape, a rhombus shape, or a diamond shape and have an opening in which each of the main patterns 101-2a of the first-2 pattern 101-2 is disposed.

The first-2 pattern 101-2 includes a plurality of main patterns 101-2a arranged in the first direction X and connection patterns 101-2c that connect two adjacent main patterns 101-2a among the plurality of main patterns 101-2a. Each of the main patterns 101-2a of the first-2 pattern 101-2 may have a rectangular shape, a rhombus shape, or a diamond shape. Each of the main patterns 101-2a of the first-2 pattern 101-2 may have a shape corresponding to that of each of the main patterns 101-1a of the first-1 pattern 101-1.

Each of the main patterns 101-1a of the first-1 pattern 101-1 is disposed relatively closer to the third pattern 103 than each of the main patterns 101-2a of the first-2 pattern 101-2.

Each of the plurality of third patterns 101′ includes the first-1 pattern 101-1 and the first-2 pattern 101-2, and each of the first-1 pattern 101-1 and the first-2 pattern 101-2 is connected to the touch controller (not shown). Thus, although the number of pins for the plurality of first patterns 101′ in the touch controller (not shown) increases by two times when compared with the sensor unit 10′″″ in FIG. 19, in the first mode (touch driving mode), the touch controller (not shown) may apply the touch driving signal to the first-1 pattern 101-1 and simultaneously apply a touch driving signal obtained by inverting a phase of the touch driving signal by 180° to the first-2 pattern 101-2 to reduce or remove a flicker occurring on the display panel including the sensor unit 10″″″. The flicker represents a feature in which flickering occurs on the display panel that is influenced when the touch driving signals applied simultaneously to at least two first patterns of the plurality of first patterns 101 of FIG. 19 are added. Since the touch driving signals having opposite phases are applied simultaneously to each of the first patterns 101′ of the sensor unit 10″″″′ of FIG. 22, even when the two touch driving signals are added together, a sum thereof is ‘0’, which does not give an effect on the display panel. Thus, the flicker phenomenon does not occur.

Although not shown in a separate drawing, the first-1 pattern 101-1 and the first-2 pattern 101-2 of each of the first patterns 101′ may have the pattern shape illustrated in FIG. 21.

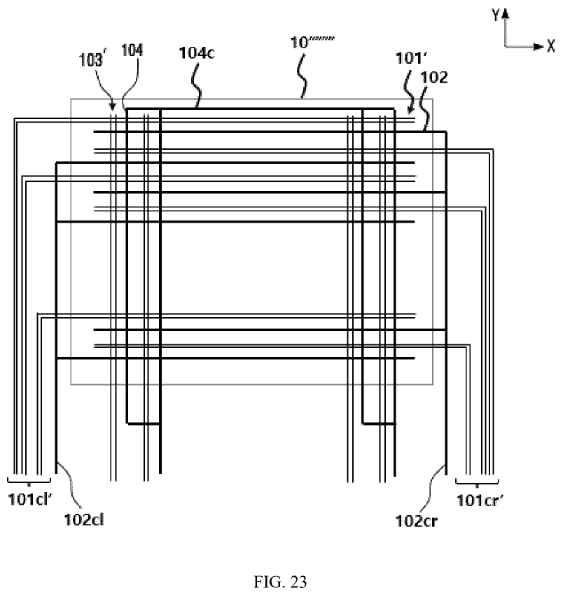

FIG. 23 is a schematic view illustrating another modified example of the sensor unit 10′″″ in FIG. 19.

As illustrated in FIG. 23, a sensor unit 10″″″″ includes first to fourth patterns 101′, 102, 103′, and 104.

When compared with the sensor unit 10′″″ in FIG. 19, the sensor unit 10″″″″ in FIG. 23 has a difference in terms of a plurality of first patterns 101′ and a plurality of second patterns 103′. The plurality of first patterns 101′ is the same as the plurality of first patterns 101′ in FIG. 22, and the plurality of third patterns 103′ is the same as the plurality of third patterns 103′ in FIG. 20.

Although there is a disadvantage in which the number of pins of the touch controller (not shown) slightly increases when the sensor unit 10″″″″ in FIG. 23 is used, the sensor units 10″″″ and 10″″″ in FIGS. 20 and 22 may exhibit technical effects together. That is, sensing sensitivity may be improved by cancelling a display noise acting on the sensor unit 100″″″″ and a low ground mass (LGM) caused by a poor ground of an object, and a flicker occurring on the display panel including the sensor unit 100″″″″ may be reduced or removed.

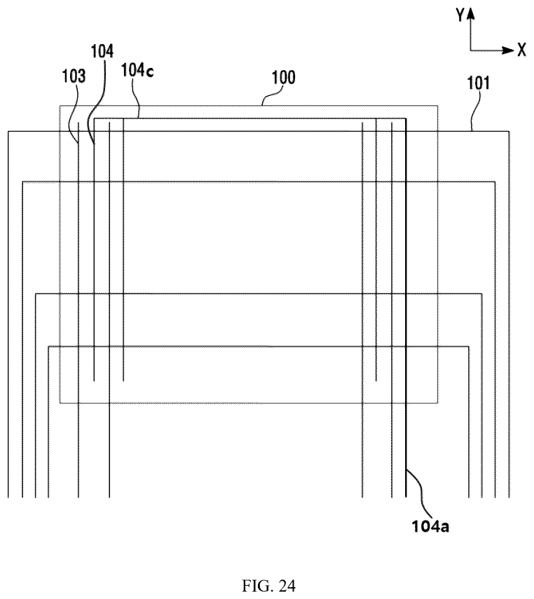

FIG. 24 is a schematic view illustrating the sensor unit 100 in FIG. 5.

As illustrated in FIG. 24, a sensor unit 100 includes a first pattern 101, a third pattern 103, and a fourth pattern 104. Here, the first pattern 101 may be referred to as a first pattern in the first direction X, the third pattern 103 may be referred to as a first pattern in the second direction Y, and the fourth pattern 104 may be referred to as a second pattern in the second direction Y.

The plurality of first patterns 101 of the sensor unit 100 in FIG. 24 is connected to the touch controller (not shown) in the double routing method. Thus, there is an advantage of expanding the touch bandwidth and preventing the half-half distortion.

The plurality of fourth patterns 104 of the sensor unit 100 in FIG. 24 may be electrically floating instead of being electrically connected to the touch controller (not shown). When the touch controller (not shown) drives the sensor unit 100 in the third mode (or downlink mode) that senses a pen signal, the touch controller (not shown) may sense the pen signal through the plurality of third patterns 103. The pen signal from the plurality of third patterns 103 is transmitted from the plurality of fourth patterns 104 by capacitive coupling. Also, the touch controller (not shown) may directly receive the pen signal through the plurality of first patterns 101.

At least one fourth pattern 104a among the plurality of fourth patterns 104 of the sensor unit 100 in FIG. 24 may be electrically connected to the touch controller (not shown). When the touch controller (not shown) operates the sensor unit 100 in the first mode (touch sensing mode), the touch controller (not shown) may control the plurality of fourth patterns 104 to be electrically grounded. This may minimize an influence of the plurality of fourth patterns 104 in the first mode.

On the other hand, when the sensor unit 100 in FIG. 24 uses the plurality of first patterns 101 to drive the stylus pen, a total resistance of the plurality of first patterns 101 and the traces connected thereto relatively increases in comparison with a case of not using the double routing method. Thus, although a power consumption in the second mode (uplink mode) is relatively high, since all or most of the plurality of fourth patterns 104 are not used, there is an advantage of reducing the number of channels of the touch controller (not shown).

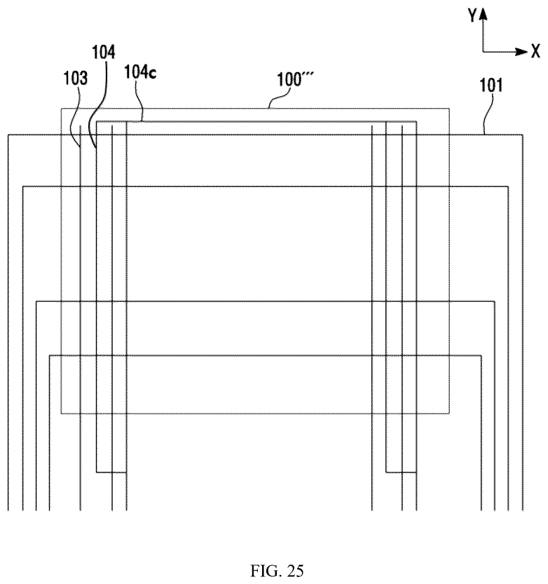

FIG. 25 is a schematic view illustrating a modified example of the sensor unit 100 in FIG. 24.

As illustrated in FIG. 25, a sensor unit 100′″ includes a first pattern 101, a third pattern 103, and a fourth pattern 104.

When compared with the sensor unit 100′″ in FIG. 24, the sensor unit 100′″ in FIG. 25 has a difference in that lower ends of the plurality of fourth patterns 104 are connected in pairs in parallel, and the portion connected in parallel is electrically connected to the touch controller (not shown).

The touch controller (not shown) may use the plurality of first patterns 101 and the plurality of third patterns 103 when operated in the first mode (touch sensing mode). Specifically, the touch controller (not shown) may apply the touch driving signal to the plurality of first patterns 101 and receive the touch sensing signal from the plurality of third patterns 103. The touch controller (not shown) may operate the first mode in the method described in FIG. 6 or 11.

The touch controller (not shown) may operate the plurality of fourth patterns 104 as a pattern for driving the stylus pen in the second mode (uplink mode). In this case, a total resistance of the plurality of fourth patterns 104 may be relatively reduced because the lower ends of the plurality of fourth patterns 104 are connected in pairs in parallel in comparison with the sensor unit 100 of FIG. 24. Thus, there is an advantage of reducing the power consumption by up to a half in comparison with a case of driving the stylus pen using the sensor unit 100 of FIG. 24.

Also, the touch controller (not shown) may directly receive the pen signal through the plurality of first patterns 101 and receive the pen signal through the plurality of third patterns 103. Here, the pen signal from the plurality of first patterns 101 may be sensed in one of the methods in FIG. 9, 11A, or 11B, and the pen signal from the plurality of third patterns 103 may be transmitted from the plurality of fourth patterns 104 and sensed by capacitive coupling.

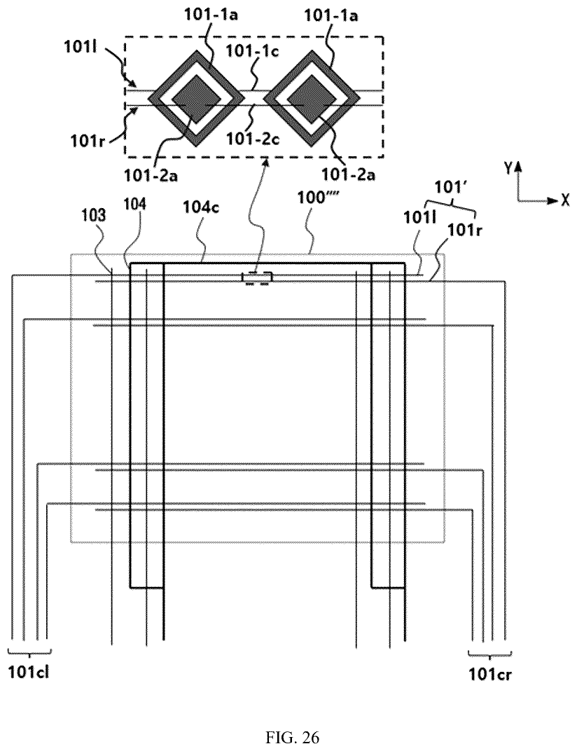

FIG. 26 is a schematic view illustrating a modified example of the sensor unit 100′″ in FIG. 25.

As illustrated in FIG. 26, a sensor unit 100″″ includes a first pattern 101′, a third pattern 103, and a fourth pattern 104.

The sensor unit 100″″ of FIG. 26 has a difference from the sensor unit 100′″ of FIG. 25 in terms of a plurality of first patterns 101′.

Each of the plurality of first patterns 101′ includes a first-1 pattern 1011 and a first-2 pattern 101r. The first-1 pattern 1011 and the first-2 pattern 101r are arranged in the first direction X and adjacent to each other. The first pattern 1011 and the second pattern 101r are physically spaced apart from each other to form capacitive coupling therebetween.

The first pattern 1011 has both ends of which one end (left end) is electrically connected to the touch controller (not shown) through a trace 101cl, and the second pattern 101r has both ends of which the other end (right end) is electrically connected to the touch controller (not shown) through a trace 101cr.

The first-1 pattern 1011 includes a plurality of main patterns 101-1a arranged in the first direction X and connection patterns 101-1c that connect two adjacent main patterns 101-1a among the plurality of main patterns 101-1a. Each of the main patterns 101-1a of the first-1 pattern 1011 may have a rectangular shape, a rhombus shape, or a diamond shape and have an opening in which each of the main patterns 101-2a of the first-2 pattern 101r is disposed.

The first-2 pattern 101r includes a plurality of main patterns 101-2a arranged in the first direction X and connection patterns 101-2c that connect two adjacent main patterns 101-2a among the plurality of main patterns 101-2a. Each of the main patterns 101-2a of the first-2 pattern 101r may have a rectangular shape, a rhombus shape, or a diamond shape. Each of the main patterns 101-2a of the first-2 pattern 101r may have a shape corresponding to that of each of the main patterns 101-1a of the first-1 pattern 1011.

Each of the main patterns 101-1a of the first-1 pattern 1011 is disposed relatively closer to the third pattern 103 than each of the main patterns 101-2a of the first-2 pattern 101r.

Each of the plurality of third patterns 101′ includes the first-1 pattern 1011 and the first-2 pattern 101r, and each of the first-1 pattern 1011 and the first-2 pattern 101r is connected to the touch controller (not shown) through respective traces 101cl and 101cr. Thus, although the number of pins for the plurality of third patterns 101′ in the touch controller (not shown) increases by two times when compared with the sensor unit 100′″ in FIG. 25, in the first mode (touch driving mode), the touch controller (not shown) may apply the touch driving signal to the plurality of third patterns 103 and differentiate two touch sensing signals output from the first-1 pattern 1011 and the first-2 pattern 101r, respectively, to cancel a display noise acting on the sensor unit 100″″″ and a low ground mass (LGM) caused by a poor ground of an object, thereby improving sensing sensitivity.

Although not shown in a separate drawing, the first-1 pattern 1011 and the first-2 pattern 101r of each of the first patterns 101′ may have the pattern shape illustrated in FIG. 21.

On the other hand, the touch controller (not shown) may operate the second mode (uplink mode) by using the plurality of fourth patterns 104.

Also, the touch controller (not shown) may operate the third mode (downlink mode) by using the plurality of first patterns 101′ and the plurality of third patterns 103. Here, the touch controller (not shown) may receive a pen signal transmitted from the fourth pattern 104 to the third pattern 103 through the plurality of third patterns 103 by capacitive coupling. The touch controller (not shown) may directly receive the pen signal through the plurality of first patterns 101′.

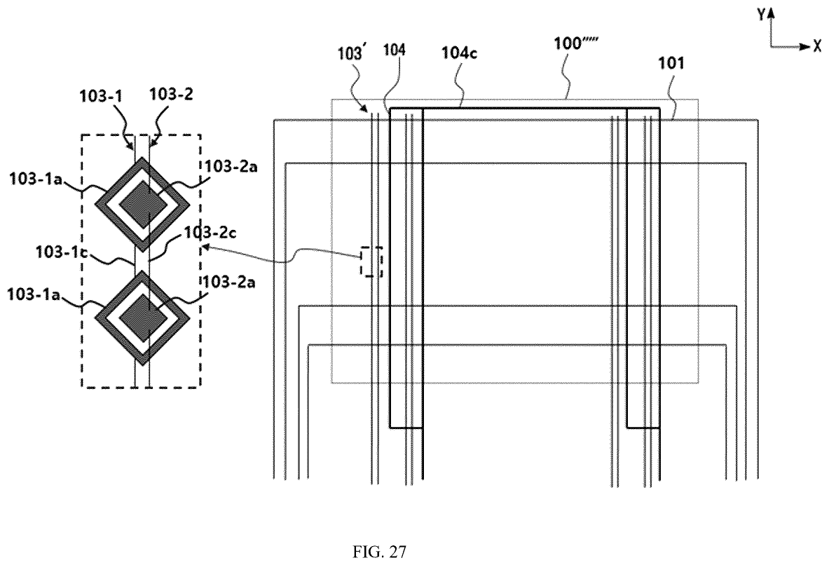

FIG. 27 is a schematic view illustrating another modified example of the sensor unit 100′″ in FIG. 25.

As illustrated in FIG. 27, a sensor unit 100′″″ includes a first pattern 101, a third pattern 103′, and a fourth pattern 104.

The sensor unit 100′″″ in FIG. 27 has a difference from the sensor unit 100′″ in FIG. 25 in terms of a plurality of third patterns 103′.

Each of the plurality of third patterns 103′ includes a third-1 pattern 103-1 and a third-2 pattern 103-2, which are adjacent to each other.

The third-1 pattern 103-1 includes a plurality of main patterns 103-1a arranged in the second direction Y and connection patterns 103-1c that connect two adjacent main patterns 103-1a among the plurality of main patterns 103-1a. Each of the main patterns 103-1a of the third-1 pattern 103-1 may have a rectangular shape, a rhombus shape, or a diamond shape and have an opening in which each of the main patterns 103-2a of the third-2 pattern 103-2 is disposed.

The third-2 pattern 103-2 includes a plurality of main patterns 103-2a arranged in the second direction Y and connection patterns 103-2c that connect two adjacent main patterns 103-2a among the plurality of main patterns 103-2a. Each of the main patterns 103-2a of the third-2 pattern 103-2 may have a rectangular shape, a rhombus shape, or a diamond shape. Each of the main patterns 103-2a of the third-2 pattern 103-2 may have a shape corresponding to that of each of the main patterns 103-1a of the third-1 pattern 103-1.

Each of the main patterns 103-1a of the third-1 pattern 103-1 is disposed relatively closer to the first pattern 101 than each of the main patterns 103-2a of the third-2 pattern 103-2.

Each of the plurality of third patterns 103′ includes the third-1 pattern 103-1 and the third-2 pattern 103-2, and each of the third-1 pattern 103-1 and the third-2 pattern 103-2 is connected to the touch controller (not shown). Thus, although the number of pins for the plurality of first patterns 101′ in the touch controller (not shown) increases by two times when compared with the sensor unit 100′″ in FIG. 25, in the first mode (touch driving mode), the touch controller (not shown) may apply the touch driving signal to the third-1 pattern 103-1 and simultaneously apply a touch driving signal obtained by inverting a phase of the touch driving signal by 180° to the third-2 pattern 103-2 to reduce or remove a flicker occurring on the display panel including the sensor unit 100′″″.

Although not shown in a separate drawing, the third-1 pattern 103-3 and the third-2 pattern 103-2 of each of the third patterns 103′ may have the pattern shape illustrated in FIG. 21.

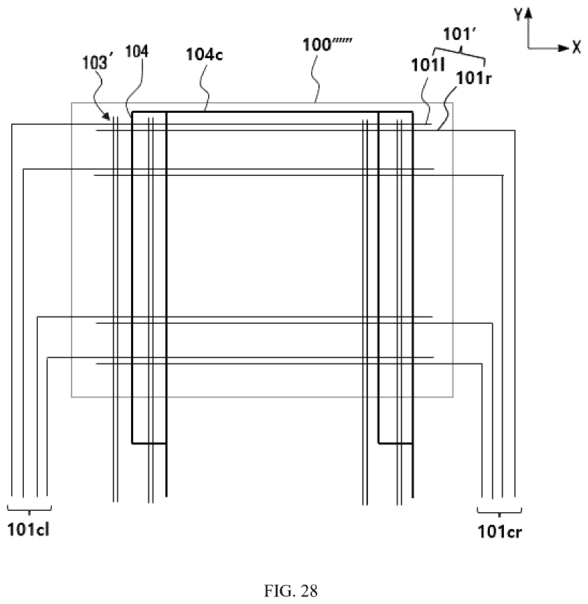

FIG. 28 is a schematic view illustrating another modified example of the sensor unit 100′″ in FIG. 25.

As illustrated in FIG. 28, a sensor unit 100″″″ includes a first pattern 101′, a third pattern 103′, and a fourth pattern 104.

When compared with the sensor unit 100′″ in FIG. 25, the sensor unit 100″″″ in FIG. 28 has a difference in terms of a plurality of first patterns 101′ and a plurality of second patterns 103′. The plurality of first patterns 101′ is the same as the plurality of first patterns 101′ in FIG. 26, and the plurality of third patterns 103′ is the same as the plurality of third patterns 103′ in FIG. 27.

Although there is a disadvantage in which the number of pins of the touch controller (not shown) slightly increases when the sensor unit 100″″″ in FIG. 28 is used, the sensor units 100″″ and 100′″″ in FIGS. 26 and 27 may exhibit technical effects together. That is, sensing sensitivity may be improved by cancelling a display noise acting on the sensor unit 100″″ and a low ground mass (LGM) caused by a poor ground of an object, and a flicker occurring on the display panel including the sensor unit 100″″″ may be reduced or removed.

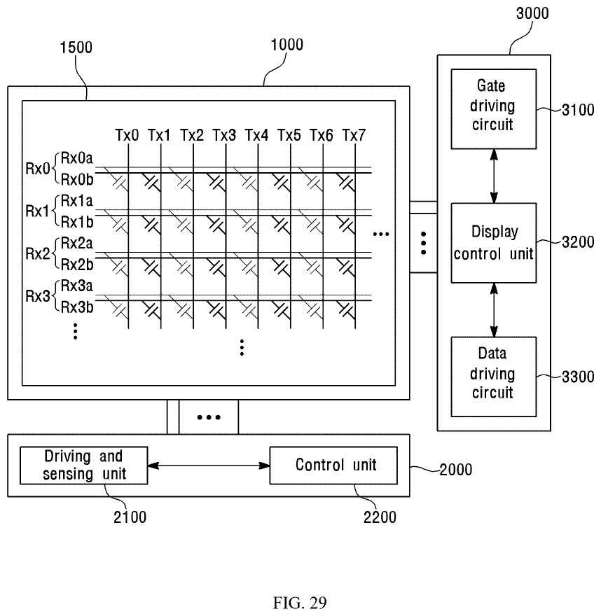

FIG. 29 is a block diagram of an electronic device according to a fourth embodiment of the present invention.

Referring to FIG. 29, the electronic device according to the fourth embodiment of the present invention includes a sensor unit 1500, a display panel 1000, a controller 2000, and a display controller 3000.

The sensor unit 1500 may be included in the display panel 1000 or separately provided. The sensor unit 1500 may include any one of the sensor units illustrated in FIGS. 4 to 25.

The sensor unit 1500 includes a plurality of first electrodes and a plurality of second electrodes. The plurality of first electrodes may be a plurality of driving electrodes Tx0, Tx1, Tx2, Tx3, Tx4, Tx5, Tx6, and Tx7, and the plurality of second electrodes may be a plurality of receiving electrodes Rx0, Rx1, Rx2, and Rx3.

The plurality of driving electrodes Tx0, Tx1, Tx2, Tx3, Tx4, Tx5, Tx6, and Tx7 may be the plurality of first patterns 101 in FIGS. 4 to 25, and the plurality of receiving electrodes Rx0, Rx1, Rx2, and Rx3 may be the plurality of third patterns 103 in FIGS. 4 to 25. On the contrary, the plurality of driving electrodes Tx0, Tx1, Tx2, Tx3, Tx4, Tx5, Tx6, and Tx7 may be the plurality of third patterns 103 in FIGS. 4 to 25, and the plurality of receiving electrodes Rx0, Rx1, Rx2, and Rx3 may be the plurality of first patterns 101 in FIGS. 4 to 25.

The controller 2000 controls the sensor unit 1500. The controller 2000 may include any one of the touch controllers illustrated in FIGS. 4 to 25. The controller 2000 may include a driving and sensing unit 2100 and a control unit 2200.

The controller 2000 may sequentially apply driving signals to the plurality of driving electrodes Tx0, Tx1, Tx2, Tx3, Tx4, Tx5, Tx6, and Tx7 of the sensor unit 1500 or simultaneously apply predetermined driving signals to at least two of the plurality of driving electrodes Tx0, Tx1, Tx2, Tx3, Tx4, Tx5, Tx6, and Tx7.

The controller 2000 may receive sensing signals output from the plurality of receiving electrodes Rx0, Rx1, Rx2, and Rx3 of the sensor unit 1500. Here, the sensing signal may contain information on an amount of variation in capacitance between the receiving electrode and the driving electrode adjacent thereto, a low ground mass (LGM) noise signal, and a display noise signal.

Each of the receiving electrodes Rx0, Rx1, Rx2, and Rx3 may include a pair of receiving electrodes. For example, the 0-th receiving electrode Rx0 may include a pair of receiving electrodes Rx0a and Rx0b, a plurality of pair of receiving electrodes Rx0a and Rx0b may be alternately arranged, a plurality of 0a receiving electrodes Rx0a may be electrically connected to each other, and a plurality of 0b receiving electrodes Rx0b may be electrically connected to each other.

The 0a receiving electrode Rx0a may be arranged to form a dominant mutual capacitance with the 0-th driving electrode Tx0, the second driving electrode Tx2, the fourth driving electrode Tx4, and the sixth driving electrode Tx6, and the 0b receiving electrode Rx0b may be arranged to form a dominant mutual capacitance with the first driving electrode Tx1, the third driving electrode Tx3, the fifth driving electrode Tx5, and the seventh driving electrode Tx7. On the other hand, the 0a receiving electrode Rx0a may be arranged to form a relatively insignificant mutual capacitance with the first driving electrode Tx1, the third driving electrode Tx3, the fifth driving electrode Tx5, and the seventh driving electrode Tx7, and the 0b receiving electrode Rx0b may be arranged to form a relatively insignificant mutual capacitance with the 0-th driving electrode Tx0, the second driving electrode Tx2, the fourth driving electrode Tx4, and the sixth driving electrode Tx6.

The rest receiving electrodes Rx1, Rx2, and Rx3 may be also configured in the same manner as the 0-th receiving electrode Rx0.

The controller 2000 may analog-to-digital convert the sensing signal output from the plurality of receiving electrodes Rx0, Rx1, Rx2, and Rx3 to output a digital sensing signal.

The controller 2000 may output two signals among the sensing signals output from the plurality of receiving electrodes Rx0, Rx1, Rx2, and Rx3 as differential signals and analog-to-digital convert the output signals to output the converted signals. The controller 2000 may detect whether a touch is generated and/or a touch position based on the digital signal output from the controller 200.

The controller 2000 may include a driving and sensing unit 2100 that applies a driving signal to at least one of the driving electrodes Tx0, Tx1, Tx2, Tx3, Tx4, Tx5, Tx6, and Tx7 of the sensor unit 1500 and receives a sensing signal from the plurality of receiving electrodes Rx0, Rx1, Rx2, and Rx3 of the sensor unit 1500 and a control unit 2200 that controls the driving and sensing unit 2100.

A plurality of scan lines (or gate lines) and a plurality of data lines may be disposed on the display panel 1000. A subpixel may be disposed on an area in which the scan lines cross the data lines.

The display panel 1000 may include an active area on which a plurality of subpixels are disposed and an inactive area (dead space or bezel) disposed outside the active area. The active area may constitute a display screen of the electronic device. The display screen may have a landscape shape in which a horizontal length is greater than a vertical length. Alternatively, the display screen may have a portrait shape in which a vertical length is greater than a horizontal length.

The display controller 3000 controls the display panel 1000 and includes a gate driving circuit 3100, a display control unit 3200, and a data driving circuit 3300.

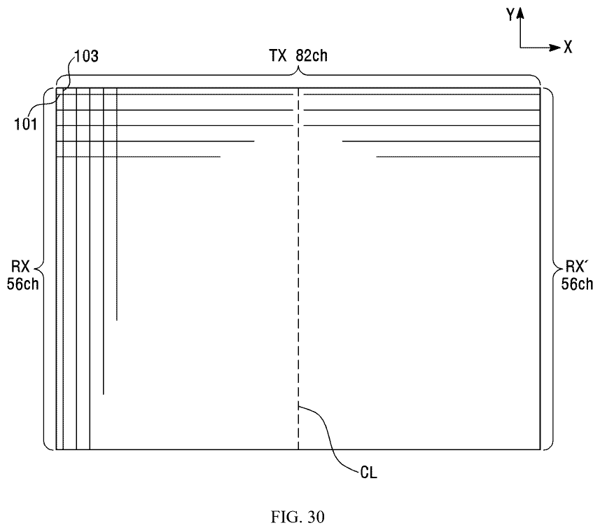

FIG. 30 is a view for explaining a typical sensor unit having a landscape shape.

The sensor unit in FIG. 30 may detect only a position of a touch of an object such as a finger. The sensor unit includes a plurality of first patterns 101 each extending in the first direction X that is a major axis and a plurality of third patterns 103 each extending in the second direction Y that is a minor axis. The plurality of first patterns 101 and the plurality of third patterns 103 are arranged to cross each other and electrically insulated from each other.

In the sensor unit in FIG. 30, the plurality of third patterns 103 function as driving electrodes TX to which a touch driving signal is applied, and the plurality of first patterns 101 function as receiving electrodes RX from which a touch sensing signal is output. Each of the first patterns 101 is divided into two patterns based on an imaginary cutting line CL.

In FIG. 30, the plurality of first patterns 101 includes a total of 112 patterns. Based on the cutting line CL, 56 first patterns 101 are arranged at a left side, and 56 first patterns 101 are arranged at a right side. Also, the plurality of third patterns 103 include a total of 82 patterns. Thus, the total number of channels (or pins) of the touch controller (not shown) for controlling the sensor unit in FIG. 30 is 194.

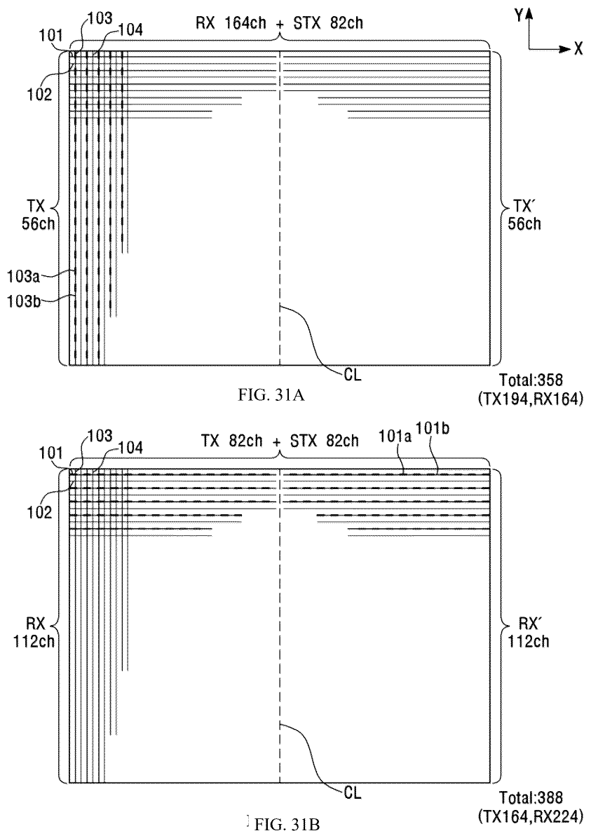

FIGS. 31A and 31B are views for explaining other typical sensor units each having the landscape shape.

The typical sensor unit in FIG. 31A may not only sense a position of an object such as a finger but also drive the stylus pen or sense the position of the stylus pen. To this end, the typical sensor unit in FIG. 31A further includes a second pattern 102 and a fourth pattern 104 in addition to the sensor unit in FIG. 30. Also, in order to remove a noise, each of third patterns 103, which functions as the receiving electrode RX, includes a pair of electrodes 103a and 103b arranged alternately along the second direction Y as illustrated in FIG. 29.

When compared with the typical sensor unit in FIG. 30, since the typical sensor unit in FIG. 31A further includes the plurality of second patterns 102 and the plurality of fourth patterns 104, and each of the third patterns 103 includes the pair of electrodes 103a and 103b, the total number of channels of the touch controller (not shown) is 358 that is a sum of the number (56) of the plurality of first patterns 101 at the left side based on the cutting line CL, the number (56) of the plurality of first patterns at the right side, the number (164) of the plurality of third patterns 103, and the number (82) of the plurality of fourth patterns 104. Here, since the plurality of second patterns 102 are not electrically connected to the touch controller (not shown), the number of the second patterns 102 is not added to the number of channels of the touch controller (not shown).

When compared with the sensor unit in FIG. 31A, the sensor unit in FIG. 31B has a difference in that the plurality of first patterns 101 function as receiving electrodes RX, the plurality of third patterns 103 function as driving electrodes TX, and each of the first patterns 101 includes a plurality of pair of electrodes 101a and 101b arranged alternately in the first direction X.

When compared with the typical sensor unit in FIG. 31A, since the typical sensor unit in FIG. 31B includes the first patterns 101 each including the pair of electrodes 101a and 101b arranged alternately in the first direction X, the total number of channels of the touch controller (not shown) is 388.

When FIGS. 31A and 31B are compared with each other, the number of channels of the touch controller (not shown) for the sensor unit in FIG. 31B requires relatively more due to characteristics of the landscape shape.

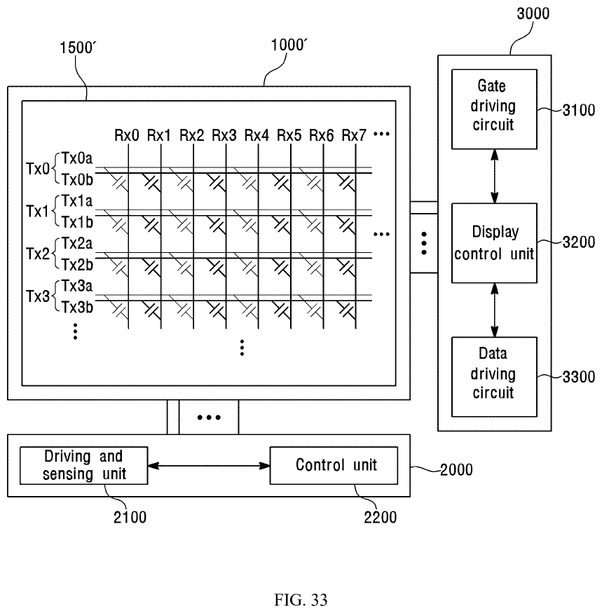

FIGS. 33A and 33B are views for explaining a sensor unit of an electronic device according to a fifth embodiment of the present invention.

In the sensor unit in FIG. 33A includes third patterns 103 each including a plurality of pair of electrodes 103a and 103b that are alternately arranged in the second direction Y as illustrated in FIG. 29 in addition to the sensor unit in FIG. 5, which is connected to a touch controller (not shown) in the double routing method.

The number of channels of the touch controller (not shown) for the sensor unit in FIG. 33A is 276. Here, the plurality of fourth patterns 104 are not electrically connected to the touch controller (not shown). When compared with the typical sensor unit in FIG. 31A, since the plurality of first patterns 101 connected in the double routing method function even in the second mode that drives the stylus pen, there is an advantage of relatively reducing the number of channels of the touch controller (not shown) by approximately 22%.

The sensor unit in FIG. 33B is configured such that each of the first patterns 101 of the sensor unit in FIG. 5 includes a plurality of pair of electrodes 101a and 101b that are alternately arranged in the first direction X as illustrated in FIG. 29.

The number of channels of the touch controller (not shown) for the sensor unit in FIG. 33B is 306. Here, the plurality of fourth patterns 104 are not electrically connected to the touch controller (not shown). When compared with the touch controller (not shown) for the typical sensor unit in FIG. 31B, since the plurality of first patterns 101 connected in the double routing method also function in the second mode for driving the stylus pen, there is an advantage of relatively reducing the number of channels of the touch controller (not shown) by approximately 22%.

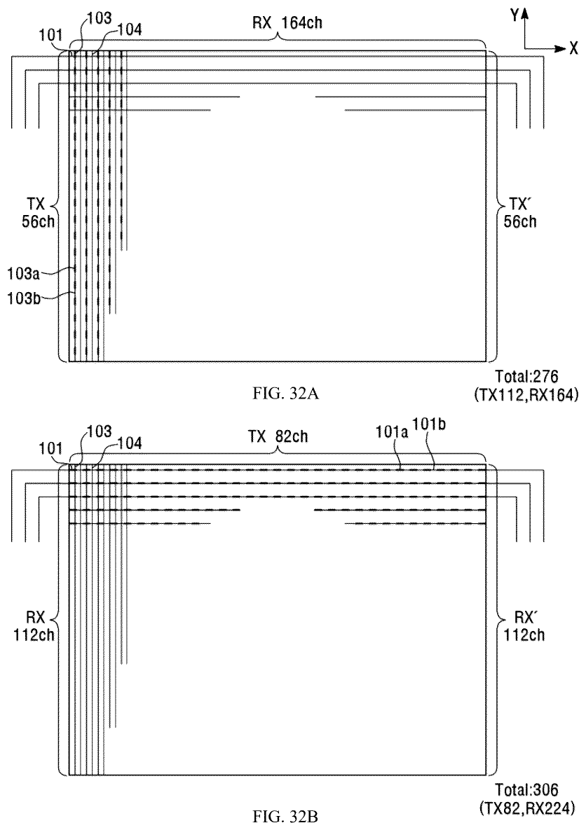

Although there is no particular limitation when the display screen of the electronic device including the sensor unit in FIGS. 31A, 31B, 32A and 32B has a size of a general size of a screen of a smartphone, e.g., 6.9 inches, when the display screen has a size that increases to 11 inches to 16 inches, such as that of a tablet PC or a foldable device, a length of each of the first to fourth patterns 101, 102, 103, and 104) of the sensor unit in FIGS. 31A and 31B also increases. Thus, an overall resistance and a capacitance value of the sensor unit increase. Since the increase in resistance and capacitance value decrease a bandwidth of an operation frequency of each of a touch driving signal applied to the touch driving electrodes TX and a pen driving signal applied to the stylus pen driving electrode STX, a limitation of not obtaining a required bandwidth of the operation frequency required in design may occur.

On the other hand, in a case of the embodiment of the present invention in FIGS. 32A and 32B, since no exclusive channels for the stylus pen driving electrodes STX exist, there is an advantage of expanding the bandwidth of the operation frequency required in design because the resistance and capacitance value may be reduced.

FIG. 33 is a block diagram of an electronic device according to a sixth embodiment of the present invention.

The electronic device illustrated in FIG. 33 has a difference from the electronic device according to the fourth embodiment illustrated in FIG. 29 as stated below.

Although, in the touch sensor 1500 in FIG. 29, the plurality of first electrodes serve as the plurality of driving electrodes Tx0, Tx1, Tx2, Tx3, Tx4, Tx5, Tx6, and Tx7, and the plurality of second electrodes serve as the plurality of receiving electrodes Rx0, Rx1, Rx2, and Rx3, in a sensor unit 1500′ in FIG. 33, on the contrary, a plurality of first electrodes serve as a plurality of receiving electrodes Rx0, Rx1, Rx2, Rx3, Rx4, Rx5, Rx6, and Rx7, and a plurality of second electrodes serve as a plurality of driving electrodes Tx0, Tx1, Tx2, and Tx3.

The plurality of driving electrodes Tx0, Tx1, Tx2, and Tx3 may be the plurality of first patterns 101 in FIGS. 4 to 25 and FIGS. 32A and 32B, and the plurality of receiving electrodes Rx0, Rx1, Rx2, Rx3, Rx4, Rx5, Rx6, and Rx7 may be the plurality of third patterns 103 in FIGS. 4 to 25 and FIGS. 32A and 32B. On the contrary, the plurality of driving electrodes Tx0, Tx1, Tx2, and Tx3 may be the plurality of third patterns 103 in FIGS. 4 to 25 and FIGS. 32A and 32B, and the plurality of receiving electrodes Rx0, Rx1, Rx2, Rx3, Rx4, Rx5, Rx6, and Rx7 may be the plurality of first patterns 101 in FIGS. 4 to 25 and FIGS. 32A and 32B.

The feature in which the plurality of first electrodes serve as the plurality of driving electrodes as illustrated in FIG. 29 or serve as the plurality of receiving electrodes as illustrated in FIG. 33 may be determined by control of a control unit 2200.

When the control unit applies a driving signal to the plurality of first electrodes, the plurality of first electrodes may serve as the plurality of driving electrodes, and when the control unit applies a driving signal to the plurality of second electrodes, the plurality of second electrodes may serve as the plurality of driving electrodes.

The plurality of driving electrodes Tx0, Tx1, Tx2, and Tx3 and the plurality of receiving electrodes Rx0, Rx1, Rx2, Rx3, Rx4, Rx5, Rx6, and Rx7 may be arranged to cross each other. Each of the driving electrodes Tx0, Tx1, Tx2, and Tx3 may extend in a second axis direction, and each of the receiving electrode Rx0, Rx1, Rx2, Rx3, Rx4, Rx5, Rx6, and Rx7 may extend in a first axis direction different from the second axis direction. Here, the first axis direction may be perpendicular to the second axis direction.

Some driving electrodes Tx0a, Tx1a, Tx2a, Tx3a, . . . among the plurality of driving electrodes Tx0, Tx1, Tx2, and Tx3 may be arranged to form a mutual capacitance Cm with even-numbered receiving electrodes Rx0, Rx2, Rx4, Rx6, . . . among the plurality of receiving electrodes Rx0, Rx1, Rx2, . . . , and the rest driving electrodes Tx0b, Tx1b, Tx2b, Tx3b, . . . among the plurality of driving electrodes Tx0, Tx1, Tx2, and Tx3 may be arranged to form a mutual capacitance Cm with odd-numbered receiving electrodes Rx1, Rx3, Rx5, Rx7, . . . among the plurality of receiving electrodes Rx0, Rx1, Rx2, . . . .

Some driving electrodes Tx0a, Tx1a, Tx2a, Tx3a, . . . among the plurality of driving electrodes Tx0, Tx1, Tx2, and Tx3 may be arranged directly adjacent to the even-numbered receiving electrodes Rx0, Rx2, Rx4, Rx6, . . . among the plurality of receiving electrodes Rx0, Rx1, Rx2, . . . and spaced a predetermined distance from the odd-numbered receiving electrodes Rx1, Rx3, Rx5, Rx7, . . . instead of being directly adjacent thereto. Here, at least one different electrode may be disposed between the some driving electrodes Tx0a, Tx1a, Tx2a, Tx3a, . . . and the rest odd-numbered receiving electrodes Rx1, Rx3, Rx5, Rx7 . . . .

The different electrode may be one of the some even-numbered receiving electrodes Rx0, Rx2, Rx4, Rx6 . . . .

The rest driving electrodes Tx0b, Tx1b, Tx2b, Tx3b, . . . among the driving electrodes Tx0, Tx1, Tx2, and Tx3 may be arranged directly adjacent to the rest odd-numbered receiving odd-numbered electrodes Rx1, Rx3, Rx5, Rx7, . . . among the plurality of receiving electrodes Rx0, Rx1, Rx2, . . . and spaced a predetermined distance from the even-numbered receiving electrodes Rx0, Rx2, Rx4, Rx6, . . . instead of being directly adjacent thereto.

Here, at least one different electrode may be disposed between the rest driving electrodes Tx0b, Tx1b, Tx2b, Tx3b, . . . and the some even-numbered receiving electrodes Rx0, Rx2, Rx4, Rx6 . . . . The different electrode may be one of the rest odd-numbered receiving electrodes Rx1, Rx3, Rx5, Rx7 . . . .

The driving signal applied to the rest driving electrodes Tx0b, Tx1b, Tx2b, Tx3b, . . . may be an inverted driving signal obtained by inverting only a phase by 180° from the driving signal applied to the some driving electrodes Tx0a, Tx1a, Tx2a, Tx3a, . . . .

For example, a driving signal applied to the driving electrode Tx0b of the pair of driving electrodes Tx0a and Tx0b of the 0-th driving electrodes Tx0 may be an inverted driving signal obtained by inverting the driving signal applied to Tx0a.

The electronic device in FIG. 33 may perform a multi-driving of simultaneously applying driving signals to all driving electrodes Tx0, Tx1, Tx2, Tx3, . . . of the touch sensor 1500′, and a flicker does not occur on the display panel although the multi-driving is performed. Also, since the multi-driving of all driving electrodes Tx0, Tx1, Tx2, Tx3, . . . may be performed, a driving time for performing mutual sensing may be reduced. Furthermore, since a turn-on time of an analog front end (AFE) may be reduced, a power consumption may be further reduced.

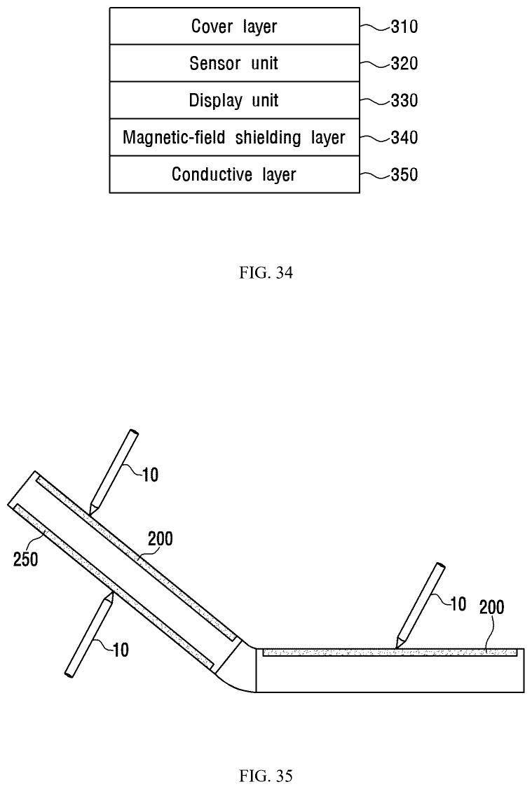

FIG. 34 is a view for explaining a stack-up structure of the electronic device according to various embodiments in FIGS. 4 to 33.

The electronic device may include a cover layer (310), a sensor unit 320, a display unit 330, a magnetic-field shielding layer 340, and a conductive layer 350.

The cover layer 310 may be disposed on the display unit 330 and made of a transparent material, and a tip of a stylus pen may directly contact a top surface (or touch surface) of the cover layer 310.

The display unit 330 is disposed below the cover layer 310 to provide predetermined visual information in response to control by a display controller (not shown). For example, the display unit 330 may be a flexible LCD module or a flexible OLED module.

The sensor unit 320 capable of driving and/or sensing the stylus pen and sensing a finger may be disposed between the cover layer 310 and the display unit 330. The sensor unit 320 may include at least one of the sensor units described above through FIGS. 4 to 33.

The magnetic-field shielding layer 340 may block a magnetic field to prevent other electronic components in the electronic device from being affected by the magnetic field. Also, the magnetic-field shielding layer 340 may diffuse heat emitted from the electronic components and block an electromagnetic wave (EMI) from the electronic components.

The conductive layer 350 may be made of metals such as copper or aluminum or may be an alloy made by adding other metal or non-metal elements to at least one metal. The conductive layer 350 may electrically have a ground potential.

FIG. 35 is a schematic view of a foldable device that is an example of the electronic device described in FIGS. 4 to 34.

The foldable device includes an inner touch screen 200 and an outer touch screen 250.

As described above, since the electronic device in FIGS. 4 to 34 may drive and/or sense not only the object such as a finger but also the stylus pen by the sensor unit, the foldable device that is the electronic device according to the embodiments of the present invention does not require the digitizer described in FIG. 4. Thus, since the digitizer is not required to be attached to a lower portion of each of the inner touch screen 200 and the outer touch screen 250, increase in overall thickness and manufacturing costs of the foldable device may be prevented.

Also, the function of the stylus pen may be supported in not only the inner touch screen but also the outer touch screen.

Also, as the first pattern is connected to the touch controller in the double routing method, a connection condition of the sensor during an object touch and a stylus touch, such as driving, receiving, grounding, and floating, may be flexibly controlled according to demands of a user.

Also, since switching through a multiplexer in the touch controller is not required, a current loss caused by own resistance of the multiplexer may be prevented, and a configuration of the electronic device may be simplified.

Also, in a case of a tablet PC or a foldable device having a large screen, additional stylus sensing sensor is not required. Thus, the number of channels of touch driving traces is reduced, and the number of channels is significantly reduced in comparison with a typical touch screen for finger and stylus touch. Thus, a thickness of a bezel in a width direction of the electronic device may be significantly reduced.

Also, as additional stylus sensing sensor is not required, the stylus function may be performed on both surfaces of the inner and outer touch screens of the foldable device without increase in thickness or manufacturing costs of the display panel.

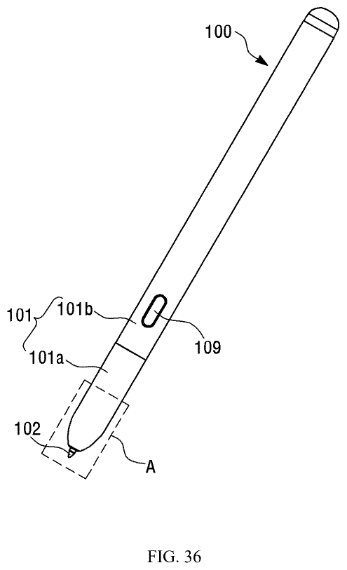

FIG. 36 is a perspective view illustrating a stylus pen 100 according to an embodiment of the present invention.

Referring to FIG. 36, a stylus pen according to an embodiment of the present invention includes a housing 101 and a core body 102.

The housing 101 defines an appearance of the stylus pen 100. The housing 101 of the stylus pen includes an inner predetermined space and has an elongated shape in one direction. The housing 101 may be formed such that two or more parts are coupled to each other or integrated into one piece.

The housing 101 may be made of a non-conductive synthetic resin material.

The housing 101 may include a first housing 101a and a second housing 101b. The first housing 101a and the second housing 101b may be coupled to each other to form the appearance of the stylus pen 100. Various components are embedded in the first housing 101a and the second housing 101b.

A button part 109 may be disposed on the housing 101. The button part 109 may be disposed at an intermediate portion of an outer surface of the second housing 101b. The button part 109 is designed to perform a specific operation of the stylus pen 100. For example, the button part 109 may be a mechanical or touch-type button used for a cancel operation.

The core body 102 includes one end that is disposed outside the housing 101, and the rest portion except the one end is disposed in the housing 101. Here, the one end of the core body 102 may be referred to as a pen tip.

One portion of the one end of the core body 102 may move inward into the housing 101 by external force applied from the outside. As the external force increases, a volume of the one portion of the one end of the core body 102, which is moved into the housing 101, may increase. When the applied external force decreases, the one portion of the one end of the core body 102 is moved out of the housing 101 by a mechanical operation of components in the housing 101. When external force is not applied, the one portion of the one end of the core body 102 is returned to an original state.

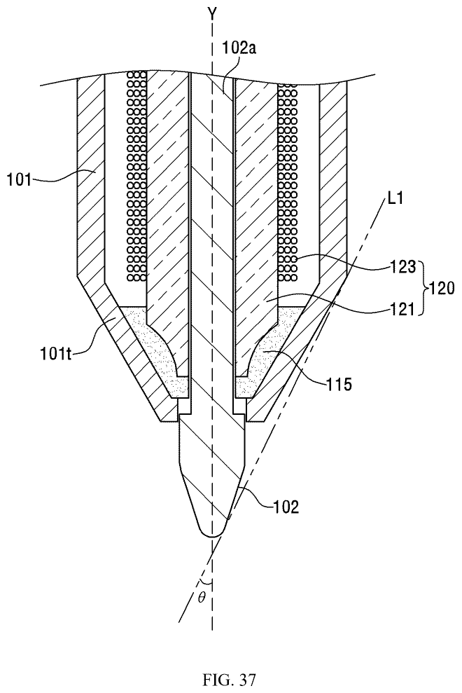

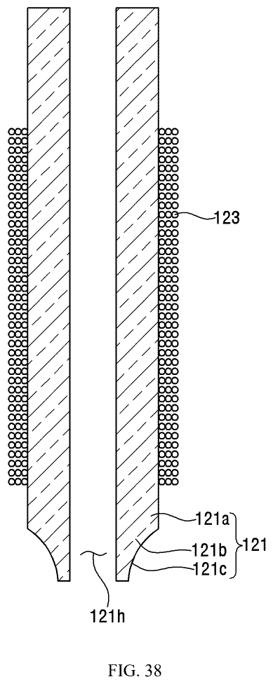

Hereinafter, an inner structure of the housing 101 will be described with reference to FIGS. 37 to 38.

FIG. 37 is a cross-sectional view illustrating portion A of the stylus pen 100 in FIG. 36, and FIG. 38 is a detailed cross-sectional view illustrating an inductor unit 120 in FIG. 37.

Referring to FIGS. 37 and 38, the stylus pen 100 according to an embodiment of the present invention includes a buffer member 115, an inductor unit 120, and a capacitor unit (not shown), which are disposed in the housing 101.

The buffer member 115 is disposed in the housing 101 and disposed between one end of a ferrite core 121 and an inner surface of the housing 101.

The buffer member 115 may be disposed in a tapered portion 101t of the housing 101. The tapered portion 101t of the housing 101, which is adjacent to the one end of the core body 102 among both ends of the housing 101, has a shape having a width or diameter that gradually decreases in a direction toward an end of the one end of the housing 101.

The buffer member 115 has a conical or polygonal pyramid shape and includes a through-hole through which one end of the ferrite core 121 and a body 102a of the core body 102 pass. An inner surface of the through-hole may have a shape corresponding to an outer surface of the one end of the ferrite core 121 and an outer surface of the body 102a of the core body 102 102. Here, the body 102a of the core body 102 refers to a portion, which is disposed in the through-hole of the ferrite core 12, in the core body 102 having an elongated shape in one direction.

The buffer member 115 may be made of an elastic material such as rubber to serve as a buffer between the ferrite core 121 and the housing 101. The buffer member 115 may protect the housing 101 and the ferrite core 121 and block an electrical or magnetic effect from the outside.

The buffer member 115 has a shape that surrounds one end or a lower end 121b of the ferrite core 121.

A virtual tangent line L1 that contacts, in common, the tapered portion 101t of the housing 101 and the portion (or pen tip) disposed outside the housing in the core body 102 forms a predetermined angle θ with a central axis Y of the core body 102. Here, the predetermined angle θ may be less than 30°. When the predetermined angle θ is less than 30°, a drawing may be performed even in a state in which the stylus pen according to an embodiment of the present invention is inclined at 60° based on a contact surface.

The inductor unit 120 may constitute an LC resonance unit with a capacitor unit (not shown). A resonance frequency may be set by a value of inductance L of the inductor unit 120 and a value of capacitance C of the capacitor unit (not shown). This resonance frequency may be varied according to variation in the value of the inductance L of the inductor unit 120 or the value of the capacitance C of the capacitor unit (not shown).

The inductor unit 120 includes a ferrite core 121 and a coil 123 wound around an outer surface of the ferrite core 121.

The coil 123 may be wound around the ferrite core 121 with at least one layer.

The ferrite core 121 may have an overall cylindrical or polygonal container shape, and a through-hole 121h that passes through the inside of the ferrite core 121 may be formed along a longitudinal direction of the ferrite core 121.

The ferrite core 121 has the through-hole 121h through which the body 102a of the core body 102 passes. The body 102a of the core body 102 may perform a linear reciprocating movement along a longitudinal direction through the through-hole 121h.

One end of the ferrite core 121 may have a tapered shape having a diameter or width that gradually decreases in a direction toward an end thereof. Here, an outer surface of the one end having the tapered shape may include at least one curved portion 121c that is curved inward.

The ferrite core 121 may include an upper end 121a and a lower end 121b disposed below the upper end 121a. Here, the upper end 121a and the lower end 121b may be integrated with each other.

The upper end 121a has a cylindrical, elliptical, or polygonal container shape. Here, the cylindrical or polygonal container shape may have a constant diameter or width as illustrated in the drawing. Alternatively, the cylindrical, elliptical, or polygonal container shape may not have a constant diameter or width, and one portion may have a diameter or width different from that of another portion.

A portion of the through-hole 121h through which the body 102a of the core body 102 passes is formed in the upper end 121a. The coil 123 is disposed on an outer surface of the upper end 121a.

The rest portion of the through-hole 121h through which the body 102a of the core body 102 passes is formed in the lower end 121b.

The lower end 121b has a tapered shape having a width that gradually decreases in a direction from top to bottom. Here, at least a portion of an outer surface of the lower end 121b has a curved portion 121c that is curved into the lower end 121b. At least one curved portion 121c may be provided. A technical effect of the stylus pen including the ferrite core 121 having the above-described curved portion 121c according to an embodiment of the present invention will be described below with reference to the drawings.

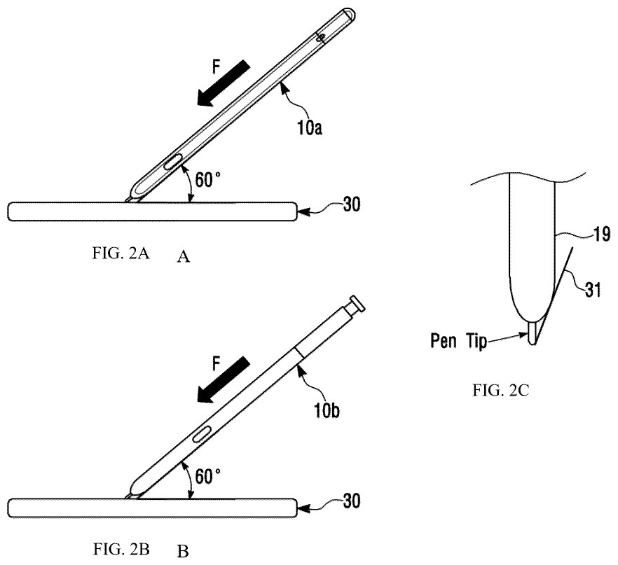

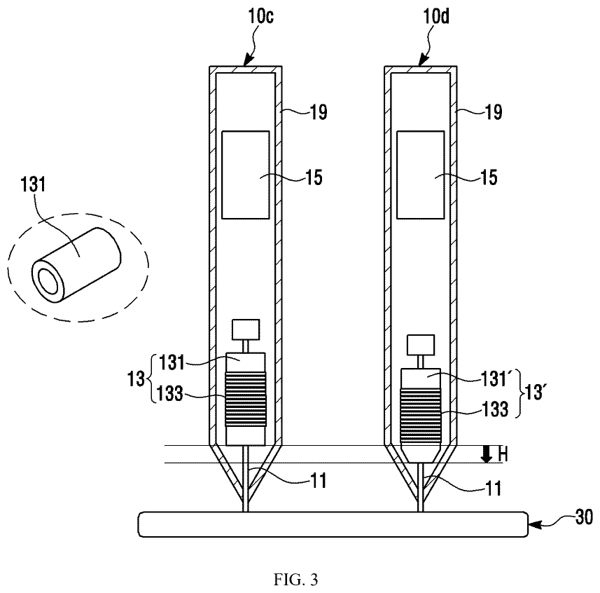

FIGS. 39A and 39B are views for explaining an inner configuration and an effect thereof of the stylus pen according to an embodiment of the present invention in FIGS. 37 and 38. Specifically, FIG. 39B is a cross-sectional view illustrating the stylus pen according to an embodiment of the present invention in FIGS. 37 and 38, and FIG. 39A is a cross-sectional view illustrating a case in which the ferrite core 121 in FIG. 39B is replaced with the ferrite core 131′ illustrated at a right side of FIG. 2.

Referring to FIGS. 39A and 39B, the stylus pen according to an embodiment of the present invention in FIG. 39B may include the ferrite core 121 that is disposed lower by a predetermined length S than the ferrite core 131′ in FIG. 39A.

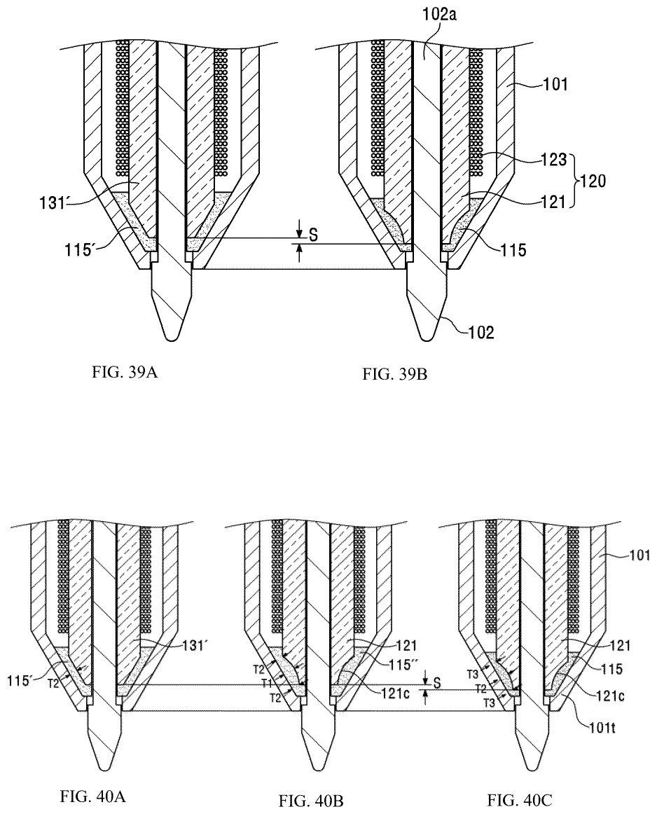

According to this configuration, when the stylus pen according to an embodiment of the present invention is used, the inductor unit 120 including the ferrite core 121 may be disposed closer to a receiver (not shown) disposed below the core body 102 of the stylus pen. Thus, there is an advantage in that a magnitude of a pen signal detected by the receiver increases. This is because a thickness (between inner and outer surfaces) of the buffer member 115 may be reduced by a shape of the ferrite core 121 of the stylus pen according to an embodiment of the present invention. Hereinafter, this will be described below with reference to FIGS. 40A to 40C.

FIGS. 40A to 40C are views for explaining in more detail an inner configuration and an effect thereof of the stylus pen according to an embodiment of the present invention in FIGS. 37 and 38. Specifically, FIG. 40A is the same as FIG. 39A, FIG. 40B is the same as FIG. 39B, and FIG. 40C is a view illustrating a case in which the ferrite core 121 is disposed at the same position as the ferrite core 131′ in FIG. 40A.

Referring to FIG. 40A, the buffer member 115′ has a constant thickness T2 between inner and outer surfaces thereof. As the thickness T2 is gradually minimized, the ferrite core 131′ may move as low as possible in the tapered portion 101t of the housing 101. However, the thickness T2 has a limitation due to a structure of the buffer member 115′ or other manufacturing processes.

Here, when it is assumed that the thickness T2 is a minimum thickness of the buffer member 115′ due to the structure of the buffer member 115′ or other manufacturing processes, FIG. 40A shows a case in which the typical ferrite core 131′ is disposed at the lowest position in the housing 101.

Referring to FIG. 40C, the ferrite core 121 is disposed at the same position as the ferrite core 131′ in FIG. 40A. Here, since the ferrite core 121 has the curved portion 121c, the buffer member 115″ is different in configuration from the buffer member 115′ in FIG. 40A. Specifically, an inner surface of the buffer member 115″ has a protruding curved surface in correspondence to the curved portion 121c of the ferrite core 121.

A thickness between an outer surface and the curved inner surface of the buffer member 115″ is varied according to positions. Specifically, each of upper and lower ends of the inner surface of the buffer member 115″ has the minimum thickness T2 from the outer surface, an intermediate portion of the inner surface of the buffer member 115″ has a thickness between T2 and T1 (where, T1>T2).

In FIG. 40C, at least one portion (upper and lower ends) of the buffer member 115″ satisfies the minimum thickness T2, and the intermediate portion of the buffer member 115″ has the thickness T1 greater than the minimum thickness T2. As described above, since the thickness T1 of the intermediate portion of the buffer member 115″ is greater than the minimum thickness T2, there is an advantage in that the buffer member 115″ is easier to manufacture than the typical buffer member 115′ in FIG. 40A.

Referring to FIG. 40B, an inner surface of the buffer member 115 is formed into a curved surface by the curved portion 121c of the ferrite core 121. Each of upper and lower ends of the inner surface of the buffer member 115 has a thickness T3 (T3<T2) from the outer surface of the buffer member 115, and an intermediate portion of the inner surface of the buffer member 115 has a thickness between T3 and T2 from the outer surface of the buffer member 115.

In FIG. 40B, although the upper and lower ends of the buffer member 115 do not satisfy the minimum thickness T2, since the intermediate portion of the buffer member 115 satisfies the minimum thickness T2, the buffer member 115 may be manufactured. Since the buffer member 115 manufactured as described above has the minimum thickness less than that of each of the buffer members 115′ and 115″ in FIGS. 40A and 40C, a volume of the buffer member 115 may be further reduced. Thus, the buffer member 115 may move further downward in the tapered portion 101t of the housing 101. Accordingly, the ferrite core 121 may be disposed lower by a predetermined height S than those in (a) and FIG. 40C.

FIG. 41 is a view for explaining an amount of increase in magnitude of a pen signal according to the predetermined height S in (a) and (c) of FIG. 40.

Referring to a table in FIG. 41, it may be known that the magnitude of the pen signal increases as the predetermined height S increases.

As described above, the stylus pen 100 according to an embodiment of the present invention in FIGS. 37 to 40C may reduce the thickness of the buffer member 115 because the tapered portion of the ferrite core 121 of the inductor unit 120 has a shape different from that of the typical ferrite core 131′. Thus, the ferrite core 121 may be disposed closer to an end of the stylus pen 102 in the housing 101. Thus, the receiver that receives the pen signal emitted from the stylus pen 100 according to an embodiment of the present invention may obtain a greater pen signal to improve sensing sensitivity of the stylus pen at a side of the receiver.

On the other hand, the receiver that is described above several times represents a module or device that receives the pen signal emitted from the stylus pen 100 according to an embodiment of the present invention. The receiver may be a general digitizer or a display panel. The display panel may have at least one loop pattern made of a conductive material. The loop pattern may be coupled to a touch sensor or coupled to the display panel separately from the touch sensor.

Hereinafter, specific internal structures of the stylus pen 100 according to an embodiment of the present invention, to which the ferrite core 121 and the buffer member 115 in FIGS. 37 to 40C are applied, will be described with reference to the drawings.

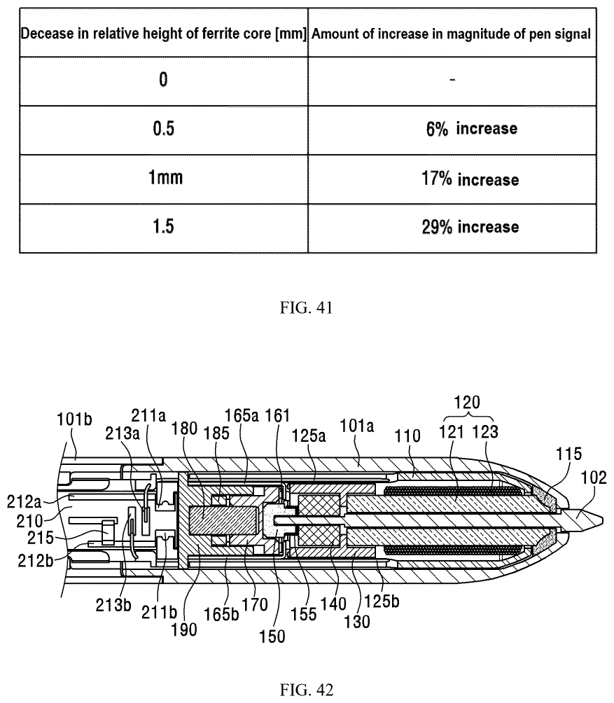

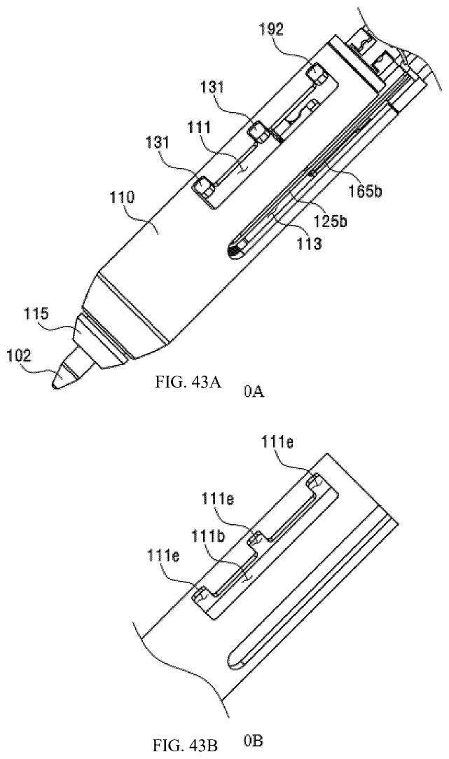

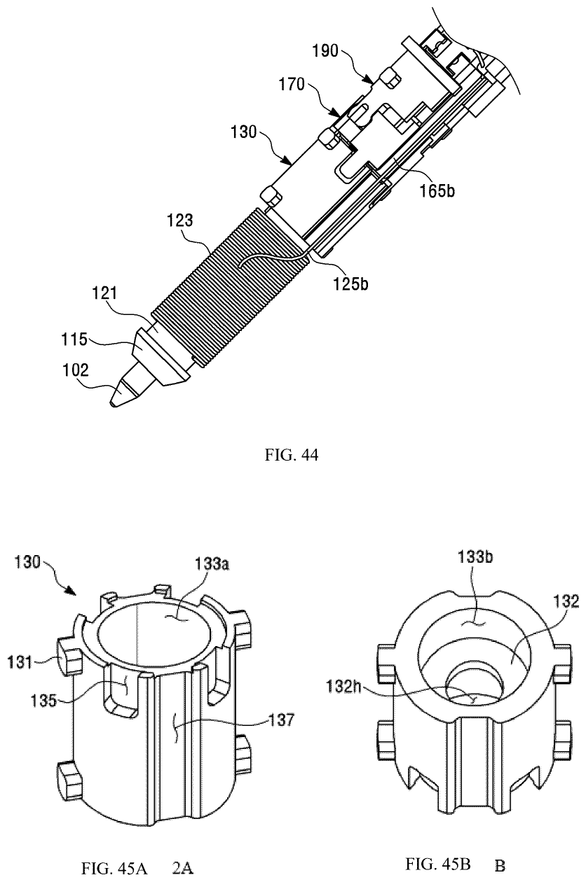

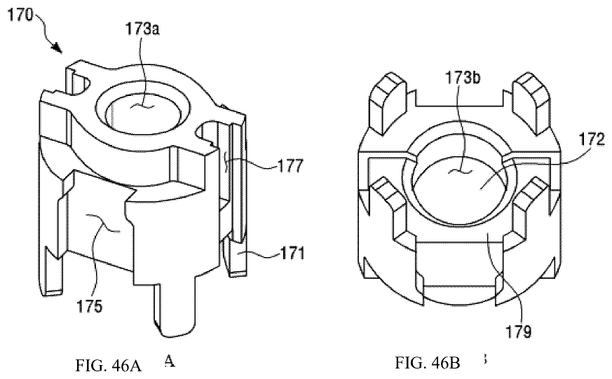

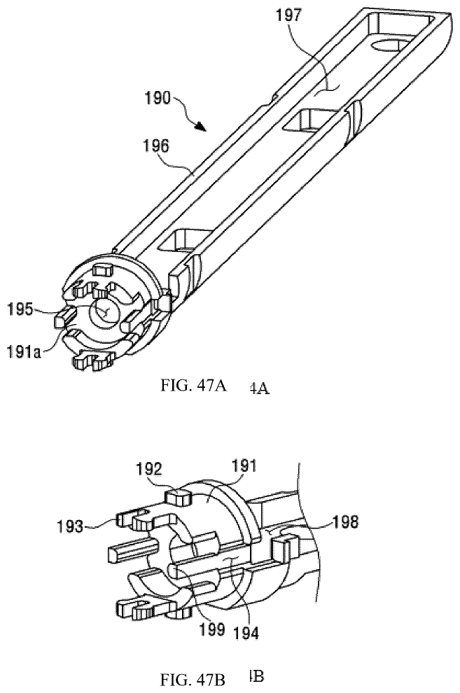

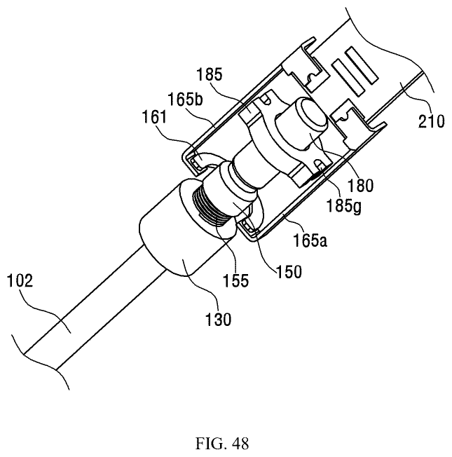

FIG. 42 is a cross-sectional view illustrating a portion of the stylus pen 100 according to an embodiment of the present invention in FIG. 36, FIG. 43A is a perspective view for explaining structures of an inner case 110 and the buffer member 115 in FIG. 42, FIG. 43B is a perspective view illustrating only the inner case 110. FIG. 44 is a perspective view illustrating a case in which the inner case 110 in FIG. 43A is removed, FIGS. 45A and 45B are perspective views illustrating a first fixing member 130 in FIGS. 42 and 44 from various angles, FIGS. 46A and 46B are perspective views illustrating a moving member 170 in FIGS. 42 and 44 from various angles, FIGS. 47A and 47B are perspective views illustrating a second fixing member 190 in FIGS. 42 and 44 from various angles, FIG. 48 is a perspective view illustrating some components in FIGS. 42 and 44 from one side, and FIGS. 49A and 49B are perspective views illustrating only some components in FIGS. 42 and 44.

Referring to FIG. 42, the stylus pen 100 includes at least two of an inner case 110, a buffer member 115, an inductor unit 120, a capacitor unit (not shown), a first fixing member 130, a magnetic body 140, a cover member 150, a ring terminal 161, connection terminals 165a and 165b, a moving member 170, a first elastic member 180, a second elastic member 185, an elastic body 155, a second fixing member 190, and a substrate 210.

The inner case 110 is made of a non-conductive material and is disposed in the housing 101. Specifically, the inner case 110 may be disposed in a first housing 101a of the housing 101. The inner case 110 may have a shape surrounding the inductor unit 120, the first fixing member 130, the ferrite chip 140, the cover member 150, the ring terminal 161, the connection terminals 165a and 165b, the moving member 170, the first elastic member 180, the second elastic member 185, the elastic body 155, and the second fixing member 190. The inner case 110 serves to protect various inner components from physical and/or electrical impacts.

Referring to FIG. 42 and FIGS. 43A and 43B, the inner case 110 may have a first opening 111 in which a first protrusion 131 of the first fixing member 130 and a first protrusion 192 of the second fixing member 190 are disposed. The first opening 111 may have a base groove 111b extending in a longitudinal direction of the stylus pen 100 and a plurality of extension grooves 111e connected to the base groove 111b and extending in a direction perpendicular to the longitudinal direction of the base groove 111b. The plurality of extension grooves 111e may be disposed at positions corresponding to a plurality of first protrusions 131 and 192. For example, the first opening 111 may have an “E”-shape.

The plurality of first protrusions 131 and 192 may be moved from the plurality of extension grooves 111e to the base groove 111b or from the base groove 111b to the plurality of extension grooves 111e by rotating the inner case 110 using the core body 102 as a rotation axis in a counterclockwise or clockwise direction. Specifically, positions of the first fixing member 130 and the second fixing member 190 may be fixed in the inner case 110 by moving the plurality of first protrusions 131 and 192 from the base groove 111b to the plurality of extension grooves 111e. On the other hand, the moving member 170 may

be moved in conjunction with a linear reciprocating movement of the core body 102 caused by external force between the first fixing member 130 and the second fixing member 190 because the moving member 170 is not directly coupled to the inner case 110.

The inner case (110) may have a second opening 113 in which extension coils 125a and 125b are disposed and from which the connection terminals 165a and 165b are exposed. The second opening 113 may provide a space in which the extension coils 125a and 125b are disposed and protect the extension coils 125a and 125b from external impacts. Also, a mounting position of the connection terminals 165a and 165b may be easily checked through the second opening 113.

The buffer member 115 may be disposed between the inductor unit 120 and the housing 101 and between the core body 102 and the inner case 110. The buffer member 115 has a through-hole through which the core body 102 passes. The buffer member 115 may guide a position of the core body 102, stably fix the inductor unit 120, and block the inductor unit 120 from external electrical or magnetic effects. Although the buffer member 115 may be provided separately from the inner case 110, the embodiment of the present invention is not limited thereto. For example, the buffer member 115 may be integrated with the inner case 110.

Referring to FIGS. 42 and 44, the buffer member 115, the inductor unit 120, the first fixing member 130, the moving member 170, and the second fixing member 190 may be arranged sequentially along a longitudinal direction (hereinafter, referred to as a “longitudinal direction”) of the stylus pen 100 from one end of the core body 102. That is, along the longitudinal direction, the inductor unit 120 may be disposed on the buffer member 115, the first fixing member 130 may be disposed on the inductor unit 120, the moving member 170 may be disposed on the first fixing member 130, and the second fixing member 190 may be disposed on the moving member 170.

The inductor unit 120 includes a ferrite core 121 and a coil 123 wound around the ferrite core 121. The ferrite core 121 has a through-hole through which the core body 102 passes. The core body 102 may perform a linear reciprocating movement along the longitudinal direction through the through-hole. The coil 123 may be wound around the ferrite core 121 with at least one layer. The extension coils 125a and 125b may be connected to both ends of the coil 123, respectively. The extension coils 125a and 125b may each extend along the longitudinal direction and be connected to coil electrodes 213a and 213b disposed on the substrate 210, respectively.

The inductor unit 120 is fixedly installed in the housing 101. The inductor unit 120 may be fixed between the first fixing member 130 and the buffer member 115 in the longitudinal direction. The inductor unit 120 may be fixed by the inner case 110 in a direction (hereinafter, referred to as a “vertical direction”) perpendicular to the longitudinal direction.

The inductor unit 120 may be fixed at one side of the first fixing member 130. Here, a portion of the inductor unit 120 may be disposed in a second cavity 133b of the first fixing member 130.

The inductor unit 120 may be electrically connected to a capacitor unit (not shown) mounted to the substrate 210 to constitute a resonance circuit unit. A resonance frequency may be set by a value of inductance L of the inductor unit 120 and a value of capacitance C of the capacitor unit (not shown). The resonance frequency may be varied because the value of inductance L of the inductor unit 120 is varied according to a movement of the magnetic body 140.

The capacitor unit (not shown) is disposed on the substrate 210. The capacitor unit (not shown) has a preset value of the capacitance C. The capacitor unit (not shown) may include two or more capacitors. The circuit may be constituted such that at least one of the two or more capacitors is always electrically connected to the inductor unit 120 as a basic capacitor.

The capacitor unit (not shown) includes a jumping capacitor 215. The circuit may be constituted such that the jumping capacitor 215 is mounted on the substrate 210 and electrically connected to the connection terminals 165a and 165b. For example, the jumping capacitor 215 may be electrically connected to connection pads 211a and 211b disposed on the substrate 210 through conductive patterns 212a and 212b. The jumping capacitor 215 may be electrically connected to or disconnected from the basic capacitor according to the movement of the core body 102. Since the ring terminal 161 is in contact with the contact terminals 165a and 165b when external force is not applied to the core body 102, the jumping capacitor 215 is connected to the basic capacitor. On the other hand, when the moving member 170 that operates together with the core is moved toward the first elastic member 180 as external force is applied to the core body 102, the ring terminal 161 is detached from the connection terminals 165a and 165b. Here, the jumping capacitor 215 may be electrically disconnected from the basic capacitor.

Referring to FIGS. 42 and 44 and FIGS. 45A and 45B, the first fixing member 130 is disposed in the inner case 110. The first fixing member 130 has an overall cylindrical shape. The first fixing member 130 has a first cavity 133a and a second cavity 133b. The magnetic body 140 in FIG. 42 is disposed in the first cavity 133a, and one end of the ferrite core 121 of the inductor unit 120 in FIG. 42 is disposed in the second cavity 133b. A partition wall 132 is disposed between the first cavity 133a and the second cavity 133b, and the partition wall 132 has a through-hole 132h through which the core body 102 passes.

The inductor unit 120 is disposed at one side of the first fixing member 130, and the second fixing member 190 is spaced at a predetermined distance from the other side of the first fixing member 130.

The plurality of first protrusions 131 that are described above may be disposed on an outer surface of the first fixing member 130.

A plurality of first grooves 135 in which a plurality of extension parts 171 are disposed, respectively, may be formed in the outer surface of the first fixing member 130. Also, a second groove 137 formed along the longitudinal direction to maintain a constant distance with the extension coils 125a and 125b illustrated in FIG. 44 may be formed in the outer surface of the first fixing member 130.

Referring to FIGS. 42 and 44 and FIGS. 46A and 46B, the moving member 170 is disposed between the first fixing member 130 and the second fixing member 190. The moving member 170 may perform a linear reciprocating movement between the first fixing member 130 and the second fixing member 190 in conjunction with a longitudinal movement of the core body 102.

The first fixing member 130 and the second fixing member 190 may also be referred to as fixed parts.

The moving member 170 is disposed in the inner case 110. The moving member 170 has an overall cylindrical shape. The moving member 170 includes a first cavity 173a and a second cavity 173b. A portion of the first elastic member 180 in FIG. 42 is disposed in the first cavity 173a, and a portion of the cover member 150 in FIG. 42 is disposed in the second cavity 173b. A partition wall 172 is disposed between the first cavity 173a and the second cavity 173b, and the partition wall 172 is disposed between the cover member 150 and the first elastic member 180. Here, the moving member 170 may also be referred to as a moving part.

The plurality of extension parts 171 disposed in the plurality of first grooves 135 are disposed on the outer surface of the moving member 170. The plurality of extension parts 171 may each have a shape extending along the longitudinal direction and be moved along the first grooves 135 of the first fixing member 130.

A plurality of second grooves 175 in which the second extension parts 193 of the second fixing member 190 in FIGS. 47A and 47B are disposed, respectively, may be formed on the outer surface of the moving member 170. As the moving member 170 performs the linear reciprocating movement along the longitudinal direction, the second grooves 175 are also moved accordingly. Thus, a position of the second extension parts 193 of the second fixing member 190 disposed in the second grooves 175 may be changed.

The second groove 175 of the moving member 170 may have a shape corresponding to the second extension part 193 of the second fixing member 190. The second groove 175 may have a shape that prevents the second extension part 193 of the second fixing member 190 from completely separated from the second groove 175 when the moving member 170 is moved away from the second fixing member 190. To this end, the second groove 175 may have a shape having a width that gradually decreases in a direction toward the second fixing member 190, and the second extension part 193 of the second fixing member 190 may have a shape that protrudes in a width direction of the second groove 175.

A first groove 177 may be formed in the outer surface of the moving member 170. The first groove 177 may be elongated in the longitudinal direction, and the connection terminals 165a and 165b may be disposed in the first groove 177 as illustrated in FIG. 49B. The first groove 177 may fix and guide a position of the connection terminals 165a and 165b. Also, the first extension part 192 of the second fixing member 190 may be disposed in the first groove 177 together with the connection terminals 165a and 165b.

Since the moving member 175 is disposed between the first fixing member 130 and the second fixing member 190, an extension part 171 of the moving member 170 is disposed in the first groove 135 of the first fixing member 130, and first and second extension parts 193 and 199 of the second fixing member 190 are disposed in the first and second grooves 175 and 177 of the moving member 170, the moving member 175 may not be separated to the outside even during frequent movements.

The moving member 170 may include one surface 179 in which the first cavity 173a is defined, and the ring terminal 161 in FIGS. 42 and 48 may be disposed on the one surface 179. The one surface 179 may have a shape corresponding to that of the ring terminal 161. The ring terminal 161 disposed on the one surface 179 may be guided by an inner surfaces of at least one extension part 171 disposed therearound.

Referring to FIGS. 42, 44, 47A and 47B, the second fixing member 190 is fixed in the housing 101. At least a portion of the second fixing member 190 is fixed in the inner case 110.

The second fixing member 190 includes a cylindrical base portion 191. One surface 191a of the base portion 191 has a cavity 195 in which a portion of the first elastic member 180 in FIG. 42 is disposed. The second elastic member 185 in FIG. 42 is disposed on the one surface 191a of the base portion 191.

The second fixing member 190 includes a first extension part 199 and a second extension part 193, each of which extends from the one surface of the base portion 191 towards the moving member 170. A plurality of first extension parts 199 and a plurality of second extension parts 193 may be disposed on the one surface 191a of the base portion 191. Specifically, two first extension parts 199 may be disposed to face each other, and two second extension parts 193 may be disposed to face each other. The plurality of first and second extension parts 191 and 199 guide an outer surface of the second elastic member 185 in FIG. 42 from all directions. Thus, a position of the second elastic member 185 may be fixed by the plurality of first and second extension parts 191 and 199.

The first extension part 199 may have an inner surface that guides an outer surface of the second elastic member 185 and an outer surface that supports a portion of the connection terminals 165a and 165b in FIGS. 42 and 44.

The second extension part 193 has a predetermined shape so as not to be separated from the second groove 175 after being coupled to the second groove 175 of the moving member 170. For example, the second extension part 193 may have a shape in which at least a portion protrudes to prevent separation from the second groove 175.

The second fixing member 190 may have a groove 194 defined in an outer surface of the base portion 191. A bottom surface of the groove 194 may be connected to the outer surface of the first extension part 199 without a stepped portion. A portion of the connection terminals 165a and 165b in FIGS. 42 and 44 may be disposed in the groove 194.

The second fixing member 190 may include a seat portion 196 that extends along the longitudinal direction from the other surface (not shown) of the base portion 191. The seat portion 196 may have a cavity 197 in which the substrate 210 in FIGS. 42 and 44 is disposed.

The second fixing member 190 may have an opening 198 for connecting the connection terminals 165a and 165b in FIGS. 42 and 44 to the substrate 210 disposed in the cavity 197. The other ends of the connection terminals 165a and 165b may be disposed in the opening 198 and connected to the connection pads 211a and 211b of the substrate 210.

Referring to FIGS. 42, 44, and 48 and FIGS. 49A and 49B, the core body 102 may extend a predetermined length in the longitudinal direction, and one end thereof may have a sharp shape. Here, the one end is exposed to the outside of the housing 101.

The core body 102 includes a stepped portion 102T disposed on one portion of the intermediate portion between one end and the other end. One end and the other end of the intermediate portion may have different thicknesses based on the stepped portion 102T. Based on the stepped portion 102T, the one end of the intermediate portion may have a first thickness D1 greater than a second thickness D2 of the other end of the intermediate portion. The above-described stepped portion 102T allows the magnetic body 140 to be move together when the core 140 is moved along the longitudinal direction by external force. That is, when the core body 102 is moved, the stepped portion 102T may push one surface of the magnetic body 140 to move the magnetic body 140 in the longitudinal direction. As the magnetic body 140 is moved along the longitudinal direction, a spaced distance between the inductor unit 120 and the magnetic body 140 is changed. The change in distance changes a value of the inductance L of the inductor unit 120, and the change in value of the inductance changes the resonance frequency of the stylus pen 100. The stylus pen sensing device that interacts with the stylus pen 100 may sense a variation

in the resonance frequency to detect a pen pressure (pressure) applied to the core body 102.

The magnetic body (140) is disposed in the first cavity 133a of the first fixing member 130 in FIGS. 45A and 45B and has a cylindrical shape. Also, the magnetic body 140 has a through-hole through which a portion of the core body 102 passes. The through-hole may have a diameter equal to or greater than the second thickness D2 and less than the first thickness D1.

The magnetic body 140 may be a ferrite chip.

The magnetic body 140 may perform a linear reciprocating movement along the longitudinal direction in conjunction with the core body 102. As the magnetic body 140 is moved in conjunction with the core body 102, the value of the inductance L of the inductor unit 120 may be varied.

A cover part 161 is disposed at the other end of the core body 102. The cover part 161 may have a shape covering the other end of the core body 102. For example, the cover part 161 may have a cylindrical shape having different thicknesses at upper and lower portions.

The elastic member 155 may be disposed between the cover part 161 and the magnetic body 140. The elastic member 155 may be a spring. The elastic member 155 may have one end that is inserted into a portion of the cover part 161 and the other end and the other end that is in contact with the magnetic body 140.

The elastic member 155 may compensate a deviation of the magnetic body 140. For example, when a length (or height) of the magnetic body 140 is less by 0.1 mm than a specification, the elastic member 155 allows the magnetic body 140 to be in close contact with the partition wall 132 of the first fixing member 130.

The ring terminal 161 is a hollow circle and electrically connects two connection terminals 165a and 165b. Here, the embodiment of the present invention is not limited to the shape of the ring terminal 161. For example, the ring terminal 161 may have a polygonal shape.

The ring terminal 161 is disposed on one surface of the moving member 170 and operates in conjunction with the moving member 170. That is, the ring terminal 161 is moved together with the linear reciprocating movement of the moving member 170 in the longitudinal direction.

Each of the connection terminals 165a and 165b includes one end that contacts or separates from the ring terminal 161 and the other end connected to the substrate 210. The one end may contact or separate from the ring terminal 161 by a movement of the ring terminal 161 that operates in conjunction with the moving member 170. The other end is directly connected to the connection pads 211a and 211b of the substrate 210 in FIG. 42 through soldering and the like.

The connection terminals 165a and 165b include a base portion disposed between the one end and the other end. This base portion may have a shape extending in the longitudinal direction. The base portion may be disposed in the first groove 177 of the moving member 170 in FIGS. 46A and 46B and in the groove 194 of the second fixing member 190 in FIGS. 47A and 47B. The base portion may be guided by the first extension part 199 of the second fixing member 190.

The first elastic member 180 is disposed in the second fixing member 190. The first elastic member 180 may have a cylindrical shape that is elongated in the longitudinal direction. The first elastic member 180 may be made of a rubber material.

The first elastic member 180 may have one end disposed in the cavity 195 of the second fixing member 190 in FIGS. 47A and 47B and the other end disposed in the first cavity 173a of the moving member 170 in FIGS. 46A and 46B.

The second elastic member 185 is disposed in the second fixing member 190. The second elastic member 185 may have a flat cylindrical shape. The second elastic member 185 may be made of a rubber material. The second elastic member 185 may be made of a rubber material that is harder relative to that of the first elastic member 180. Thus, the second elastic member 185 may be made of a hard rubber material, and the first elastic member 180 may be made of a soft rubber material.

On the other hand, the second elastic member 185 may be a spring. The second elastic member 185 may be a spring configured to respond to relatively heavier force than the first elastic member 180.

The second elastic member 185 has a thickness in the longitudinal direction, which is less than that of the first elastic member 180, and a diameter in the vertical direction, which is greater than that of the first elastic member 180.

The second elastic member 185 is disposed to surround an intermediate portion of the first elastic member 180. Thus, the second elastic member 185 has a through-hole through which the first elastic member 180 passes.

As illustrated in FIG. 49B, the second elastic member 185 may have a groove 185g that is inserted into a portion of the first extension part 199 of the second fixing member 190. Through this, the second elastic member 185 may be stably fixed to the second fixing member 190.

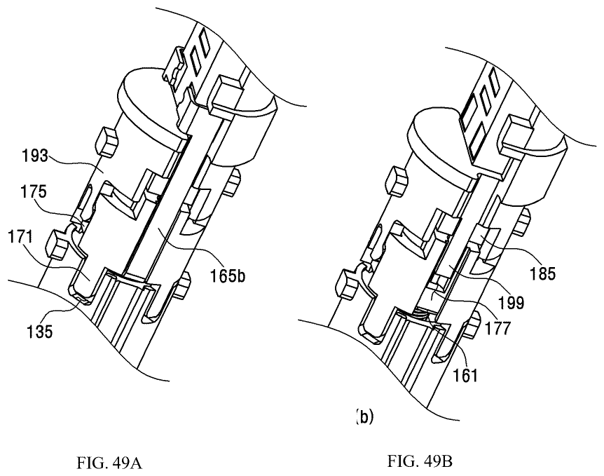

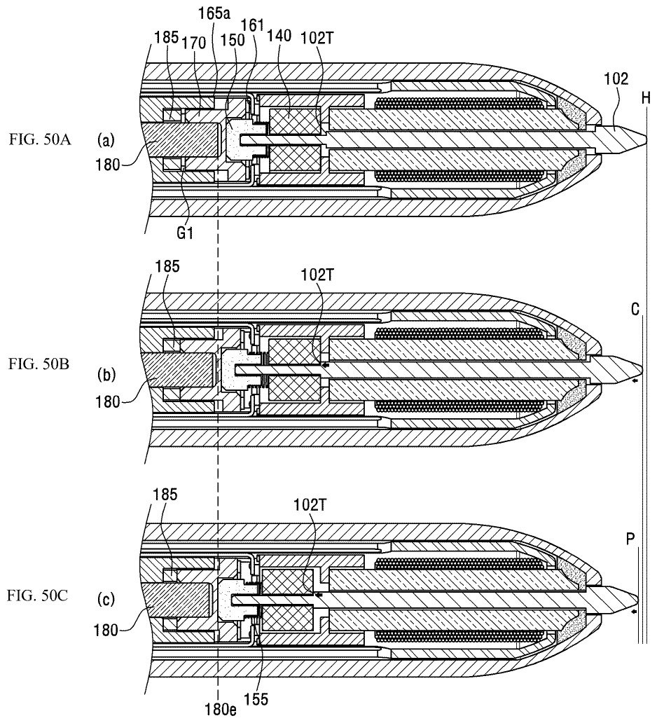

Hereinafter, an operation of the stylus pen 100 according to an embodiment in FIGS. 42 to 49B will be described with reference to FIGS. 50A to 50C.

FIGS. 50A to 50C are views for explaining the operation of the stylus pen 100 in FIGS. 42 to 49B. Specifically, FIG. 50A is a view illustrating a hover state H of the stylus pen 100, FIG. 50B is a view illustrating a contact state C of the stylus pen 100, and FIG. 50C is a view illustrating a pen pressure state P of the stylus pen 100.

Referring to FIG. 50A, since external force is not applied to the core body 102 in the hover state H, the inner components are not changed. In particular, the ring terminal 161 and the connection terminals 165a and 165b maintain a contact state therebetween.

Referring to FIG. 50B, in the contact state C, a predetermined pressure is applied to one end of the core body 102. The applied pressure causes the core body 102 to be moved in an inward direction of the housing 101. As the core body 102 is moved, the cover part 150 pushes the moving member 170 towards the first elastic member 180, and the ring terminal 161 is separate from the connection terminals 165a and 165b. Accordingly, the jumping capacitor 215 in FIG. 42 is electrically disconnected from the basic capacitor, and overall capacitance of the capacitor unit (not shown) decreases. Here, since the magnetic body 140 is not moved, the value of the inductance of the inductor unit 120 remains unchanged. Since the overall capacitance value of the capacitor unit (not shown) decreases, the resonance frequency is varied.

Referring to FIG. 50C, in the pen pressure state P, greater pressure is applied to one end of the core body 102 than that in the contact state C. The greater pressure causes the core body 102 to be moved further in an inward direction of the housing 101. Accordingly, the magnetic body 140 is pushed by the stepped portion 102T of the core body 102. As the magnetic body 140 is pushed, the elastic body 155 disposed between the cover part 150 and the magnetic body 140 is pressed, and as the moving member 170 is moved, the first elastic member 180 and the second elastic member 185 are pressed. Here, since the magnetic body 140 is moved away from the inductor unit 120, the value of the inductance L of the inductor unit 120 gradually decreases. Here, the capacitance of the capacitor unit (not shown) remains the same as that in the contact state C. Since the value of the inductance of the inductor unit 120 decreases, the resonance frequency is varied.

FIG. 51A is a view illustrating a variation in LC value of the resonance circuit unit according to the operations in FIGS. 50A to 50C. Here, a Th period represents the hover state of FIG. 50A, a Tc point represents the contact state of FIG. 50B, and a Tp period represents the pressure state of FIG. 50C. FIG. 51B is a graph showing frequency characteristics in each of the operating states of FIGS. 50A to 50C.

Referring to FIG. 51A, a LC value of the resonance circuit unit including the capacitor unit (not shown) and the inductor unit 120 maintains a constant value before Th the core body 102 of the stylus pen 100 contacts a touch surface Th and significantly decreases directly after Tc the core body 102 contacts the touch surface Tc. Also, in the period Tp in which pen pressure is applied to the stylus pen 100 after the stylus pen 100 contacts the touch surface, the LC value of the resonance circuit unit decreases further according to the pen pressure. That is, in this period Tp, as the pen pressure applied to the stylus pen 100 increases, the LC value of the resonance circuit unit may gradually decrease. Referring to FIG. 51A, the LC value of the resonance circuit unit shows hover state>contact state>pen pressure state. Also, immediately after the core body 102 contacts the touch surface, an amount of variation in LC value is more significant in a state in which the pen pressure gradually increases.

When the value of the inductance of the inductor unit 120 and the value of the capacitance of the capacitor unit (not shown) are varied, the resonance frequency and the Q value of the resonance circuit unit may be also varied. The resonance frequency of the resonance circuit unit increases as the inductance of the resonance circuit unit decreases, and the Q value decreases as the inductance decreases. Thus, as illustrated in FIG. 51B, frequency characteristics of a resonance signal Vpen output from the resonance circuit unit may show that, as a movement distance of the core body 102 increases, i.e., the pen pressure increases, the resonance frequency increases (hover state<contact state<pen pressure state), and the Q value decreases (hover state>contact state>pen pressure state).

When the resonance frequency of the resonance circuit unit is varied, a phase of the electromagnetic signal output from the stylus pen 100 is changed. The stylus pen sensing device that interacts with the stylus pen 100 may calculate the variation in the LC value of the resonance circuit unit, and based on this, whether the stylus pen 100 is in contact with the stylus pen sensing device and the pen pressure thereof may be detected.

As described above, the stylus pen 100 according to an embodiment in FIGS. 42 to 49B may change at least one or both of the inductance value and the capacitance value of the resonance circuit unit to detect the pen pressure in the stylus pen sensing device. Also, the stylus pen 100 may have an advantage of sensing precise pressure.

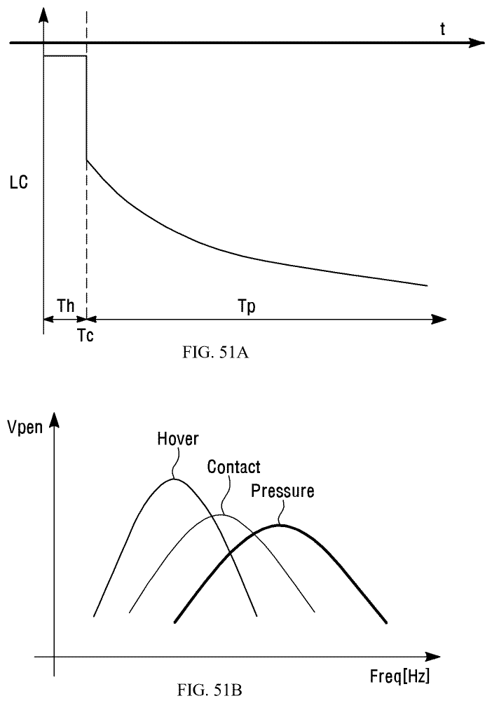

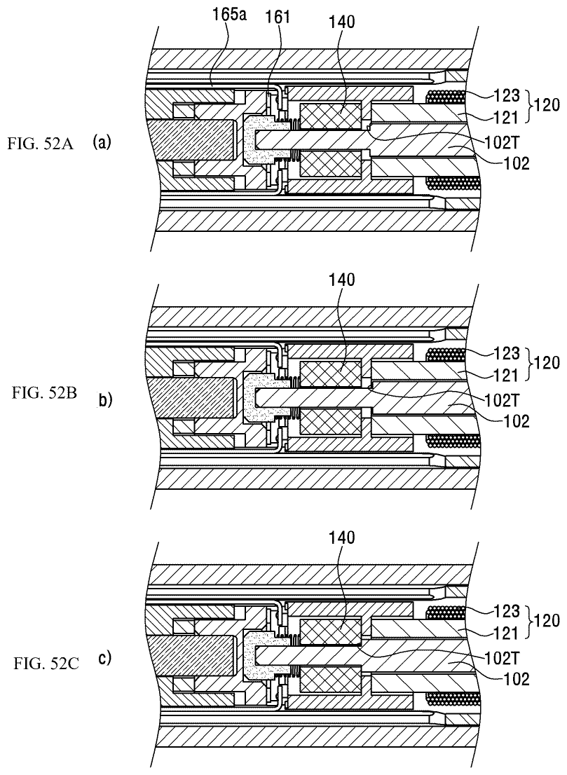

On the other hand, the stylus pen according to an embodiment in FIGS. 42 to 49B may have an assembly deviation during an assembly process. Since the assembly deviation may cause a predetermined limitation, the assembly deviation will be described in detail below with reference to FIGS. 52A to 54C.

FIGS. 52A to 52C are views for explaining a limitation caused by an assembly deviation of a core body 102 when the stylus pen 100 in FIGS. 42 to 50C is assembled;

Specifically, FIG. 52A shows a case in which the core body 102 is mounted as designed in advance without the assembly deviation, and FIGS. 52B and 52C show a case in which the core body 102 is not mounted in a designed position by an assembly deviation occurring during the assembly process.

In FIG. 52A, the stepped portion 102T of the core body 102 is disposed in the through-hole 132h formed in the partition wall 132 of the first fixing member 130. A position of the stepped portion 102T is assembled correctly without any deviation. On the other hand, in FIGS. 52B and 52C, the stepped portion 102T is disposed at a different position instead of the through-hole 132h of the partition wall 132. Specifically, the stepped portion 102T is disposed in the second cavity 133b (refer to FIG. 45B) of the first fixing member 130, in which the inductor unit 120 is disposed, in FIG. 52B, and the stepped portion 102T is disposed in the first cavity 133a (refer to FIG. 45A) of the first fixing member 130, in which the magnetic body 140 is disposed, in FIG. 52C.

When the assembly deviation occurs as in FIG. 52C, pressure is continuously applied to the core body 102 immediately after the contact state in FIG. 50B, the inductance value of the inductor unit 120 is not changed immediately because a distance between the inductor unit 120 and the magnetic body 140 is constant. On the other hand, in case of FIG. 52C, as the magnetic body 140 is moved by the core body 102 between the hover state of FIG. 50A and the contact state of FIG. 50B, the inductance value of the inductor unit 120 may be varied.

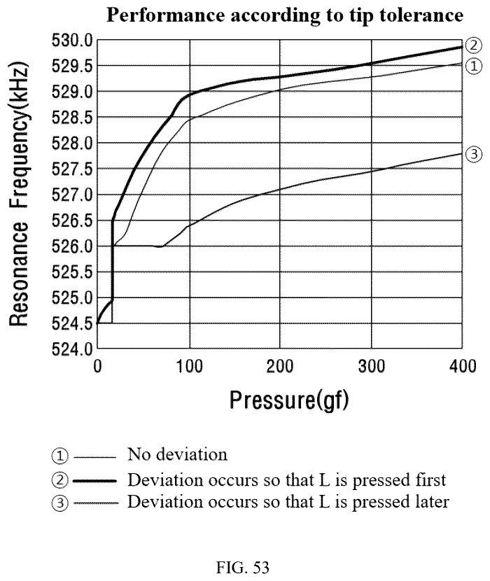

The variation in resonance frequency according to the pressure applied to the core body 102 in each of FIGS. 52A to 52C will be described with reference to FIG. 53.

In a graph of FIG. 53, line \textcircled{1} corresponds to FIG. 52A without an assembly deviation, line \textcircled{2} corresponds to FIG. 52C with the assembly deviation, and line \textcircled{3} corresponds to FIG. 52B with the assembly deviation.

Referring to FIG. 53, in case of line \textcircled{3}, the resonance frequency is not varied although the pressure applied to the core body 102 increases immediately after the contact state. Thus, the stylus pen sensing device that interacts with the stylus pen 100 may not detect the pen pressure applied to the core body 102. In case of line \textcircled{2}, since the resonance frequency is varied even in the hover state, the stylus pen sensing device may recognize the core body 102 as being in the contact state instead of the hover state. As described above, due to the assembly deviation in FIGS. 52B and 52C, the stylus pen sensing device may not accurately detect the stylus pen 100.

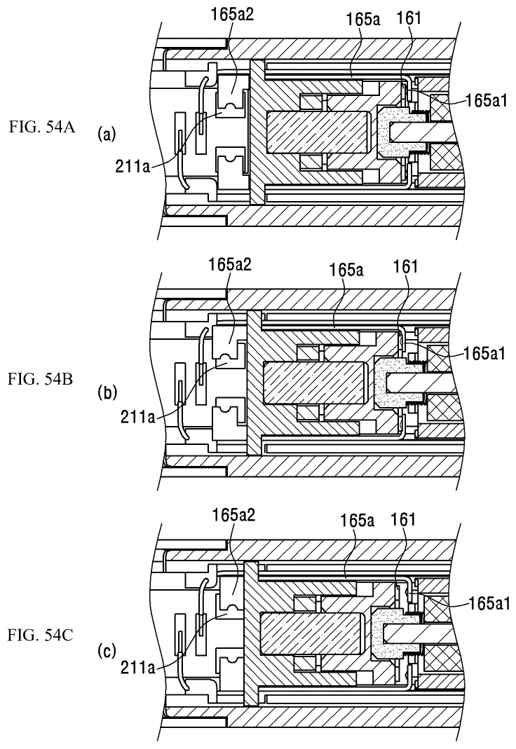

FIGS. 54A to 54C are views for explaining a limitation caused by an assembly deviation of the connection terminals 165a and 165b occurring when the stylus pen 100 in FIGS. 42 to 50C is assembled.

Specifically, FIG. 54A shows a case in which the connection terminals 165a and 165b are mounted as designed without any assembly deviation, and FIGS. 54B and 54C show cases in which the connection terminals 165a and 165b are not mounted at designed positions due to the assembly deviation.

In FIG. 54A, one end 165al of the connection terminal 165a is in contact with the ring terminal 161, and the other end 165a2 is in contact with the connection pad 211a of the substrate 210. A position of the connection terminal 165a is assembled correctly without any deviation. On the other hand, in FIGS. 54B and 54C, the connection terminal 165a is disposed at a different position instead of a designed position due to the assembly deviation. Specifically, in FIG. 54B, as the connection terminal 165a is offset by a predetermined distance towards the substrate 210, the one end 165al presses the ring terminal 161 with considerable force. In FIG. 54C, as the connection terminal 165a is offset by a predetermined distance towards the first fixing member 130, the one end 165al is spaced a predetermined distance from the ring terminal 161.

When the assembly deviation occurs as in FIG. 54B, since the connection terminal 165a and the ring terminal 161 are assembled in a state of being pressed by each other, there is a limitation in that pressure increases to recognize the contact state in FIG. 50B. On the other hand, in case of FIG. 54C, the ring terminal 161 and the connection terminal 165a are separated from the hover state of FIG. 50A, the stylus pen sensing device may not sense the contact state of FIG. 50B although pressure is applied to the core body 102.

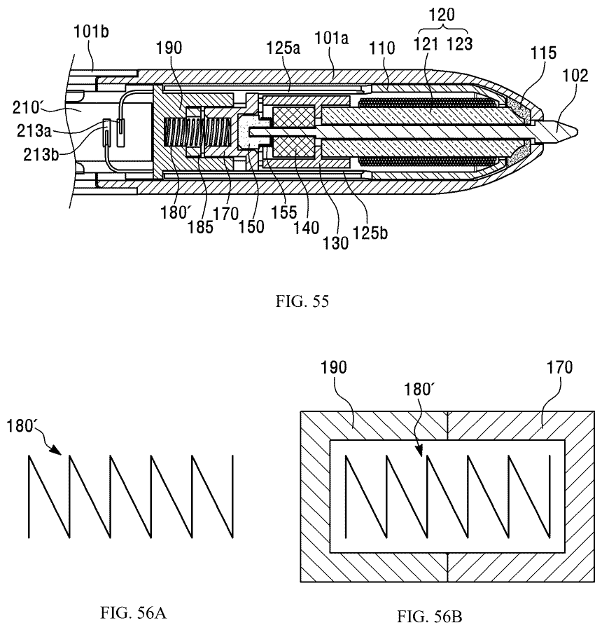

Hereinafter, a stylus pen according to another embodiment, which is not significantly affected in performance although the assembly deviation described with reference to FIGS. 52A to 54C occurs and reduced in manufacturing cost by reducing the number of inner components, will be described with reference to FIGS. 55 to 59.

When compared with the stylus pen 100 in FIGS. 42 to 50, the stylus pen in FIG. 55 is different in that: 1) a first elastic member 180′ is made of a spring instead of a rubber material, and 2) the ring terminal 161, the connection terminals 165a and 165b, the jumping capacitor 215, and components for electrical connection therebetween of the stylus pen 100 in FIGS. 42 to 50 are omitted. Since the rest components except for the above-described components are the same as those of the stylus pen 100 in FIGS. 42 to 50, a detailed description thereof will be replaced with the above description, and only different components will be described in detail below.

Referring to FIG. 55, the first elastic member 180′ includes a spring. The first elastic member 180′ may be pressed even under low pressure (e.g., about 10 gf) and disposed to be pressed quickly even when pressure slightly increases due to a low compression strength thereof.

FIGS. 56A and 56B are views for explaining the first elastic member 180′ in FIG. 55. FIG. 56A is a view illustrating a state in which no force is applied to the first elastic member 180′, and FIG. 56B is a view illustrating a state in which the first elastic member 180′ is disposed between the moving member 170 and the second fixing member 190 in FIG. 55.

As illustrated in FIG. 56B, the first elastic member 180′ is inserted between the moving member 170 and the second fixing member 190 in a partially pressed (or incompletely pressed) state. The first elastic member 180′ is not pressed unless force (or repulsive force) greater than the pressed force applied by the moving member 170 and the second fixing member 190. Here, the force (or repulsive force) may be, e.g., about 10 gf. On the other hand, the second elastic member 190 is pressed when force greater than the applied pressed force is applied through the moving member 170.

Below is <Mathematical equation 1> that represents force F (or repulsive force) of the partially pressed first elastic member 180′.

$$F = - kx = - \frac{\text{?}}{8 {NaD}^{3}} x \qquad [ Mathematical equation 1 ]$$

$$\text{?} \text{indicates text missing or illegible when filed}$$

where, G is a transverse elastic modulus of the spring, Na is an effective number of winding of the spring, D is a diameter of the spring, d is a diameter of a wire, and x is a pressed (− direction) length of the spring.

On the other hand, the first elastic member 180′ in a non-pressed state may be disposed between the moving member 170 and the second fixing member 190. Thus, the stylus pen according to another embodiment of the present invention is not limited to the state in which a portion of the first elastic member 180′ in a pressed state is disposed between the moving member 170 and the second fixed member 190.

The first elastic member 180′ may be configured to respond to a relatively greater weight than the elastic body 155.

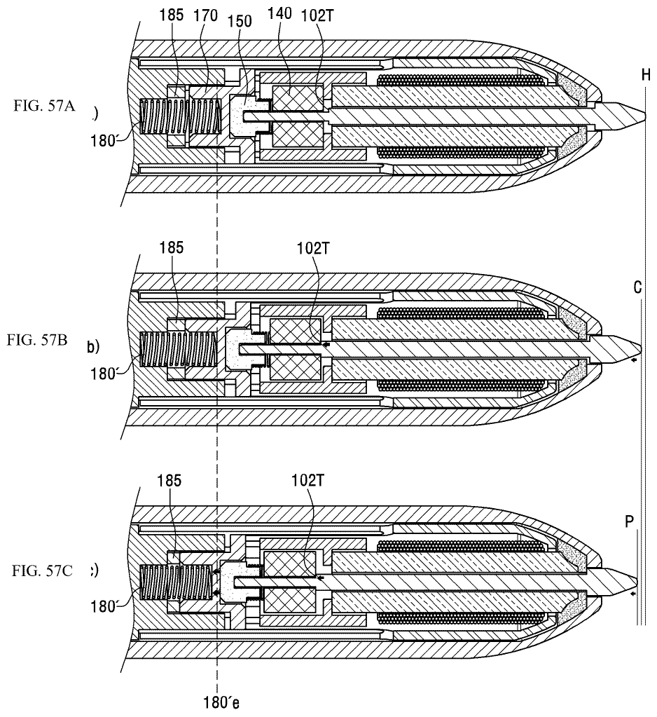

Hereinafter, an operation of the stylus pen according to another embodiment in FIGS. 55 to 56B will be described with reference to FIGS. 57A to 57C.

FIGS. 57A to 57C are view for explaining the operation of the stylus pen in FIGS. 55 and 56. Specifically, FIG. 57A is a view illustrating the hover state H of the stylus pen, FIG. 57B is a view illustrating the contact state C of the stylus pen, and FIG. 57C is a view illustrating the pen pressure state P of the stylus pen.

Referring to FIG. 57A, since external force is not applied to the core body 102 in the hover state H, the inner components are not changed.

Referring to FIG. 57B, in the contact state C, a predetermined pressure is applied to one end of the core body 102. The applied pressure causes the core body 102 to be moved in an inward direction of the housing 101. As the core body 102 is moved, the cover part 150 pushes the moving member 170 toward the first elastic member 180′ upto the second elastic member 185. In this situation, the first elastic member 180′ is pressed as much as the moving member 170 is pushed. Also, as the core body 102 is moved, the stepped portion 102T of the core body 102 pushes the magnetic body 140 towards the first elastic member 180′. As the magnetic body 140 is pushed, a distance between the inductor unit 120 and the magnetic body 140 is changed, and this changed distance changes the inductance value of the inductor unit 120 and resultantly changes the resonance frequency.

Referring to FIG. 57C, in the pen pressure state P, greater pressure is applied to one end of the core body 102 than that in the contact state C. The greater pressure causes the core body 102 to be moved further in the inward direction of the housing 101, and resultantly the magnetic body 140 is moved further away from the inductor unit 120. As the magnetic body 140 is moved, the elastic body 155 disposed between the cover part 150 and the magnetic body 140 is pressed, and the movement of the moving member 170 causes the first elastic member 180′ to be further pressed and the second elastic member 185 to be also pressed. Here, since the magnetic body 140 is moved further away from the inductor unit 120, the inductance L value of the inductor unit 120 gradually decreases. Since the inductance value of the inductor unit 120 decreases, the resonance frequency is varied.

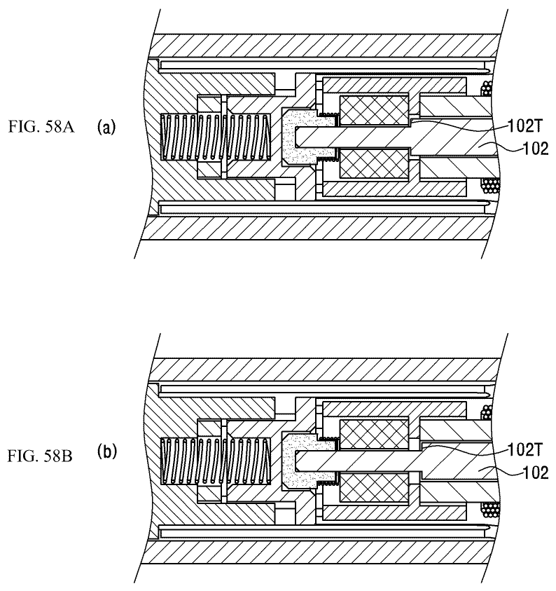

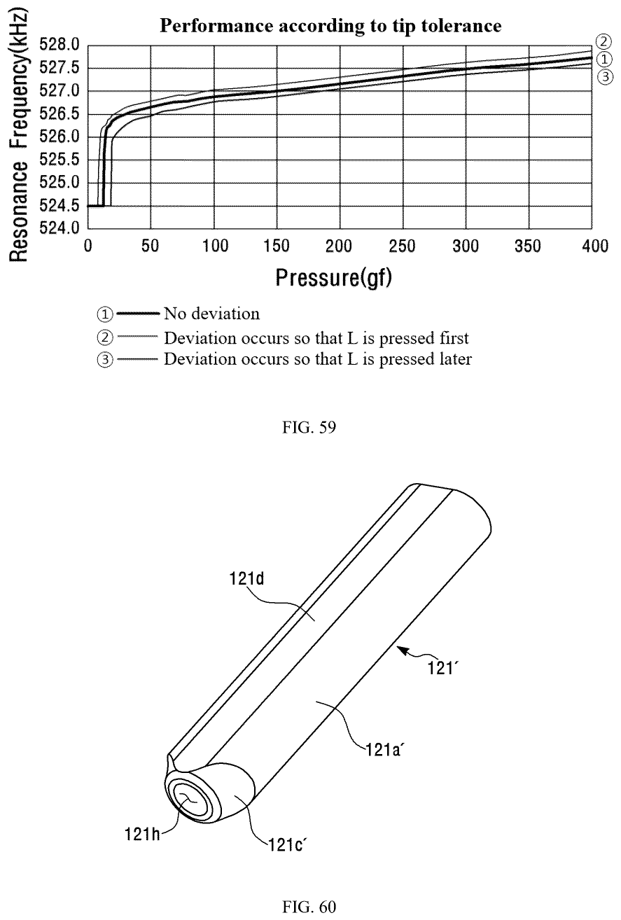

FIGS. 58A and 58B are views illustrating an example of the assembly deviation occurring in the core body 102, and FIG. 59 is a graph showing a variation of the resonance frequency according to the pressure applied to the core body 102 in each of FIGS. 58A and 58B.

FIG. 58A is a view illustrating a state in which the stepped portion 102T of the core body 102 is offset toward the magnetic body 140 due to the assembly deviation occurring during the assembly process, and FIG. 58B is a view illustrating a state in which the stepped portion 102T of the core body 102 is offset towards the inductor unit 120 due to the assembly deviation.

In a graph of FIG. 59, line \textcircled{1} corresponds to FIG. 55 that is a case without the assembly deviation, line \textcircled{2} corresponds to FIG. 58A; and line \textcircled{3} corresponds to FIG. 58B.

Referring to FIG. 59, the stylus pen including the first elastic member 180′ according to another embodiment of the present invention exhibits a minimal performance change in comparison with the case without the assembly deviation although the assembly deviation slightly occurs in the core body 102. Thus, the stylus pen has an advantageous aspect in mass production in comparison with the stylus pen 100 in FIG. 42.

Also, since the stylus pen in FIGS. 55 to 57C does not use components such as the jumping capacitor 215, the ring terminal 161, and the connection terminals 165a and 165b in the stylus pen 100 illustrated in FIGS. 42 to 49B, the stylus pen may have a simplified structure and a reduced manufacturing cost. Furthermore, components for arranging the connection terminals 165a and 165b, such as the groove 194 of the second fixing member 190 in FIGS. 47A and 47B and a portion of the first groove 177 of the moving member 170 in FIGS. 46A and 46B, are not required.

Although not shown in the drawing, the stylus pen according to another embodiment of the present invention may be configured such that the first elastic member 180 in the stylus pen 100 in FIG. 42 is replaced with the first elastic member 180′ in FIGS. 55, 56A and 56B.

On the other hand, although not illustrated separately, the ferrite core 121 and the buffer member 115 in FIG. 37 may be directly applied to not only the stylus pen in FIGS. 42 to 59 but also typical stylus pens.

FIG. 60 is a perspective view according to a modified example of the ferrite core 121 in FIGS. 37 and 38, FIG. 61 is an enlarged front view illustrating a portion of a ferrite core 121′ in FIG. 60, and a cross-sectional view taken along line A-A′.

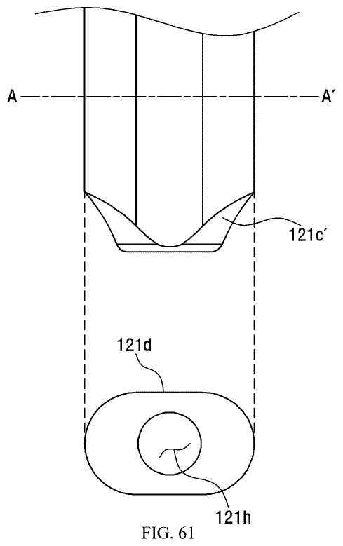

Referring to FIGS. 60, 61A and 61, the ferrite core 121′ has a cylindrical shape. A flat portion 121d may be disposed on at least a portion of an outer surface of the ferrite core 121′. Another flat portion corresponding to the flat portion 121d may be also disposed on another portion of the outer surface of the ferrite core 121′. The ferrite core 121′ may be stably disposed in the housing by the flat portion 121d.

The ferrite core 121′ has a cylindrical upper end 121a′ and a cylindrical lower end 121b′, and the lower end 121b′ has at least two curved portions 121c′. The curved portions 121c′ may each extend from the outer surface of the lower end 121b′ to a portion adjacent to the through-hole 121h of the ferrite core 121′. The curved portions 121c′ may be disposed at both sides, which face each other, of the lower end 121b′ based on the through-hole 121h, respectively.

While the curved portion 121c of the ferrite core 121 in FIGS. 37 to 38 may be disposed over the entire outer surface of the lower end 121b′, the curved portion 121c′ of the ferrite core 121′ in FIGS. 60 to 61 may be disposed on a portion of the outer surface of the lower end 121b′.

The flat portions 121d may be disposed on the upper end 121a′ and the lower end 121b′, respectively, and connected and continuously arranged. Here, the flat portion 121d disposed on the lower end 121b′ may be disposed between two curved portions 121c′ that are disposed to face each other on the outer surface of the lower end 121b′.

The ferrite core 121′ in FIGS. 60 to 61 may be applied as a replacement to the stylus pen in FIGS. 42 to 59. In this case, a buffer member (not shown) may have a shape covering a portion of the lower end 121b′ of the ferrite core 121′.

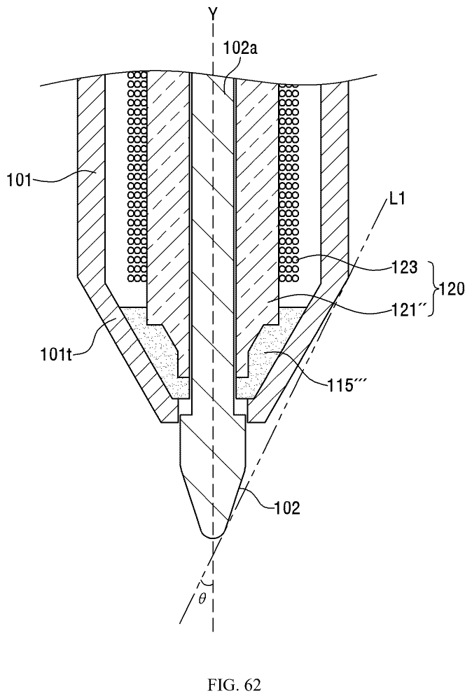

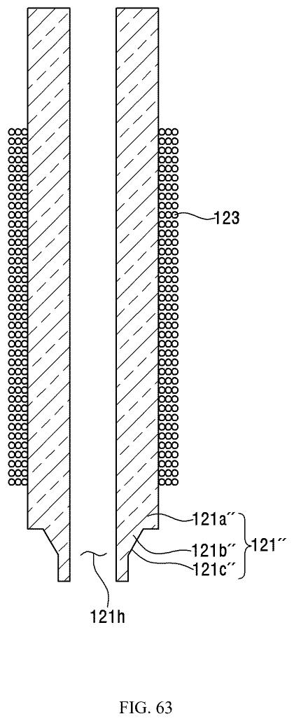

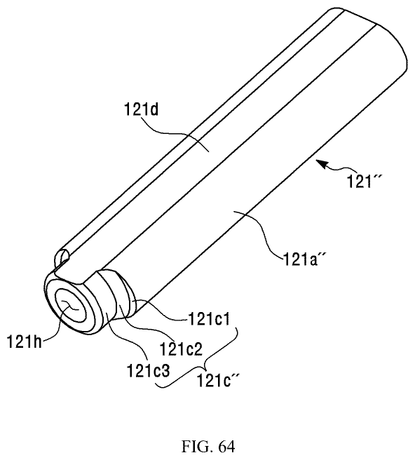

FIG. 62 is a cross-sectional view illustrating a stylus pen to which another modified example of the ferrite core 121 in FIG. 37 is applied, FIG. 63 is a cross-sectional view illustrating only a ferrite core 121″ and a coil 123 in FIG. 62, FIG. 64 is a perspective view illustrating the ferrite core 121″ in FIGS. 62 to 63, FIG. 65 is an enlarged front view illustrating a portion of the ferrite core 121″ in FIG. 64, and a cross-sectional view taken along the line B-B′.

Referring to FIGS. 62 to 64, the ferrite core 121″ in another modified example includes an upper end 121a″ and a lower end 121b″.

The lower end 121b″ has a tapered shape, and an outer surface of the lower end 121b″ includes at least one stepped portion 121c″.

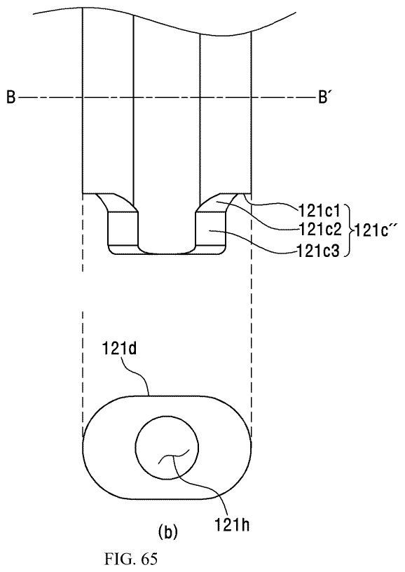

The stepped portion 121c″ may be disposed over the entire outer surface of the lower end 121b″ or disposed on a portion (portions) of the outer surface as in FIGS. 64 to 65.

The stepped portion 121c″ may include a first surface 121c1, a second surface 121c2 connected to the first surface 121c1, and a third surface 121c3 connected to the second surface 121c2. The first surface 121c1 may be perpendicular to a direction in which a through-hole 121h passes, and the third surface 121c3 may be parallel to the direction in which the through-hole 121h passes. The second surface 121c2 may connect the first surface 121c1 and the third surface 121c3. Here, although not shown in the drawing, the second surface 121c2 may be a curved surface that is curved inward or outward.

The ferrite core 121″ has a cylindrical shape. A flat portion 121d may be disposed on at least a portion of the outer surface of the ferrite core 121″. A flat portion corresponding to the flat portion 121d may be disposed on another portion of the outer surface of the ferrite core 121″. The flat portion 121d may allow the ferrite core 121″ to be stably disposed in the housing.

The flat portions 121d may be disposed on the upper end 121a″ and the lower end 121b″, respectively, and connected and continuously arranged. Here, the flat portion 121d disposed on the lower end 121b″ may be disposed between two stepped portions 121c″ that are disposed to face each other on the outer surface of the lower end 121b″.

Since the ferrite core 121″ in FIGS. 62 to 65 includes the stepped portions 121c″, the ferrite core 121″ may have the same or similar effect as the ferrite core 121 in FIGS. 37 to 38.

The ferrite core 121″ in FIGS. 62 to 65 may be applied as a replacement to the stylus pen in FIGS. 42 to 59. In this case, the buffer member (not shown) may have a shape covering a portion of the lower end 121b″ of the ferrite core 121″.

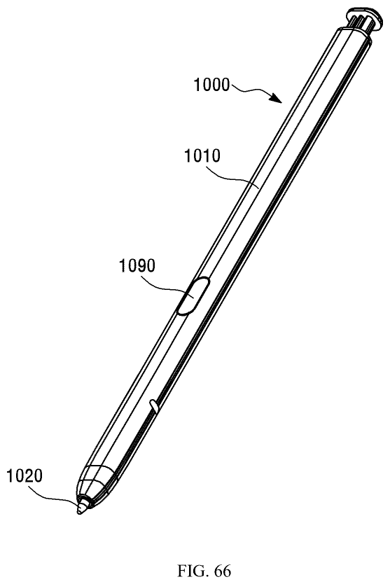

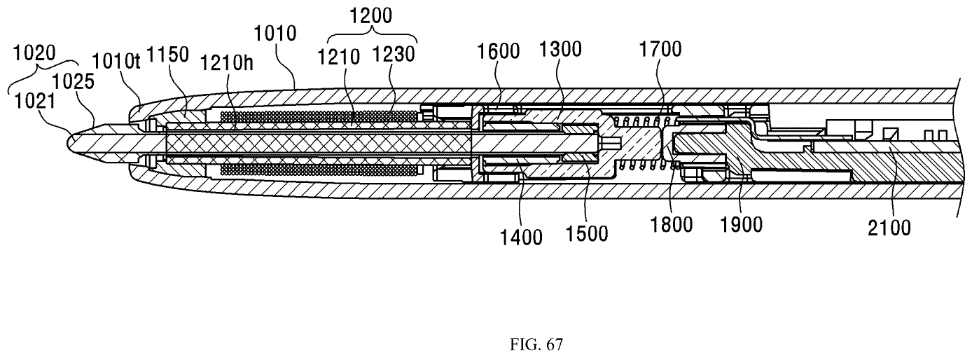

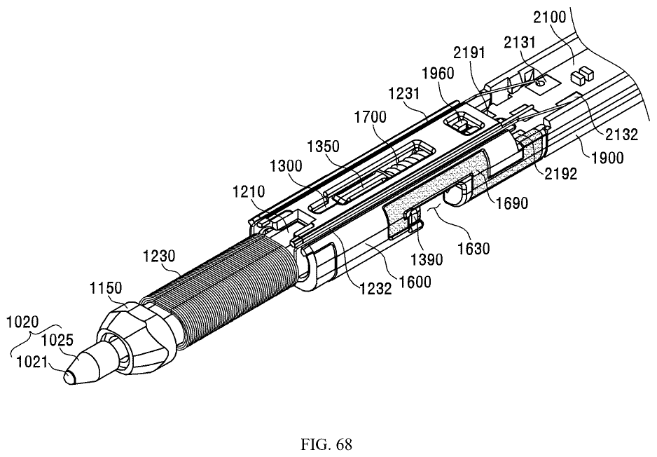

FIG. 66 is a perspective view illustrating a stylus pen 1000 according to another embodiment of the present invention, FIG. 67 is a cross-sectional view illustrating a portion of the stylus pen 1000 in FIG. 66, and FIG. 68 is a perspective view illustrating the stylus pen 1000 in FIG. 66, from which a housing 1010 is removed.

Referring to FIGS. 66 to 68, the housing 1010 forms an appearance of the stylus pen 1000. The housing 1010 includes an inner predetermined space and has an elongated shape in one direction. The housing 1010 may be formed such that two or more parts are coupled to each other or integrated into one piece.

The housing 1010 may be made of a non-conductive synthetic resin material.

A button unit 1090 may be disposed on the housing 1010. The button unit 1090 is designed to perform a specific operation of the stylus pen 1000. For example, the button unit 1090 may be a button for performing a cancel operation or a special function.

A core body 1020 includes one end that is disposed outside the housing 1010, and the rest portion except the one end is disposed in the housing 1010. Here, the one end of the core body 1020 may be referred to as a pen tip.

The core body 1020 may be made of a non-conductive resin material.

The core body 1020 may include a base portion 1021 and an outer portion 1025. The base portion 1021 has an elongated shape extending along a longitudinal direction of the stylus pen 1000. The outer portion 1025 surrounds a side surface of the base portion 1021. One end of the base portion 1021 is exposed to the outside instead of being covered by the outer portion 1025. The outer portion 1025 is made of a relatively harder material than that of the base portion 1021 to reinforce and protect the base portion 1021.

One portion of the one end of the core body 1020 may be moved into the housing 1010 by external force applied from the outside. As the external force increases, a volume of the one portion of the one end of the core body 1020, which is moved into the housing 1010, may increase. When the applied external force decreases, the one portion of the one end of the core body 1020 is moved out of the housing 101 again. When the external force is not applied, the one portion of the one end of the core body 1020 is returned to an original state.

A buffer member 1150 is disposed in the housing 1010 and disposed between one end of a ferrite core 1210 and an inner surface of the housing 1010. The buffer member 1150 may be disposed in a tapered portion 1010t of the housing 1010. Here, the tapered portion 101t of the housing 1010, which is adjacent to the one end of the core body 1020 among both ends of the housing 1010, has a shape having a width or diameter that gradually decreases in a direction toward an end of the one end of the housing 1010.

The buffer member 1150 has a conical or polygonal pyramid shape and includes a through-hole through which one end of the ferrite core 1210 and a body between one end and the other end of the core body 1020 pass. An inner surface of the through-hole may have a shape corresponding to an outer surface of the one end of the ferrite core 1210 and an outer surface of the body of the core body 1020. Here, the body of the core body 1020 refers to a portion, which is disposed in the through-hole of the ferrite core 1210, in the core body 1020 having an elongated shape in one direction.

The buffer member 1150 may be made of an elastic material such as rubber to serve as a buffer between the ferrite core 1210 and the housing 1010. This buffer member 1150 may block an electrical or magnetic effect from the outside.

The buffer member 1150 has a shape that surrounds one end of the ferrite core 1210.

A virtual tangent line L1 that contacts, in common, the tapered portion 1010t of the housing 1010 and the portion (or pen tip) disposed outside the housing in the core body 102 forms a predetermined angle as illustrated in FIG. 37. Here, the predetermined angle may be less than 30°. When the predetermined angle is less than 30°, a drawing may be performed in a state in which the stylus pen according to another embodiment of the present invention is inclined at 60° based on a contact surface.

The inductor unit 1200 may constitute an LC resonance unit with a capacitor unit (not shown). A resonance frequency may be set by a value of inductance L of the inductor unit 1200 and a value of capacitance C of the capacitor unit (not shown). The resonance frequency may be varied according to variation in the value of the inductance L of the inductor unit 1200 and/or the value of the capacitance C of the capacitor unit (not shown).

The inductor unit 1200 includes a ferrite core 1210 and a coil 1230 wound around an outer surface of the ferrite core 1210.

The ferrite core 1210 may have an overall cylindrical, elliptical, or polygonal container shape, and a through-hole 1210h that passes through the inside of the ferrite core 1210 may be formed along a longitudinal direction of the ferrite core 121.

The ferrite core 1210 has the through-hole 1210h through which the body of the core body 1020 passes. The body of the core body 1020 may perform a linear reciprocating movement along the longitudinal direction through the through-hole 1210h.

One end of the ferrite core 1210 may have a tapered shape having a diameter or width that gradually decreases in a direction toward an end thereof. Here, as illustrated in FIG. 38, an outer surface of the one end having the tapered shape may include at least one curved portion 121c that is curved inward.

As illustrated in FIG. 38, the ferrite core 1210 may include an upper end 121a and a lower end 121b disposed below the upper end 121a. Here, the upper end 121a and the lower end 121b may be integrated with each other.

The coil 1230 may be wound around the ferrite core 1210 with at least one layer.

The coil 1230 is electrically connected to a substrate 2100. The coil 1230 may include a first connection part 1231 and a second connection part 1232, which are for being connected to the substrate 2100. The first connection part 1231 is disposed on a fixing bracket 1600 and has one end that is electrically connected to a first terminal 2131 of the substrate 2100. The second connection part 1232 is disposed on the fixing bracket 1600 and has one end that is electrically connected to a second terminal 2132 of the substrate 2100. Here, the fixing bracket 1600 may have a groove in which each of the first connection part 1231 and the second connection part 1232 is disposed. The groove may be formed along the longitudinal direction of the stylus pen 1000 on an outer surface of the fixing bracket 1600. The groove may guide the first connection part 1231 and the second connection part 1232 of the coil 1230 and protect the first connection part 1231 and the second connection part 1232 from external impacts.

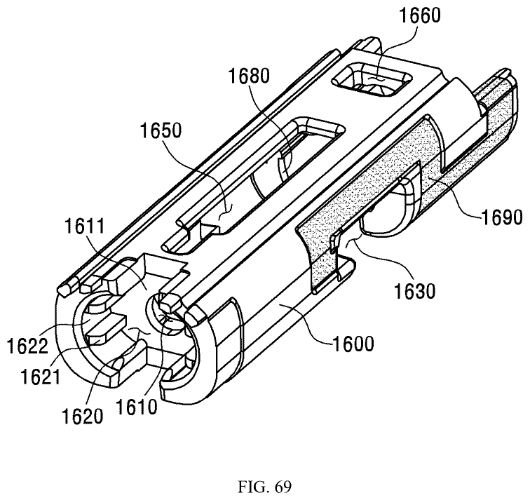

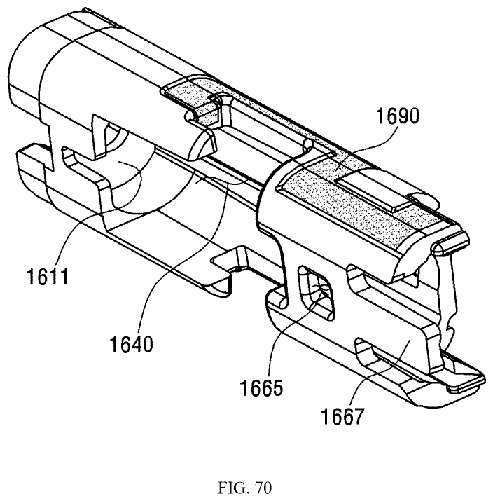

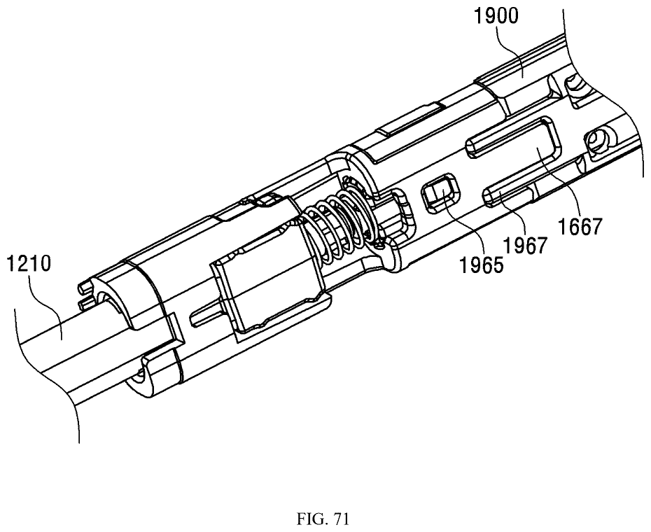

FIG. 69 is a perspective view illustrating only the fixing bracket 1600 in FIG. 58, FIG. 70 is a perspective view illustrating the fixing bracket 1600 in FIG. 69 viewed from another direction, and FIG. 71 is a perspective view illustrating a portion of FIG. 68 viewed from another direction.

Referring to FIGS. 68 to 71, the fixing bracket 1600 is fixed in the housing 1010. The fixing bracket 1600 may be disposed between the inductor unit 1200 and a substrate bracket 1900 in the housing 1010. The fixing bracket 1600 may have one end coupled to the inductor unit 1200 and the other end coupled to the substrate bracket 1900.

The one end of the fixing bracket 1600 may include an insertion groove 1620 into which the other end of the ferrite core 1210 of the inductor unit 1200 is inserted. The insertion groove 1620 may be defined by a first partition wall 1611 and an inner wall 1622 of the fixing bracket 1600.

The first partition wall 1611 may contact the other end of the ferrite core 1210, and the first partition wall 1611 has a through-hole 1610 through which the core body 1020 passes.

The inner wall 1622 may include a plurality of protrusions 1621 that protrude into the insertion groove 1620. The plurality of protrusions 1621 may contact an outer surface of the other end of the ferrite core 1210 to hold a position thereof.

The other end of the fixing bracket 1600 may include latch holes 1660 and 1665 into which latch parts 1960 and 1965 of the substrate bracket 1900 are inserted. At least one latch hole 1660 and 1665 may be provided. Alternatively, as illustrated in the drawing, one latch hole may be disposed above the fixing bracket 1600, and one latch hole may be disposed below the fixing bracket 1600. As the latch part 1960 of the substrate bracket 1900 is coupled to the latch hole 1660, the fixing bracket 1600 may be coupled to the substrate bracket 1900.

The other end of the fixing bracket 1600 may include a guide protrusion 1667. The guide protrusion 1667 may extend along a longitudinal direction of the fixing bracket 1600. The guide protrusion 1667 may be coupled with a guide part 1967 of the substrate bracket 1900. As the guide protrusion 1667 is coupled to the guide part 1967 of the substrate bracket 1900, the fixing bracket 1600 may be disposed along the longitudinal direction of the stylus pen 1000.

The other end of the fixing bracket 1600 may include a second partition wall 1680. The second partition wall 1680 fixes a position of an elastic member 1800 together with the substrate bracket 1900. That is, the elastic member 1800 may be fixedly mounted between the second partition wall 1680 and the substrate bracket 1900.

The fixing bracket 1600 is disposed to surround a moving bracket 1300, an elastic body 1700, and the elastic member 1800. The fixing bracket 1600 may have an inner accommodation space 1640 in which the moving bracket 1300, the elastic body 1700, and the elastic member 1800 are accommodated. The moving bracket 1300 may perform a linear reciprocating movement in the accommodation space 1640 of the fixing bracket 1600,

The fixing bracket 1600 may include two or more electrode patterns 1690. At least two electrode patterns 1690 may be disposed on an outer surface of the fixing bracket 1600. For example, the electrode patterns 1690 may be disposed on both outer surfaces of the fixing bracket 1600, respectively. The electrode patterns 1690 may be plated on the outer surface of the fixing bracket 1600 made of a non-conductive material. For example, the electrode patterns 1690 may be formed on the outer surface of the non-conductive fixing bracket by using a laser direct structuring (LDS) and a laser manufacturing antenna (LMA).

Grooves (or cavities) corresponding to shapes of the electrode patterns 1690 may be formed on the outer surface of the fixing bracket 1600. The electrode patterns 1690 may be plated in the grooves (or cavities). Although not shown in the drawing, according to another embodiment, protrusions corresponding to the shapes of the electrode patterns 1690 may be formed on the outer surface of the fixing bracket 1600, and the electrode patterns 1690 may be plated on the protrusions.

The electrode patterns 1690 may be arranged around a guide groove 1630 of the fixing bracket 1600 and have an uneven shape or a ‘ [symbol] ’-shape. Each of the electrode patterns 1690 may have one end that is in contact with or spaced a predetermined distance from an electrode pattern 1390 of the moving bracket 1300 and the other end that is electrically connected to terminals 2191 and 2192 of the substrate 2100.

According to a movement of the moving bracket 1300 synchronized with a movement of the core body 1020, the electrode pattern 1690 may be in contact with or spaced at a predetermined distance from the electrode pattern 1390 of the moving bracket 1300. This will be explained later with reference to another drawing.

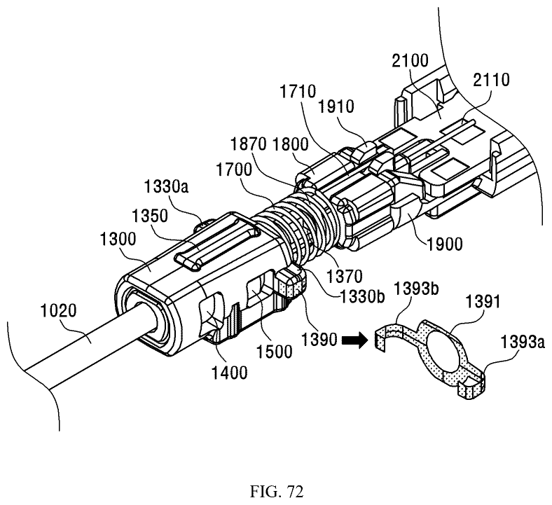

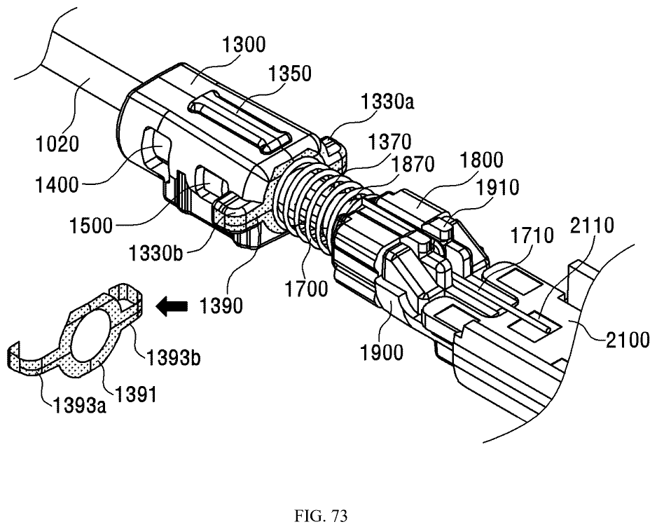

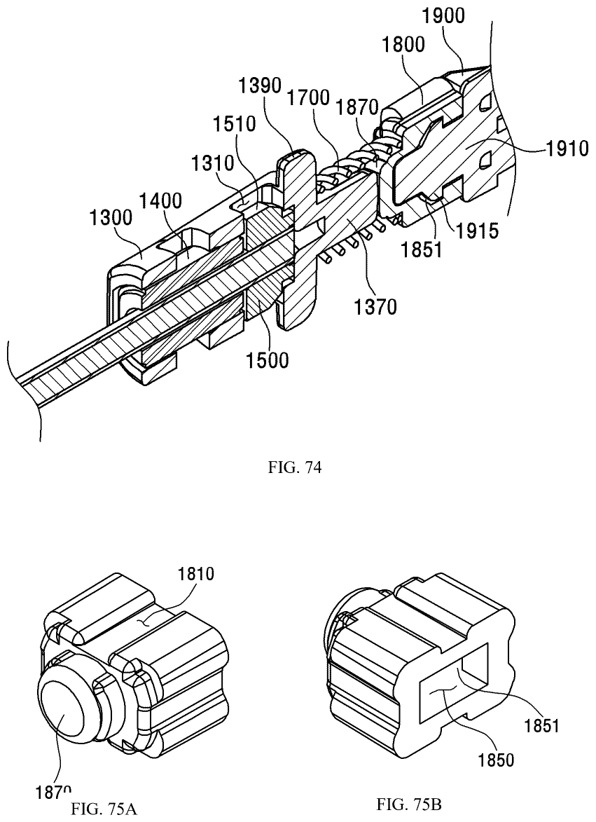

FIG. 72 is a perspective view from which the inductor unit 1200 and the fixing bracket 1600 in FIG. 68 are removed, FIG. 73 is a perspective view of FIG. 72 viewed from another direction, and FIG. 74 is a cross-sectional view of FIG. 72.

Referring to FIGS. 67 to 72, the moving bracket 1300 is moved in synchronization with the core body 1020. When one end of the core body 1020 receives external force from the outside, the core body 1020 is moved into the housing 1010, and the moving bracket 1300 is moved together with the core body 1020.

The moving bracket 1300 accommodates the other end of the core body 1020, the magnetic body 1400, and the protection member 1500. The moving bracket 1300 may include an accommodation part for accommodating the other end of the core body 1020, the magnetic body 1400, and the protection member 1500. Here, the moving bracket 1300 may also be referred to as a moving part.

In the accommodation part, the magnetic body 1400 and the protection member 1500 are disposed to surround the other end of the core body 1020. To this end, the magnetic body 1400 may have a container shape with a through-hole through which the other end of the core body 1020 passes, and the protection member 1500 may have a container shape with a through-hole through which the other end of the core body 1020 passes.

The magnetic body 1400 includes a magnetic material and is moved together with the core body 1020 in synchronization with the movement of the core body 1020. The movement of the magnetic body 1400 changes a distance to the inductor unit 1200 fixed in the housing 1010. An inductance of the inductor unit 1200 is varied by the change in distance.

The protection member 1500 may include an elastic material and be inserted between the other end of the core body 1020 and the moving bracket 1300. The protection member 1500 may protect the other end of the core body 1020. Since the protection member 1500 is inserted between the other end of the core body 1020 and the moving bracket 1300, the moving bracket 1300 may be synchronized with the movement of the core body 1020.

As illustrated in FIG. 71, the protection member 1500 may include a protrusion 1510 that protrudes from an outer surface thereof to the outside. The protrusion 1510 may be inserted into an insertion groove 1310 defined in the moving bracket 1300. The protection member 1500 may be stably fixed to the moving bracket 1300 by the protrusion 1510 of the protection member 1500 and the insertion groove 1310 of the moving bracket 1300, and thus the other end of the core body 1020 may be fixed to the moving bracket 1300.

The moving bracket 1300 may include a first protrusion 1330a and a second protrusion 1330b. The first protrusion 1330a and the second protrusion 1330b may protrude in an outward direction from the outer surface of the moving bracket 1300 or in a direction perpendicular to a longitudinal direction of the stylus pen 1000. The first protrusion 1330a and the second protrusion 1330b may be disposed in the guide hole 1630 of the fixing bracket 1600 in FIG. 68. When the moving bracket 1300 is moved in synchronization with the movement of the core body 1020, the first protrusion 1330a and the second protrusion 1330b may be moved along the guide hole 1630 of the fixing bracket 1600.

The moving bracket 1300 may include a third protrusion 1350. The third protrusion part 1350 may protrude in an outward direction from the outer surface of the moving bracket 1300 or in a direction perpendicular to the longitudinal direction of the stylus pen 1000. The third protrusion 1350 may be disposed in the guide hole 1650 of the fixing bracket 1600 in FIG. 68. When the moving bracket 1300 is moved in synchronization with the movement of the core body 1020, the third protrusion 1350 may be moved along the guide hole 1650 of the fixing bracket 1600.

The moving bracket 1300 may include an extension part 1370. The extension part 1370 may extend along the longitudinal direction of the stylus pen 1000 from the outer surface of the moving bracket 1300. Alternatively, the extension part 1370 may extend along the longitudinal direction of the core body 1020 from the outer surface of the moving bracket 1300. The extension part 1370 may have a structure and a shape to be disposed in the elastic member 1700. An extension part 1870 of the elastic member 1800 may be disposed on an end of the extension part 1370.

The moving bracket 1300 may include an electrode pattern 1390. The electrode pattern 1390 may be disposed on the outer surface of the moving bracket 1300, on which the extension part 1370 is formed, among the outer surfaces of the moving bracket and on the first and second protrusions 1330a and 1330b.

The electrode pattern 1390 may be in contact with and electrically connected to the elastic body 1700 surrounding the extension part 1370 of the moving bracket 1300. The electrode pattern 1390 may be in contact with and electrically connected to the electrode pattern 1690 of the fixing bracket 1600 in FIG. 68, and detached and electrically disconnected from the electrode pattern 1690 of the fixing bracket 1600 by the movement of the core body 1020.

The electrode pattern 1390 may be plated on the outer surface of the moving bracket 1300 made of non-conductive material. For example, the electrode pattern 1390 may be formed on the outer surface of the moving bracket 1300 by using a laser direct structuring (LDS) and a laser manufacturing antenna (LMA).

The electrode pattern 1390 may include a base electrode pattern 1391 and first and second extension patterns 1393a and 1393b.

The base electrode pattern 1391 may be disposed on the outer surface of the moving bracket 1300 and arranged to surround the extension part 1370 of the moving bracket 1300. The base electrode pattern 1391 contacts one end of the elastic member 1700.

The first and second extension patterns 1393a and 1393b may extend respectively from both sides of the first electrode pattern 1391, the first extension pattern 1393a may be disposed on the first protrusion 1330a, and the second extension pattern 1393b may be disposed on the second protrusion 1330b. The first and second extension patterns 1393a and 1393b may contact the electrode pattern 1690 of the fixing bracket 1600 in FIG. 68 or may be separated therefrom by a movement of the core body 1020.

The elastic body 1700 may be made of a conductive material and have a spring shape. The elastic body 1700 may be disposed between the moving bracket 1300 and the elastic member 1800. Here, the elastic body 1700 may be inserted between the moving bracket 1300 and the elastic member 1800 in a partially pressed state instead of being completely pressed. When the external force applied to the moving bracket 1300 synchronized with the movement of the core body 1020 is less than elastic force of pushing outward from the partially pressed elastic body 1700, the elastic member 1700 is not pressed. When the external force is greater than the elastic force, the elastic body 1700 is initiated to be pressed.

In the elastic body 1700, the extension part 1370 of the moving bracket 1300 and the extension part 1870 of the elastic member 1800 may be disposed together. Through this, there is an advantage in that an inner volume of the stylus pen 1000 may be reduced because an inner space of the elastic body 1700 is usable.

The elastic body 1700 has one end electrically connected to the electrode pattern 1390 of the moving bracket 1300 and the other end electrically connected to the terminal 2110 of the substrate 2100. The elastic body 1700 may include a connecting wire 1710 that connects the elastic body 1700 and the terminal 2110 of the substrate 2100. The connecting wire 1710 may have one end connected to the elastic body 1700 and the other end connected to the terminal 2110 of the substrate 2100. Each of the elastic member 1800 and the substrate bracket 1900 may have a guide groove in which the connecting wire 1710 is disposed in order to protect and guide the connecting wire 1710.

The elastic member 1800 is made of a non-conductive material and has a predetermined elasticity. For example, the elastic member 1800 may be made of rubber.

The elastic member 1800 may be disposed between the moving bracket 1300 and the substrate bracket 1900.

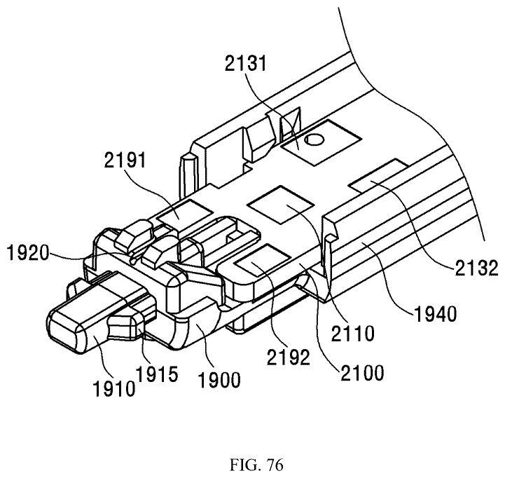

FIGS. 75A and 75B are perspective views illustrating only the elastic member 1800 in FIG. 72, and FIG. 76 is a perspective view illustrating the substrate bracket 1900 and the substrate 2100 in FIG. 72.

Referring to FIGS. 69 to 74, the elastic member 1800 may include an extension part 1870. The extension part 1870 may extend in a direction from an outer surface of the elastic member 1800 to the moving bracket 1300. The extension part 1870 may be disposed in the elastic body 1700.

The elastic member 1800 may include a guide groove 1810. The guide groove 1810 may be formed along the longitudinal direction of the stylus pen 1000 on the outer surface of the elastic member 1800. An extension line 1710 of the elastic body 1700 may be disposed in the guide groove 1810.

The elastic member 1800 may include a mounting groove 1850. The mounting groove 1850 is defined in the outer surface of the elastic member 1800. The mounting groove 1850 may be disposed at a side opposed to the extension part 1870. A mounting part 1910 of the substrate bracket 1900 may be inserted into the mounting groove 1850. A latch groove 1851 having a shape corresponding to a protrusion 1915 of the mounting part 1910 of the substrate bracket 1900 may be formed in the mounting groove 1850. Through this, the elastic member 1800 may be stably fixed and mounted to the substrate bracket 1900.

The substrate bracket 1900 supports the substrate 2100 in the housing 1010 and is coupled with the elastic member 1800 to support the elastic member 1800.

The substrate bracket 1900 may include a side part 1940 that guides and supports a side portion of the substrate 2100.

The substrate bracket 1900 may include a mounting part 1910 for being coupled with the elastic member 1800. The mounting part 1910 protrudes in a direction from the substrate bracket 1900 to the moving bracket 1300. The mounting part 1910 may include a protrusion 1915 that protrudes from an outer surface thereof. The protrusion 1915 may protrude in a direction perpendicular to a direction in which the mounting part 1910 protrudes.

The substrate bracket 1900 may include a guide groove 1920. The guide groove 1920 may guide and protect the connecting wire 1710 of the elastic member 1700.

The substrate 2100 is disposed on the substrate bracket 1900.

The substrate 2100 may include a plurality of terminals 2110, 2131, 2132, 2191, and 2192. Among the plurality of terminals 2110, 2131, 2132, the terminal 2110 is electrically connected to the elastic body 1700, and first and second terminals 2131 and 2132 are electrically connected to the coil 1230 of the inductor unit 1200. Third and fourth terminals 2191 and 2192 are electrically connected to electrode patterns 1690 disposed on both outer surfaces of the fixing bracket 1600, respectively.

The substrate 2100 includes a capacitor unit (not shown). One or more capacitors that constitute the capacitor unit (not shown) may be arranged on the substrate 2100.

The substrate 2100 may include a circuit pattern that electrically connects the one or more capacitors of the capacitor unit (not shown) and the plurality of terminals 2110, 2131, and 2132.

FIGS. 77A and 77B are views for explaining a movement of a moving bracket 1300 according to a movement of the core body 1020 in FIGS. 68 to 76, and an electrical contact and disconnection between the fixing bracket 1600 and the moving bracket 1300;

FIG. 77A illustrates a case when any external force is not applied to the core body 1020, and FIG. 77B illustrates a case when predetermined external force is applied to the core body 1020 to move the moving bracket 1300 in one direction.

First, referring to FIG. 77A, when any external force is not applied to the core body 1020, the electrode pattern 1390 of the moving bracket 1300 contacts the electrode pattern 1690 of the fixing bracket 1600. That is, the electrode pattern 1390 of the moving bracket 1300 and the electrode pattern 1690 of the fixing bracket 1600 are electrically connected to each other.

As the second protrusion 1330b of the moving bracket 1300 is pushed toward the core body 1020 by the elastic body 1700, a state in which the electrode pattern 1390 disposed on an outer surface of the second protrusion 1330b is in contact with the electrode pattern 1690 of the fixing bracket 1600 may be maintained.

Referring to FIG. 77B, when predetermined force is applied to the core body 1020 to move the core body 1020 in one direction, the moving bracket 1300 is moved together with the core body 1020 in the one direction. As the moving bracket 1300 is moved in the one direction, the second protrusion 1330b is also moved in the one direction. As the second protrusion 1330b is moved, a contact between the electrode pattern 1390 of the moving bracket 1300 and the electrode pattern 1690 of the fixing bracket 1600 is released. Likewise, as the first protrusion 1330a disposed at a side opposed to the second protrusion 1330b is also moved, the contact between the electrode pattern 1390 of the moving bracket 1300 and the electrode pattern 1690 of the fixing bracket 1600 is released. Also, as the moving bracket 1300 is moved, the elastic body 1700 is pressed.

As illustrated in FIG. 77B, when predetermined force is applied to the core body 1020 to move the core body 1020 in one direction, a contact between the electrode pattern 1390 of the moving bracket 1300 and the electrode pattern 1690 of the fixing bracket 1600 is released. The release of the contact causes a change in capacitance of the capacitor unit (not shown) mounted to the substrate 2100. The change of the capacitance changes a frequency of a pen signal emitted from the stylus pen 1000. A receiving side that receives the pen signal may detect the changed frequency to determine whether the stylus pen 1000 is brought into contact with a screen.

As the moving bracket 1300 is moved, the magnetic body 1400 disposed in the moving bracket 1300 is also moved. As the magnet 1400 is moved, a distance between the inductor unit 1200 and the magnetic body 1400 increases. The change in distance between the inductor unit 1200 and the magnetic body 1400 changes an inductance of the inductor unit (not shown). The change in inductance occurs together with the above-described change in capacitance. Here, the stylus pen may be configured such that the change of the capacitance is more dominantly changed than the change of the inductance. In a limited inner space of the housing of the stylus pen, it is easier to dramatically change the capacitance rather than the inductance. Alternatively, depending on cases, the stylus pen may be configured such that the change of the inductance is more dominantly changed than the change of the capacitance. Alternatively, the stylus pen may be configured such that the change of the capacitance is similar in phase to the change of the inductance. In any of the above-described three cases, the capacitance and the inductance are changed by the movement of the moving bracket 1300, and the changes of the capacitance and the inductance cause a change of the resonance frequency of the resonance circuit formed by the inductor unit 1200 and the capacitor unit. The receiver that receives the pen signal may detect the change of the resonance frequency to determine whether the stylus pen 1000 is in contact with the screen.

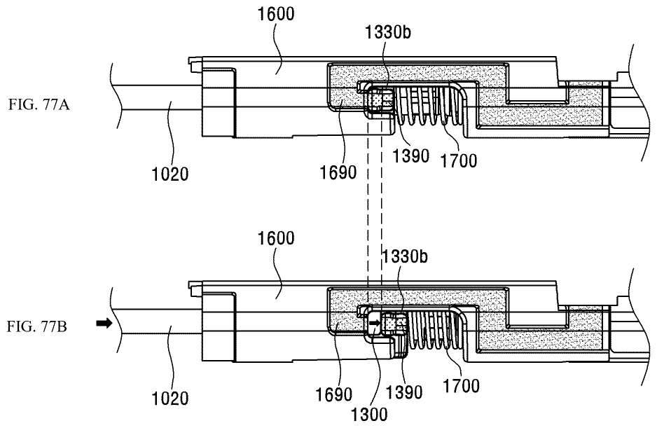

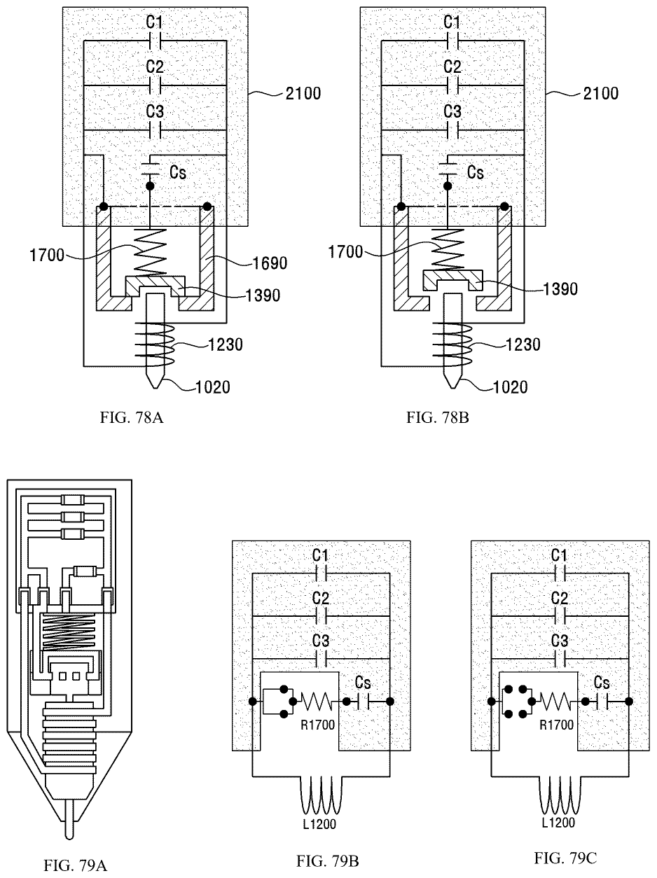

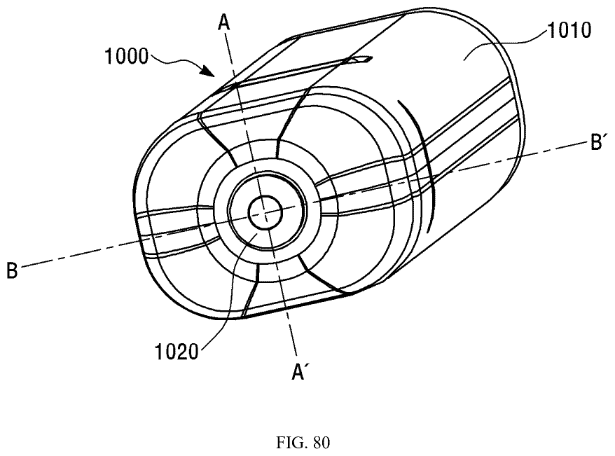

FIGS. 78A and 78B are views schematizing each of FIGS. 77A and 77B, and FIGS. 79A to 79C are views simplifying a stylus pen according to another embodiment of the present invention and showing equivalent circuit diagrams of FIGS. 77A and 77B.

Referring to FIGS. 78A and 78B and FIGS. 79B and 79C, a plurality of capacitors C1, C2, C3, and Cs are arranged on the substrate 2100. The capacitors C1, C2, C3, and Cs may form a capacitor unit (not shown). At least one or more capacitors C1, C2, and C3 of the plurality of capacitors C1, C2, C3, and Cs are connected in parallel to maintain a constant capacitance value, and an auxiliary capacitor Cs is connected in parallel to the basic capacitor according to the contact or release between the electrode pattern 1690 of the fixing bracket 1600 and the electrode pattern 1390 of the moving bracket 1300 as illustrated in FIGS. 77A and 77B.

First, as illustrated in FIG. 78A and FIG. 79B, since the electrode pattern 1690 of the fixing bracket 1600 and the electrode pattern 1390 of the moving bracket 1300 are in contact with each other in a state in which external force is not applied to the core body 1020, an auxiliary capacitor Cs is connected in parallel with the basic capacitors C1, C2, and C3. Thus, a capacitance of the capacitor unit (not shown) is a sum of capacitance values of the basic capacitors C1, C2, and C3 and the auxiliary capacitor Cs.

Thereafter, as illustrated in FIG. 78B and FIG. 79C, when predetermined external force is applied to the core body 1020,

the electrode pattern 1390 of the moving bracket 1300 is released from the electrode pattern 1690 of the fixing bracket 1600 by the movement of the moving bracket 1300 synchronized with the movement of the core body 1020. Thus, the auxiliary capacitor Cs is not electrically connected to the basic capacitors C1, C2, and C3, and the capacitance of the capacitor unit (not shown) is changed to a capacitance value of the basic capacitors C1, C2, and C3.

In particular, referring to FIG. 79B, it may be known that the electrode pattern 1390 of the moving bracket 1300 is in contact with the electrode pattern 1690 of the fixing bracket 1600 at two points. As illustrated in FIGS. 72 and 73, it may be understood that the fixing bracket 1600 has two electrode patterns 1690, and the first and second extension patterns 1393a and 1393b are arranged on the first and second protrusions 1330a and 1330b of the moving bracket 1300.

When the external force applied to the core body 1020 is insufficient to separate both the first and second extension patterns 1393a and 1393b from two electrode patterns 1690 of the fixing bracket 1600, i.e., when the first extension pattern 1393a is separated from one electrode pattern 1690 of the fixing bracket 1600 while the second extension pattern 1393b is not separated from the other electrode pattern 1690 of the fixing bracket 1600, the auxiliary capacitor Cs remains connected in parallel with the basic capacitors C1, C2, and C3.

On the other hand, only when the external force applied to the core body 1020 is sufficient to completely separate both the first and second extension patterns 1393a and 1393b from the two electrode patterns 1690 of the fixing bracket 1600, the auxiliary capacitor Cs is electrically disconnected from the basic capacitors C1, C2, and C3. Thus, when the stylus pen 1000 according to another embodiment of the present invention is used, there is an advantage in that a clear distinguishment between the hover state and the contact state may be obtained by clearly setting a reference pressure for distinguishing the hover state and the contact state. In particular, since the stylus pen 1000 according to another embodiment of the present invention may still maintain the contact state between another extension pattern and another electrode pattern although one extension pattern of the first and second extension patterns 1393a and 1393b is not in contact with one of the two electrode patterns 1690 of the fixing bracket 1600 due to a limitation in manufacturing process while manufacturing the stylus pen or carelessness of a user while using the stylus pen.

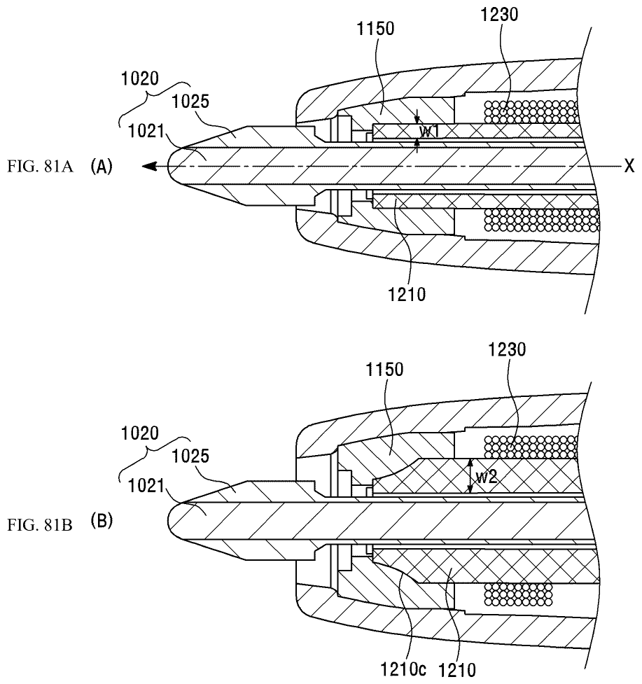

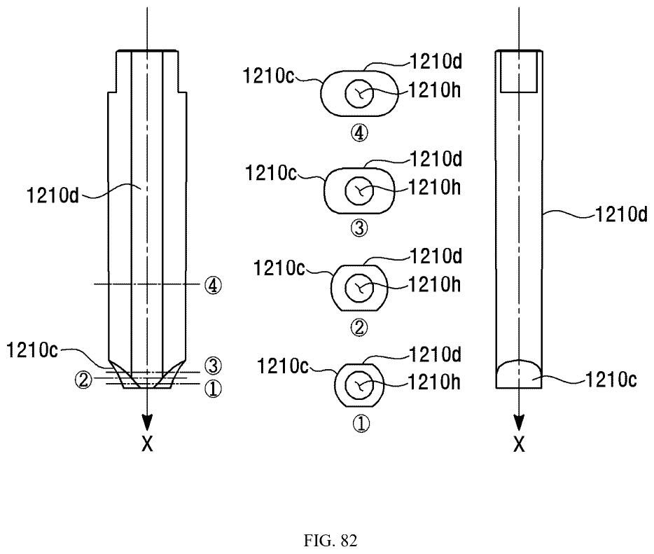

FIG. 80 is a perspective view illustrating the stylus pen 1000 in FIG. 66 according to another embodiment of the present invention viewed from the core body 1020, FIG. 81A is a partial cross-sectional view taken along line A-A′ of the stylus pen 1000 in FIG. 80, FIG. 81B is a partial cross-sectional view taken along line B-B′ of the stylus pen 1000 in FIG. 80, and FIG. 82 is a view illustrating cross-sectional views and side views of the ferrite core 1210 in FIGS. 80, 81A and 81B.

Referring to FIGS. 68 and 80 to 81B, the housing 1010 of the stylus pen 1000 has a rectangular container shape having rounded corners, and an exposed portion of the core body 1020 in the housing 1010 has a width that gradually decreases in an outward direction.

Components disposed in the housing 1010 have shapes corresponding to the shape of the housing 1010 according to an outer shape of the housing 1010. Among the inner components, the ferrite core 1210 of the inductor unit 1200 also has an optimized structure corresponding to the outer shape of the housing 1010.

As illustrated in FIGS. 81A and 81B, in the ferrite core 1210, a first cross-sectional shape taken along a first vertical direction (A-A′ direction in FIG. 80) perpendicular to an axial direction X (or the longitudinal direction of the stylus pen 1000) of the ferrite core 1210 is different from a second cross-section shape taken along a second vertical direction (B-B′ direction in FIG. 80). Specifically, a thickness w1 of the ferrite core 1210 in the first vertical direction is different from a thickness w2 in the second vertical direction. More specifically, the thickness w1 in the first vertical direction is less than the thickness w2 in the second vertical direction. Here, the thickness w1 in the first vertical direction is defined as a minimum distance from the through-hole 1210h of the ferrite core 1210 to the outer surface of the ferrite core 1210 in the first cross-sectional shape, and the thickness w2 in the second vertical direction is defined as a minimum distance from the through-hole 1210h of the ferrite core 1210 to the outer surface of the ferrite core 1210 in the second cross-sectional shape. Alternatively, unlike as illustrated in the drawing, the thickness w1 in the first vertical direction may be a total thickness of the ferrite core 1210 in the first cross-sectional shape, and the thickness w2 in the second vertical direction may be a total thickness of the ferrite core 1210 in the second cross-sectional shape.

The ferrite core 1210 has a container or cylinder shape. A flat portion 1210d may be disposed on at least a portion of the outer surface of the ferrite core 1210. A flat portion corresponding to the flat portion 1210d may be disposed on another portion of the outer surface of the ferrite core 1210. The ferrite core 1210 may be stably disposed in the housing 1010 by the flat portion 1210d. The flat portion 1210d extends from one end to the other end of the ferrite core 1210 along the axial direction X of the ferrite core 1210.

One end of the ferrite core 1210 may include at least two curved portions 1210c. As illustrated in FIGS. 81A and 81B, at least a portion of the curved portion 1210c may be shown in the second cross-sectional shape, but may not be shown in the first cross-sectional shape. The curved portion 1210c may be curved from one side surface of one end of the ferrite core 1210 to a portion adjacent to the through-hole 1210h of the ferrite core 1210 in a direction toward the through-hole 1210h. The curved portion 1210c may be disposed on each of both sides opposed to each other at one end of the ferrite core 1210 based on the through-hole 1210h.

As illustrated in \textcircled{1}, \textcircled{2}, and \textcircled{3} of FIG. 82, the curved portion 1210c is changed in shape from an aspherical shape to a spherical shape along the axial direction X of the ferrite core 1210. \textcircled{3} of FIG. 82 shows the curved portion 1210c having an aspherical shape, and \textcircled{1} of FIG. 82 shows the curved portion 1210c having a spherical shape. Also, \textcircled{2} of FIG. 82 shows that the curved portion 1210c has an intermediate shape between the aspherical shape and the spherical shape.

At one end of the ferrite core 1210, the flat portion 1210d has a shape having a width that gradually decreases along the axial direction X of the ferrite core 1210. Here, the width of the flat portion 1210d may decrease non-linearly.

As described in FIGS. 39 to 41, when the above-described ferrite core 1210 is used, the inductor unit 1200 including the ferrite core 1210 may be disposed closer to a tip of the stylus pen 1000 in the stylus pen 1000. Thus, since the inductor unit 1200 may be moved relatively closer to the receiver (not shown), the pen signal received by the receiver may increase.

On the other hand, the ferrite core 1210 in FIGS. 80 to 82 may be applied to the stylus pen in FIG. 36 or 55. Furthermore, the ferrite core of the stylus pen in FIG. 36 or 22 may be applied to the stylus pen in FIG. 66.

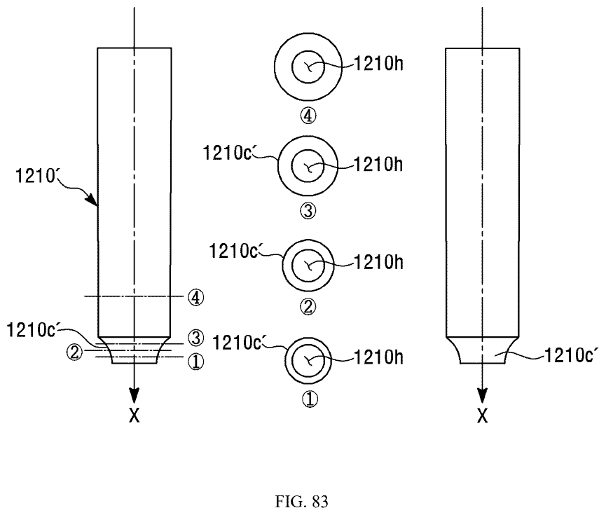

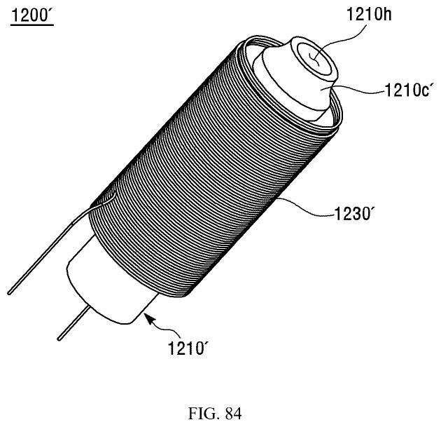

FIG. 83 is a view for explaining a modified example of the ferrite core 1210 in FIG. 82, and FIG. 84 is a perspective view illustrating an inductor unit 1200′ in which a coil 1230′ is wound around an outer surface of the ferrite core 1210′ in FIG. 83.

Referring to FIG. 83, the ferrite core 1210′ has a cylindrical shape.

One end of the ferrite core 1210′ may include a curved portion 1210c′. The curved portion 1210c′ may be a curved surface extending from one end of the ferrite core 1210′ to a portion adjacent to the through-hole 1210h of the ferrite core 1210′ in a direction toward the through-hole 1210h.

The ferrite core 1210′ has a through-hole 1210h along the axial direction X. The through-hole 1210h may have a constant diameter from one end to the other thereof.

As illustrated in \textcircled{1}, \textcircled{2}, and \textcircled{3} of FIG. 83, the curved portion 1210c′ has an outer diameter that gradually decreases in the axial direction X of the ferrite core 1210′ and a constant inner diameter. Here, the inner diameter defines the through-hole 1210h. Alternatively, as illustrated in \textcircled{1}, \textcircled{2}, and \textcircled{3} of FIG. 83, a thickness between the outer diameter and the inner diameter of the curved portion 1210c′ gradually decreases in the axial direction X of the ferrite core 1210′.

A rate of decrease in the outer diameter or the thickness (between the outer diameter and the inner diameter) along the axial direction X of the ferrite core 1210′ may be non-linear. More specifically, when dividing one end of the ferrite core 1210′ into an upper portion (on which \textcircled{3} is disposed), an intermediate portion (on which \textcircled{2} is disposed), and a lower portion (on which \textcircled{1} is disposed), the rate of decrease in the outer diameter or thickness from the upper portion to the intermediate portion may be relatively greater than that from the intermediate portion to the lower portion. That is, the rate of decrease from the upper portion to the intermediate portion may be relatively sharp, and the rate of decrease from the intermediate portion to the lower portion may be relatively mild.

Referring to FIG. 84, the coil 1230′ may be wound around the outer surface (or outer circumference) of the ferrite core 1210′.

The inductor unit 1200′ including the ferrite core 1210′ and the coil 1230′ may be disposed in a cylindrical housing (not shown) instead of the housing 1000 in FIG. 80. Although not shown in the drawing, the ferrite core of the inductor unit may have a shape corresponding to the inner shape of the housing.

### Overall Configuration of Stylus Pen Having Waterproof Function

A stylus pen 100 according to an embodiment of the present disclosure may include a housing 101, a core 102, an inductor unit 120, a capacitor unit (not shown), a first fixing member 130, and sealing members 200a, 200a′, and 200b. A detailed description on the housing 101, the core 102, the inductor unit 120, the capacitor unit (not shown), and the first fixing member 130 is the same as that described above.

A stylus pen 1000 according to another embodiment of the present disclosure may include a housing 1010, a core 1020, an inductor unit 1200, a capacitor unit (not shown), a fixing bracket 1600, and sealing members 2000a, 2000a′, and 2000b. A detailed description on the housing 1010, core 1020, the inductor unit 1200, the capacitor unit (not shown), and the fixing bracket 1600 is the same as that described above.

On the other hand, the sealing member 200a, 200a′, 200b of the stylus pen 100 according to an embodiment of the present disclosure and the sealing member 2000a, 2000a′, and 2000b of the stylus pen 1000 according to another embodiment may be made of synthetic rubber or thermoplastic elastomer (TPE). For example, the synthetic rubber may include nitrile butadiene rubber (NBR), fluoroelastomer (FKM), ethylene propylene diene monomer (EPDM), or silicone rubber. However, the embodiment of the present disclosure is not limited thereto.

Hereinafter, the sealing member 200a, 200a′, and 200b of the stylus pen 100 according to an embodiment of the present disclosure and the sealing member 2000a, 2000a′, and 2000b of the stylus pen 1000 according to another embodiment will be described in detail with reference to the accompanying drawings.

### Moisture Ingress Path

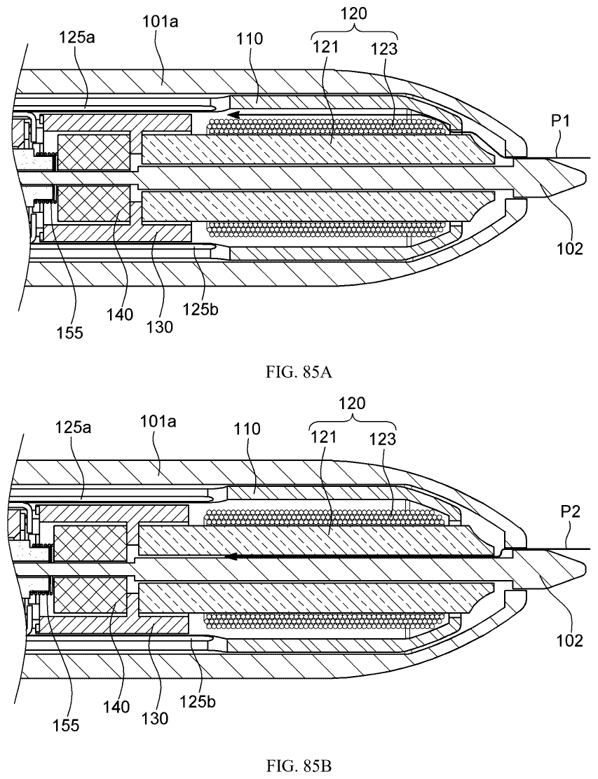

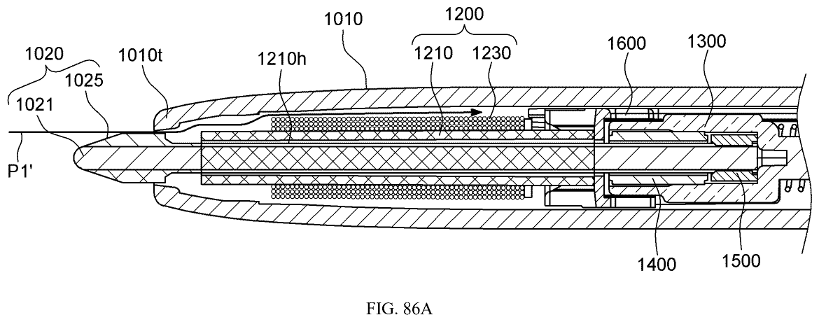

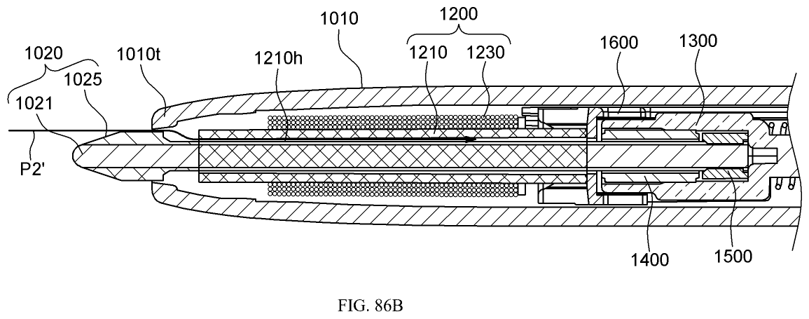

FIGS. 85A and 85B are views illustrating a first moisture ingress path and a second moisture ingress path in which moisture enters into the stylus pen in FIG. 9 through a core opening of the housing. FIGS. 86A and 86B are views illustrating a first moisture ingress path and a second moisture ingress path in which moisture enters into the stylus pen in FIG. 34 through a core opening of the housing.

As illustrated in FIGS. 85A and 85B, moisture may enter into the stylus pen 100 in FIG. 9 through a core opening (not shown) of the housing 101.

Here, the core opening (not shown) may refer to a gap between the housing 101 and the core 102.

Specifically, as illustrated in FIG. 85A, moisture may enter into the stylus pen 100 through the first moisture ingress path P1, in which moisture enters into the stylus pen 100 through the core opening (not shown) of the housing 101 and the space between the housing 101 and the inductor unit 120. Alternatively, as illustrated in FIG. 85B, moisture may enter into the stylus pen 100 through a second moisture ingress path P2, in which moisture enters into the stylus pen 100 through a core opening (not shown) of the housing 101 and a through-hole of a ferrite core 121.

As illustrated in FIGS. 86A and 86B, moisture may also enter into the stylus pen 1000 in FIG. 34 through a core opening (not shown) of the housing 1010. Specifically, as illustrated in FIG. 86A, moisture may enter into the stylus pen 1000 through a first moisture ingress path P1′, in which moisture enters into the stylus pen 1000 through a core opening (not shown) of the housing 1010 and a space between the housing 1010 and the inductor unit 1200. Alternatively, as illustrated in FIG. 86B, moisture may enter into the stylus pen 1000 through a second moisture ingress path P2′, in which moisture enters into the stylus pen 1000 through a core opening (not shown) of the housing 1010 and a through-hole of a ferrite core 1210.

### Stylus Pen Including Sealing Member Capable of Blocking a Plurality of Moisture Ingress Paths

The stylus pen 100 illustrated in FIG. 9 may include a plurality of sealing members 200a, 200a′, and 200b capable of blocking a plurality of moisture ingress paths P1 and P2 passing through a core opening (not shown) of the housing 101. Specifically, the plurality of moisture ingress paths P1 and P2 may include a first moisture ingress path P1 and a second moisture ingress path P2. More specifically, the plurality of sealing members 200a, 200a′, and 200b may include a first sealing member 200a and 200a′ capable of blocking the first moisture ingress path P1 and a second sealing member 200b capable of blocking the second moisture ingress path P2.

The stylus pen 1000 illustrated in FIG. 34 may include a plurality of sealing members 2000a, 2000a′, and 2000b capable of blocking a plurality of moisture ingress paths P1′ and P2′ passing through a core opening (not shown) of the housing 1010. Specifically, the plurality of moisture ingress paths P1′ and P2′ may include a first moisture ingress path P1′ and a second moisture ingress path P2′. More specifically, the plurality of sealing members 2000a, 2000a′, and 2000b may include a first sealing member 2000a and 2000a′ capable of blocking the first moisture ingress path P1′, and a second sealing member 2000b capable of blocking the second moisture ingress path P2′.

### Arrangement of First Sealing Member

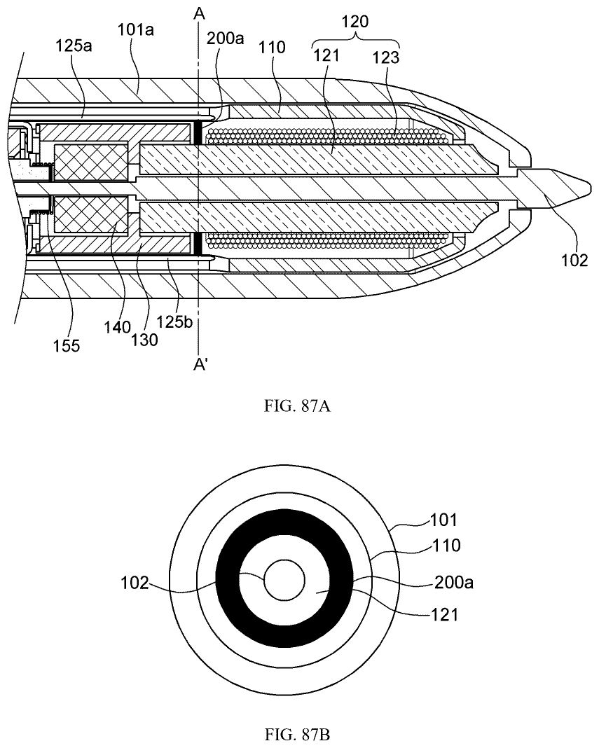

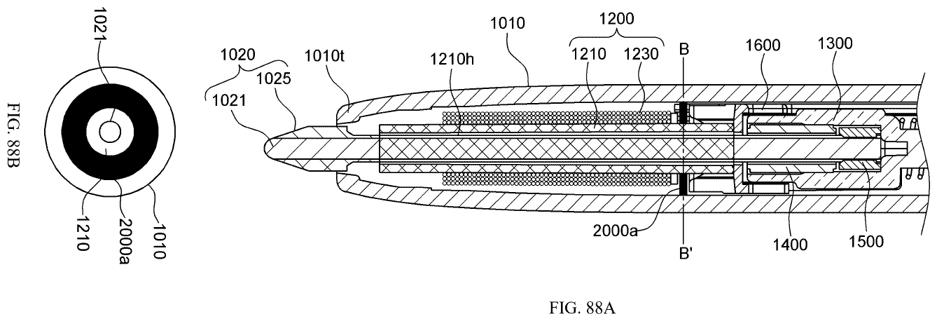

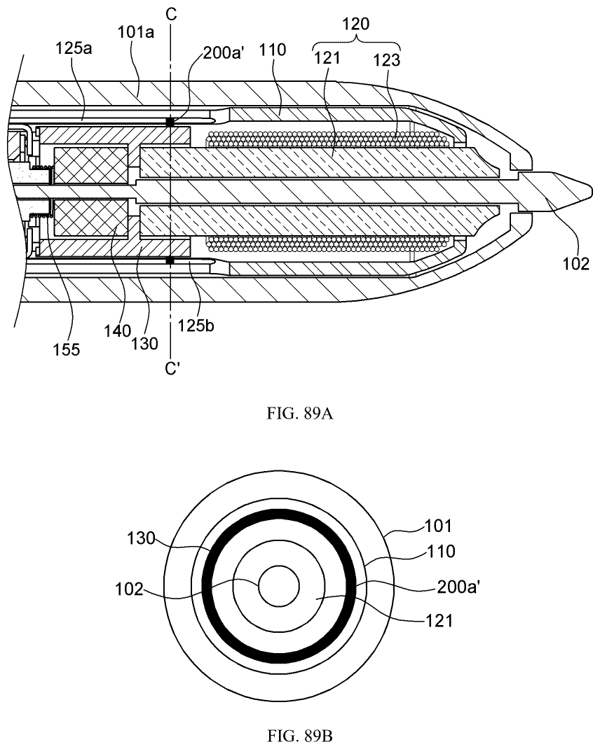

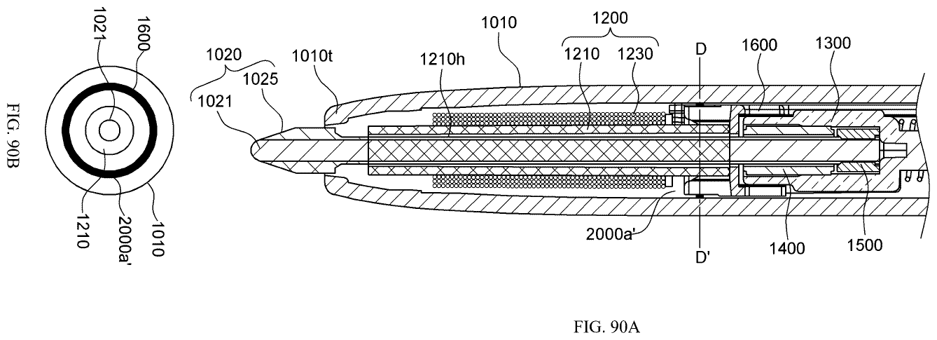

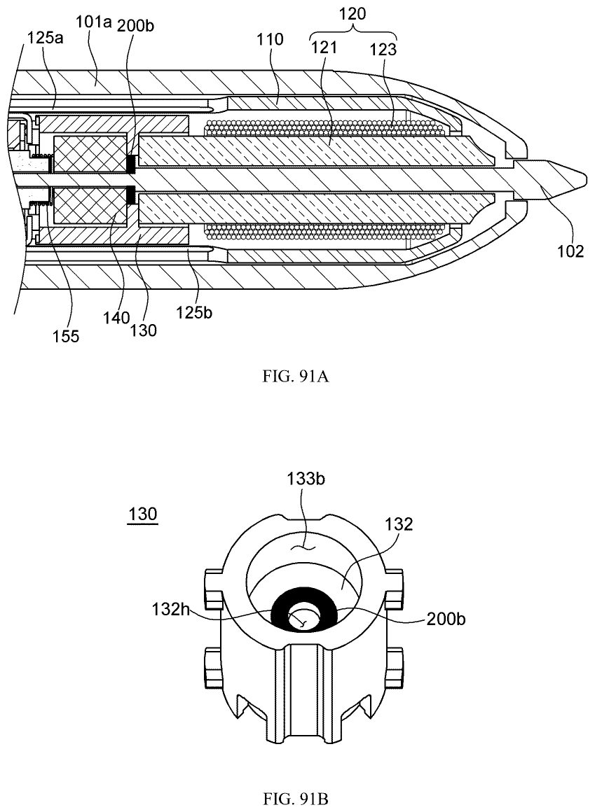

FIGS. 87A and 87B is a view illustrating an embodiment of a sealing member for blocking the first moisture ingress path in the stylus pen in FIGS. 85A and 85B. FIGS. 88A and 88B is a view illustrating an embodiment of a sealing member for blocking the first moisture ingress path in the stylus pen in FIGS. 86A and 86B. FIGS. 89A and 89B is a view illustrating another embodiment of the sealing member for blocking the first moisture ingress path in the stylus pen in FIGS. 85A and 85B. FIGS. 90A and 90B is a view illustrating another embodiment of the sealing member for blocking the first moisture ingress path in the stylus pen in FIGS. 86A and 86B.

Arrangement that Surrounds Outer Surface of Ferrite Core

FIG. 87A is a view illustrating an embodiment of the first sealing member 200a that surrounds an outer surface of the ferrite core 121 of the stylus pen 100 in FIGS. 85A and 85B. FIG. 87B is a cross-sectional view obtained by cutting the stylus pen 100 along line A-A′ in FIG. 87A.

As illustrated in FIGS. 87A and 87B, the first sealing member 200a may surround at least a portion of the outer surface of the ferrite core 121. Also, the first sealing member 200a may be in close contact with an inner wall of the housing 101. Accordingly, the first sealing member 200a may prevent moisture from entering through the first moisture ingress path P1.

As described above, the stylus pen 100 in FIGS. 85A and 85B may further include an inner case 110 disposed in the housing 101. When the stylus pen 100 further includes the inner case 110, the first sealing member 200a may be in close contact with an inner wall of the inner case 110.

FIG. 88A is a view illustrating an embodiment of the first sealing member 2000a that surrounds an outer surface of the ferrite core 1210 of the stylus pen 1000 in FIGS. 86A and 86B.

FIG. 88B is a cross-sectional view obtained by cutting the stylus pen 1000 along line B-B′ in FIG. 88A.

As illustrated in FIGS. 88A and 88B, the first sealing member 2000a may surround at least a portion of the outer surface of the ferrite core 1210. Also, the first sealing member 2000a may be in close contact with an inner wall of the housing 1010. Accordingly, the first sealing member 2000a may prevent moisture from entering through the first moisture ingress path P1′.

Arrangement that Surrounds Outer Surface of Fixing Bracket (or First Fixing Member)

FIG. 89A is a view illustrating an embodiment of a first sealing member 200a′ that surrounds an outer surface of the first fixing member 130 of the stylus pen 100 in FIGS. 85A and 85B. FIG. 89B is a cross-sectional view taken along line C-C′ of the stylus pen 100 in FIG. 89A according to an embodiment of the present disclosure.

As illustrated in FIGS. 89A and 89B, the first sealing member 200a′ may surround at least a portion of the outer surface of the first fixing member 130. Also, the first sealing member 200a′ may be in close contact with the inner wall of the housing 101. Accordingly, the first sealing member 200a′ may prevent moisture from entering through the first moisture ingress path P1.

As described above, the stylus pen 100 in FIGS. 85A and 85B may further include an inner case 110 disposed in the housing 101. When the stylus pen 100 further includes the inner case 110, the first sealing member 200a′ may be in close contact with the inner wall of the inner case 110.

FIG. 90A is a view illustrating an embodiment of the first sealing member 2000a′ that surrounds an outer surface of the fixing bracket 1600 of the stylus pen 1000 in FIGS. 86A and 86B. FIG. 90B is a cross-sectional view obtained by cutting the stylus pen 1000 along line D-D′ in FIG. 90A.

As illustrated in FIGS. 90A and 90B, the first sealing member 2000a′ may surround at least a portion of the outer surface of the fixing bracket 1600. Also, the first sealing member 2000a′ may be in close contact with the inner wall of the housing 1010. Accordingly, the first sealing member 2000a′ may prevent moisture from entering through the first moisture ingress path P1′.

### Arrangement of Second Sealing Member

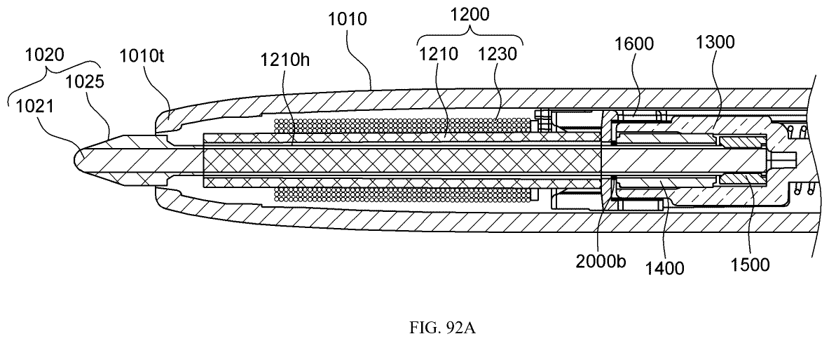

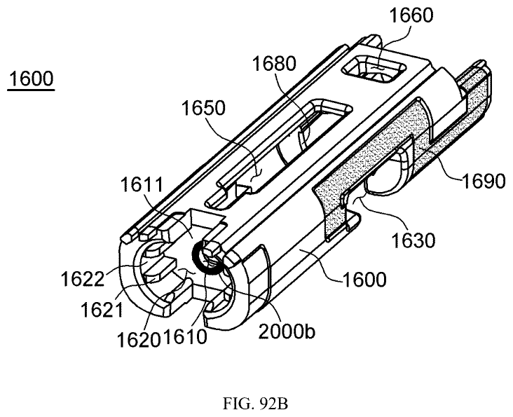

FIGS. 91A and 91B are views illustrating a sealing member for blocking the second moisture ingress path in the stylus pen in FIGS. 85A and 85B. FIGS. 92A and 92B are views illustrating a sealing member for blocking the second moisture ingress path in the stylus pen shown in FIGS. 86A and 86B.

FIG. 91A is a view illustrating an embodiment of a second sealing member 200b disposed on a partition wall 132 of the first fixing member 130 in the stylus pen 100 in FIGS. 85A and 85B. FIG. 91B is a perspective view illustrating a coupling relationship between the first fixing member 130 and the second sealing member 200b.

As illustrated in FIGS. 91A and 91B, the second sealing member 200b may be disposed on the partition wall 132 so that the core fills an outer portion of a through-hole 132h of the partition wall 132. Also, the second sealing member 200b may be in close contact with the core 102 at a portion at which the core 102 passes through the through-hole 132h of the partition wall 132. Accordingly, the second sealing member 200b may prevent moisture from entering through the second moisture ingress path P2. On the other hand, a detailed description on the first fixing member 130, the partition wall 132, and the through-hole 132h is the same as that described above.

FIG. 92A is a view illustrating an embodiment of a second sealing member 2000b disposed on a partition wall 1611 of the fixing bracket 1600 in the stylus pen 1000 in FIGS. 86A and 86B. FIG. 92B is a perspective view illustrating a coupling relationship between the fixing bracket 1600 and the second sealing member 2000b.

As illustrated in FIGS. 92A and 92B, the second sealing member 2000b may be disposed on the partition wall 1611 so that the core 1020 fills an outer portion of a through-hole 1610 of the partition wall 1611. Also, the second sealing member 2000b may be disposed in close contact with the core 1020 at a portion at which the core 1020 passes through the through-hole 1610 of the partition wall 1611. Accordingly, the second sealing member 2000b may prevent moisture from entering through the second moisture ingress path P2′. On the other hand, a detailed description on the fixing bracket 1600, the partition wall 1611, and the through-hole 1610 is the same as that described above.

### Stylus Pen Including First and Second Sealing Members

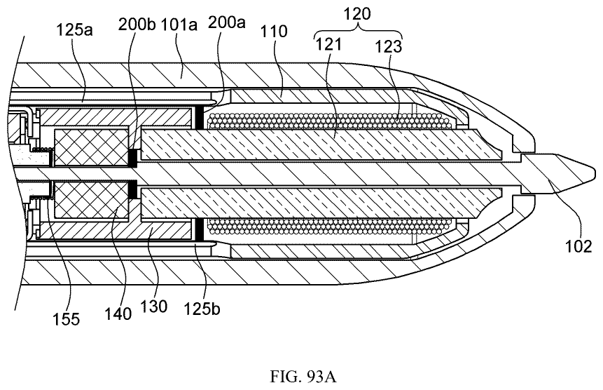

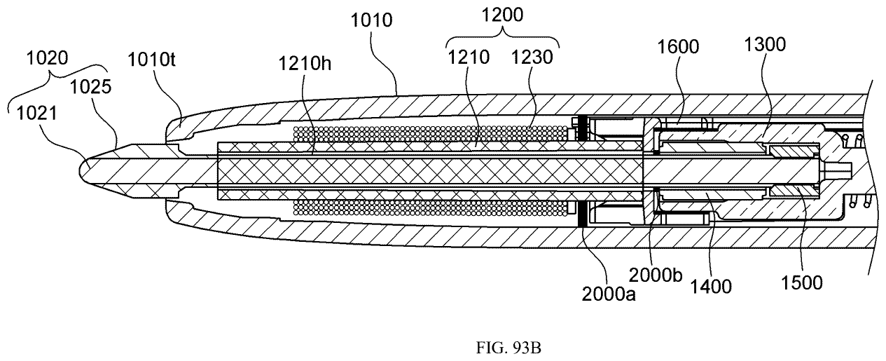

FIGS. 93A and 93B are views illustrating a state in which a first sealing member and a second sealing member is added to each of the stylus pens in FIGS. 85A to 86B.

As illustrated in FIG. 93A, the stylus pen 100 in FIGS. 85A and 85B may include a plurality of sealing members 200a, 200a′, and 200b capable of blocking a plurality of moisture ingress paths P1 and P2 passing through a core opening (not shown) of the housing 101. Specifically, the plurality of moisture ingress paths P1 and P2 may include a first moisture ingress path P1 and a second moisture ingress path P2. More specifically, the plurality of sealing members 200a, 200a′, and 200b may include a first sealing member 200a and 200a′ capable of blocking the first moisture ingress path P1 and a second sealing member 200b capable of blocking the second moisture ingress path P2. That is, the stylus pen 100 may block both the first moisture ingress path P1 and the second moisture ingress path P2 by the first sealing member 200a and 200a′ and the second sealing member 200b.

As illustrated in FIG. 93B, the stylus pen 1000 in FIGS. 86A and 86B may include a plurality of sealing members 2000a, 2000a′, and 2000b capable of blocking a plurality of moisture ingress paths P1′ and P2′ passing through a core opening (not shown) of the housing 1010. Specifically, the plurality of moisture ingress paths P1′ and P2′ may include a first moisture ingress path P1′ and a second moisture ingress path P2′. More specifically, the plurality of sealing members 2000a, 2000a′, and 2000b may include a first sealing member 2000a and 2000a′ capable of blocking the first moisture ingress path P1′ and a second sealing member 2000b capable of blocking the second moisture ingress path P2′. That is, the stylus pen 1000 may block both the first moisture ingress path P1′ and the second moisture ingress path P2′ by the first sealing member 2000a and 2000a′ and the second sealing member 2000b.

### Stylus Pen Including Sealing Member Having Contact Part

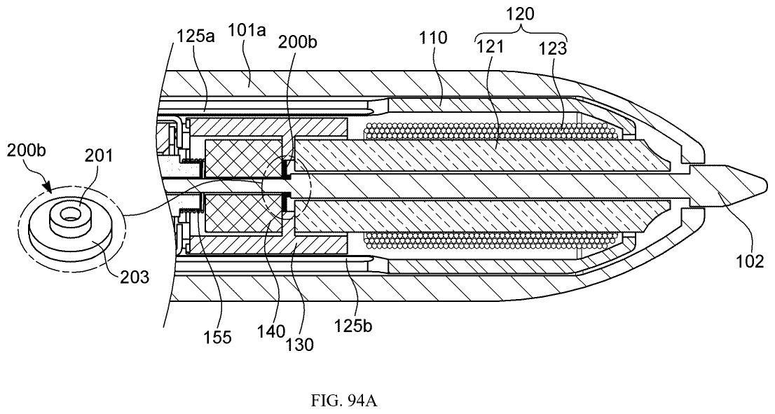

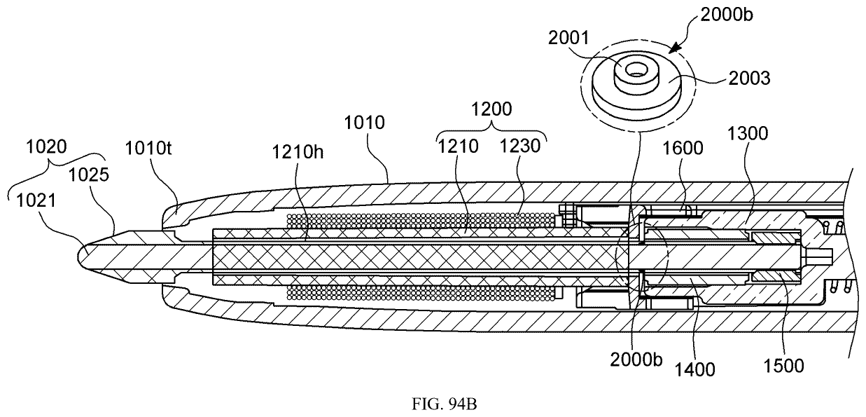

FIGS. 94A and 94B are views illustrating a modified example of the sealing member in FIGS. 91A to 92B.

As described above, the second sealing member 200b in FIGS. 91A and 91B may be disposed on the partition wall 132 so that the core 102 fills an outer portion of a through-hole 132h of the partition wall 132, which passes through the partition wall 132 of the first fixing member 130. Also, the second sealing member 200b may be in close contact with the core 102 at a portion at which the core 102 passes through the through-hole 132h of the partition wall 132. Accordingly, the second sealing member 200b may prevent moisture from entering through the second moisture ingress path P2. On the other hand, a detailed description on the first fixing member 130, the partition wall 132, and the through-hole 132h is the same as that described above.

As described above, the second sealing member 2000b in FIGS. 92A and 92B may be disposed on the partition wall 1611 so that the core 1020 fills an outer portion of a through-hole 1610 of the partition wall 1611, which passes through the partition wall 1611 of the fixing bracket 1600. Also, the second sealing member 2000b may be in close contact with the core 1020 at a portion at which the core 1020 passes through the through-hole 1610 of the partition wall 1611. Accordingly, the second sealing member 2000b may prevent moisture from entering through the second moisture ingress path P2′. On the other hand, a detailed description on the fixing bracket 1600, the partition wall 1611, and the through-hole 1610 is the same as that described above.

On the other hand, as illustrated in FIG. 94A, the second sealing member 200b of the stylus pen 100 in FIGS. 85A and 85B may include a sealing member body 203 and a contact part 201. Specifically, the sealing member body 203 may be disposed on the partition wall 132 to fill an outer portion of the through-hole 132h of the partition wall 132. More specifically, the contact part 201 may have a cylindrical shape with a height extending in a longitudinal direction of the core 102, and the second sealing member 200b may be in close contact with the core 102 at the contact part 201. Accordingly, the contact part 201 may maintain a close contact state with at least a portion of the core 102 when the core 102 is moved in the longitudinal direction of the core 102. That is, when the core 102 is moved in the longitudinal direction, the second sealing member 200b may prevent moisture entered through the second moisture ingress path P2 from passing through the through-hole 132h defined in the partition wall 132 of the first fixing member 130 by the contact part 201.

Also, as illustrated in FIG. 94B, the second sealing member 2000b of the stylus pen 1000 in FIGS. 86A and 86B may include a sealing member body 2003 and a contact part 2001. Specifically, the sealing member body 2003 may be disposed on the partition wall 1611 to fill an outer portion of the through-hole 1610 of the partition wall 1611. More specifically, the contact part 2001 may have a cylindrical shape with a height extending in the longitudinal direction of the core 1020, and the second sealing member 2000b may be in close contact with the core 1020 at the contact part 2001. Accordingly, the contact part 2001 may maintain a close contact state with at least a portion of the core 1020 when the core 1020 is moved in the longitudinal direction of the core 1020. That is, when the core 1020 is moved in the longitudinal direction, the second sealing member 2000b may prevent moisture entered through the second moisture ingress path P2′ from passing through the through-hole 1610 defined in the partition wall 1611 of the fixing bracket 1600 by the contact part 2001.

### Stylus Pen Including Buffer Member

Referring to FIGS. 42, 87A, 87B, 89A and 89B, the stylus pen 100 in FIGS. 85A and 85B may include a housing 101, a core 102, an inductor unit 120, a capacitor unit (not shown), a first fixing member 130, a buffer member 115, and a first sealing member 200a and 200a′. A detailed description on the housing 101, the core 102, the inductor unit 120, the capacitor unit (not shown), the first fixing member 130, and the first sealing member 200a and 200a′ is the same as that described above.

Specifically, the stylus pen 100 in FIGS. 85A and 85B may further include a buffer member 115 disposed between an inner surface of the housing 101 and the other end of the ferrite core 121. Here, the buffer member 115 may surround at least a portion of the other end of the ferrite core 121. Also, the buffer member 115 may be in close contact with the housing 101 and the other end of the ferrite core 121. Accordingly, the buffer member 115 may block a path in which moisture enters into the stylus pen 1000 through a core opening (not shown) of the housing 101.

As illustrated in FIGS. 37 to 40C, the other end of the ferrite core 121 may have a taper shape having a diameter or a width that gradually decreases in a direction toward an end thereof. Also, the other end of the ferrite core 121 may include at least one curved portion 121c having an outer surface that is curved inwardly. The other end of the ferrite core 121 when the other end of the ferrite core 121 includes the curved portion 121c may have a thickness less than that of the other end of the ferrite core 121 when the other end does not include the curved portion 121c.

Referring to FIGS. 67, 88A, 88B, 90A and 90B, the stylus pen 1000 may include a housing 1010, a core 1020, an inductor unit 1200, a capacitor unit (not shown), a fixing bracket 1600, a buffer member 1150, and a first sealing member 2000a and 2000a′. A detailed description on the housing 1010, the core 1020, the inductor unit 1200, the capacitor unit (not shown), the fixing bracket 1600, and the first sealing member 2000a and 2000a′ is the same as that described above.

Specifically, the stylus pen 1000 in FIGS. 86A and 86B may include a buffer member 1150 disposed between the inner surface of the housing 1010 and the other end of the ferrite core 1210. Here, the buffer member 1150 may surround at least a portion of the other end of the ferrite core 1210. Also, the buffer member 1150 may be in close contact with the housing 1010 and the other end of the ferrite core 1210. Accordingly, the buffer member 1150 may block a path in which moisture enters into the stylus pen 1000 through the core opening (not shown) of the housing 1010.

As illustrated in FIGS. 37 to 40c, the other end of the ferrite core 1210 may have a taper shape having a diameter or a width that gradually decreases in a direction toward an end thereof. Also, the other end of the ferrite core 1210 may include at least one curved portion 121c having an outer surface that is curved inwardly. The other end of the ferrite core 121 when the other end of the ferrite core 121 includes the curved portion 121c may have a thickness less than that of the other end of the ferrite core 121 when the other end does not include the curved portion 121c.

### Third Sealing Member

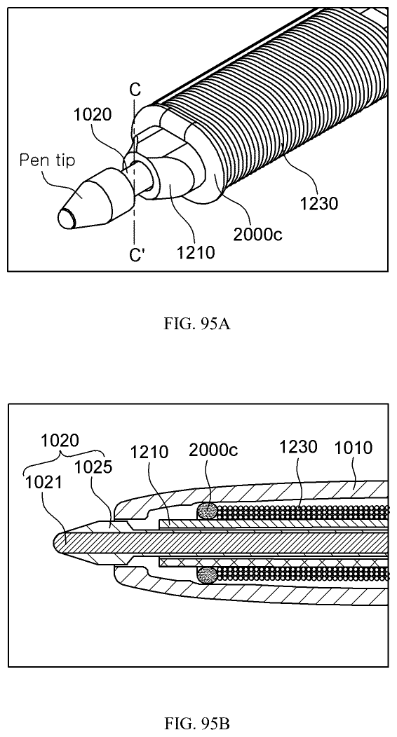

FIGS. 95A and 95B are views illustrating another embodiment of the sealing member for blocking the first moisture ingress path in the stylus pen in FIGS. 86A and 86B. Specifically, FIG. 95A is a partial perspective view illustrating a stylus pen including a third sealing member. Also, FIG. 95B is a partial cross-sectional view obtained by cutting FIG. 95A along line C-C′ in FIG. 95A.

As illustrated in FIGS. 95A and 95B, the stylus pen 1000 may include a third sealing member 2000c capable of blocking the first moisture ingress path P1′ in FIGS. 86A and 86B, which passes through a core opening (not shown) of the housing 1010.

As illustrated in FIG. 95A, the third sealing member 2000c may surround at least a portion of an outer surface of the ferrite core 1210. Specifically, the third sealing member 2000c may surround at least a portion of the outer surface of the ferrite core 1210 around the core opening (not shown). Although the third sealing member 2000c may be in contact with the coil 1230, the embodiment of the present disclosure is not limited thereto.

As illustrated in FIG. 95B, the third sealing member 2000c may be in close contact with the inner wall of the housing 1010. Thus, the third sealing member 2000c may prevent moisture from entering through the first moisture ingress path P1′ in FIGS. 86A and 86B.

### Buffer Member and Fourth Sealing Member

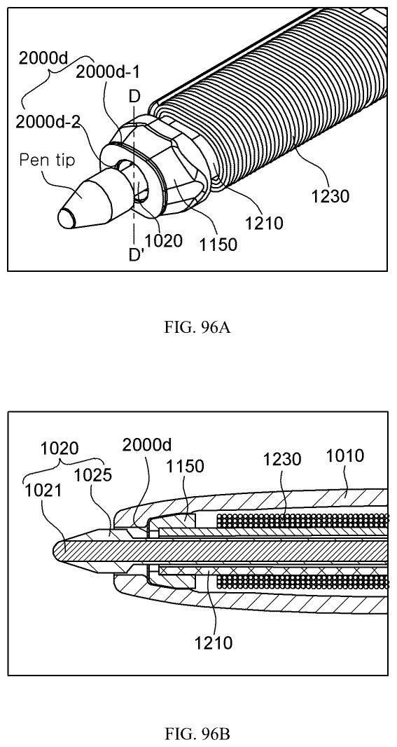

FIGS. 96A and 96B are views illustrating an embodiment of the buffer member for blocking the first moisture ingress path and the second moisture ingress path in the stylus pen in FIGS. 86A and 86B. Specifically, FIG. 96A is a partial perspective view illustrating the stylus pen including the buffer member. Also, FIG. 96B is a partial cross-sectional view obtained by cutting FIG. 96A along line D-D′ of FIG. 96A.

As illustrated in FIGS. 96A and 96B, the stylus pen 1000 may include a buffer member 1150. Specifically, the buffer member 1150 may surround at least a portion of an outer surface of each of the core 1020 and the ferrite core 1210 around the core opening (not shown). More specifically, the buffer member 1150 may include a predetermined hole (not shown). The buffer member 1150 may accommodate the core 1020 and the ferrite core 1210 through the predetermined hole (not shown).

As illustrated in FIG. 96A, the buffer member 1150 may include a fourth sealing member 2000d. Although the fourth sealing member 2000d may have a ring shape, the embodiment of the present disclosure is not limited thereto. The fourth sealing member 2000d may be coupled to one end disposed at the core opening (not shown) of the buffer member 1150.

More specifically, the fourth sealing member 2000d may block the first moisture ingress path P1′ in FIGS. 86A and 86B. As illustrated in FIG. 96B, an outer portion 2000d-1 of the fourth sealing member 2000d may be in close contact with the inner wall of the housing 1010. Thus, the fourth sealing member 2000d may prevent moisture from entering through the first moisture ingress path P1′.

Alternatively, the fourth sealing member 2000d may block the second moisture ingress path P2′ in FIGS. 86A and 86B. As illustrated in FIG. 96B, an inner portion 2000d′-2 of the fourth sealing member 2000d may be in close contact with the core 1020 and/or the ferrite core 1210. Thus, the fourth sealing member 2000d may prevent moisture from entering through the second moisture ingress path P2′. However, the embodiment of the present disclosure is not limited thereto. For example, the fourth sealing member 2000d may include the fourth sealing member 2000d having the inner portion 2000d′-2 that is spaced a predetermined distance from the core 1020 and/or the ferrite core 1210.

According to an embodiment of the present disclosure, the fourth sealing member 2000d may be coupled to one end of the buffer member 1150 as a separate component. Alternatively, the fourth sealing member 2000d may be coupled to one end of the buffer member 1150 and integrated with the buffer member 1150. However, the embodiment of the present disclosure is not limited thereto.

According to an embodiment of the present disclosure, the fourth sealing member 2000d may be formed at one end of the buffer member 1150 through a predetermined process. For example, the fourth sealing member 2000d may be formed through at least one process selected from the group consisting of a taping process and a coating process. However, the embodiment of the present disclosure is not limited thereto.

### Third Sealing Member, Buffer Member, and Fourth Sealing Member

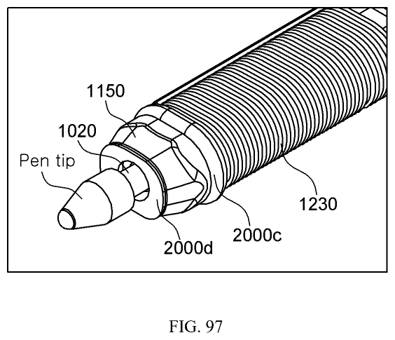

FIG. 97 is a view illustrating a stylus pen including the sealing member in FIGS. 95A and 95B and the buffer member in FIGS. 96A and 96B.

As illustrated in FIG. 97, the stylus pen 1000 may include the third sealing member 2000c and the buffer member 1150. The buffer member 1150 may include the fourth sealing member 2000d. Specifically, the fourth sealing member 2000d and the buffer member 1150 may be in contact with each other to surround at least a portion of the outer surface of each of the core 1020 or the ferrite core 1210 around the core opening (not shown). Thus, the third sealing member 2000c and the fourth sealing member 2000d may together prevent moisture from entering through the first moisture ingress path P1′ and the second moisture ingress path P2′.

### Third Moisture Ingress Path

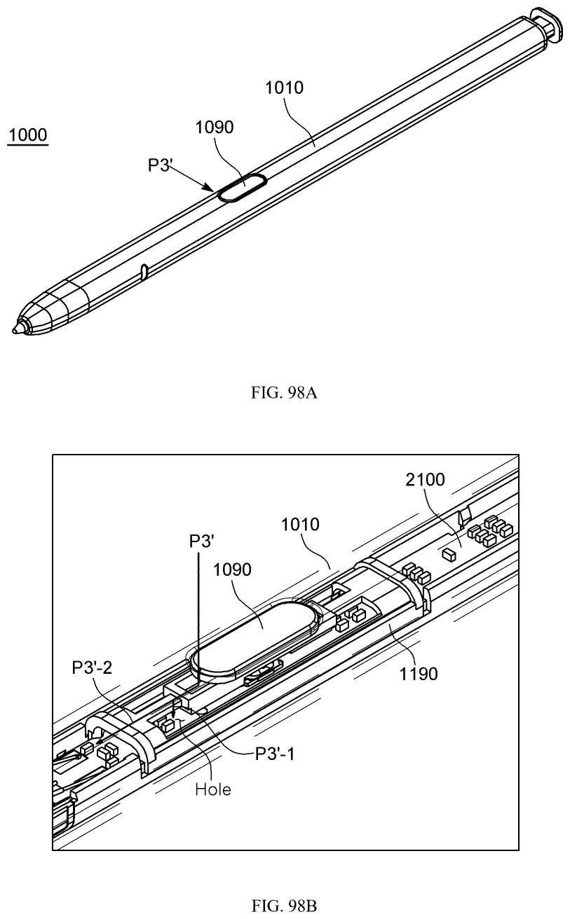

FIGS. 98A and 98B are views illustrating a third moisture ingress path in which moisture enters into the stylus pen in FIG. 34 through a button part. Specifically, FIG. 98A is a perspective view illustrating the stylus pen together with the third moisture ingress path. Also, FIG. 98B is a partial perspective view illustrating a state in which the housing is removed from FIG. 98A together with the third moisture ingress path.

As illustrated in FIGS. 98A and 98B, the stylus pen 1000 in FIG. 34 may include a button bracket 1190. Specifically, the button bracket 1190 is coupled with a substrate bracket 1900 to cover at least a portion of the substrate 2100 in the housing 1010. Also, the button bracket 1190 may have a predetermined groove (not shown) for being coupled with the button part 1090 to accommodate the button part 1090.

As illustrated in FIG. 98A, moisture may enter into the stylus pen 1000 in FIG. 34 through the third moisture ingress path P3′. Specifically, as illustrated in FIG. 98B, the third moisture ingress path P3′ may include a path P3′-1 that passes through a gap between the button part 1090 and the housing 1010 and extends until the substrate 2100 through a hole (not shown) defined in the button bracket 1190. Alternatively, the third moisture ingress path P3′ may include a path P3′-2 that passes the gap between the button part 1090 and the housing 1010 and extends until the substrate 2100 along an outer surface of the button bracket 1190.

### Fourth Moisture Ingress Path

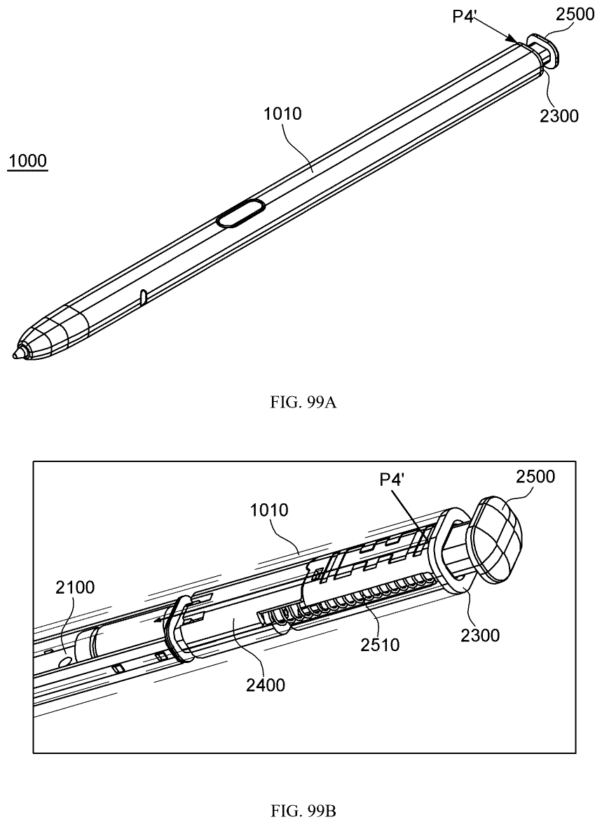

FIGS. 99A and 99B are views illustrating a fourth moisture ingress path in which moisture enters into the stylus pen in FIG. 34 through a coupled portion between a housing and a clicker housing. Specifically, FIG. 99A is a perspective view illustrating the stylus pen together with the fourth moisture ingress path. Also, FIG. 99B is a partial perspective view illustrating a state in which the housing is removed from FIG. 99A together with the fourth moisture ingress path.

As illustrated in FIGS. 99A and 99B, the stylus pen 1000 shown in FIG. 34 may include a clicker housing 2300, a clicker cover 2400, a clicker button 2500, and a clicker elastic member 2510.

Specifically, the clicker button 2500 may be inserted into a hole (not shown) defined in an end of the clicker housing 2300, which is disposed opposite to a pen tip. The clicker button 2500 may be designed to perform a specific motion of the stylus pen 1000. The clicker button 2500 may be pressed in a direction toward the core opening (not shown) by an external force.

Specifically, the clicker elastic member 2510 may have one end connected to the clicker button 2500. Also, the clicker elastic member 2510 may have the other end connected to the clicker housing 2300. When the clicker button 2500 is pressed in the direction toward the core opening (not shown), the clicker elastic member 2510 may be compressed to store elastic energy. When the force of pressing the clicker button 2500 is released, the clicker button 2500 is moved in a direction opposite to the core opening (not shown) by the elastic energy stored in the clicker elastic member 2510.

Specifically, the clicker cover 2400 and the clicker housing 2500 may surround the clicker button 2500 and the clicker elastic member 2510 in the housing 1010. The clicker housing 2500 may include a hole (not shown) for accommodating the clicker button 2500. Also, the clicker housing 2500 may be coupled to the clicker cover 2400. The clicker cover 2400 may be connected to the clicker housing 2500 through a predetermined fastening part (not shown) and coupled to an end of the substrate bracket 1900. On the other hand, as described above, a predetermined groove (not shown) may be formed in the clicker cover 2400 around a portion coupled to the substrate bracket 1900.

As illustrated in FIG. 99A, moisture may enter into the stylus pen 1000 in FIG. 34 through a fourth moisture ingress path P4′. Specifically, as illustrated in FIG. 99B, the fourth moisture ingress path P4′ passes through a coupled portion between the housing 1010 and the clicker housing 2300 and extends until the substrate 2100 along outer surfaces of the clicker housing 2300 and the clicker cover 2400.

### Packing Member

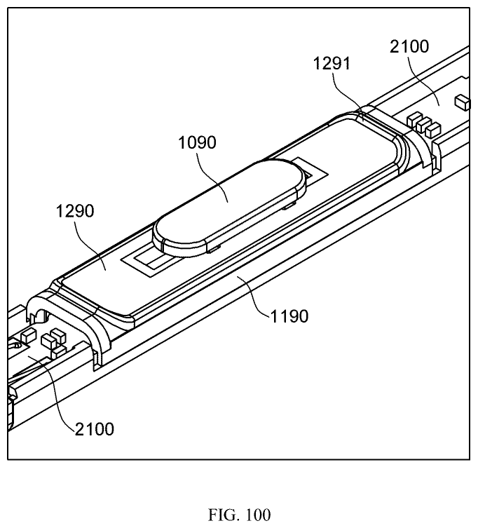

FIG. 100 is a view illustrating a packing member for blocking the third moisture ingress path in the stylus pen in FIGS. 98A and 98B.

As illustrated in FIG. 100, the stylus pen 1000 in FIG. 34 may include a packing member 1290. Specifically, the packing member 1290 may be coupled to the button bracket 1190 through a predetermined groove (not shown) defined in the button bracket 1190. Also, the packing member 1290 that is for blocking the third moisture ingress path P3′ in FIGS. 98A and 98B may cover the hole (not shown) defined in the button bracket 1190. The packing member 1290 may be in close contact with the button bracket 1190.

As illustrated in FIG. 100, the packing member 1290 may include a protrusion 1291 disposed at an edge thereof. Specifically, the protrusion 1291 may be in close contact with the inner wall of the housing 1010.

Thus, the packing member 1290 may prevent moisture from entering through the third moisture ingress path P3′, which passes the gap between the button part 1090 and the housing 1010 and extends until the substrate 2100 along the hole (not shown) defined in the button bracket 1190 or the outer surface of the button bracket 1190.

### Fifth Sealing Member

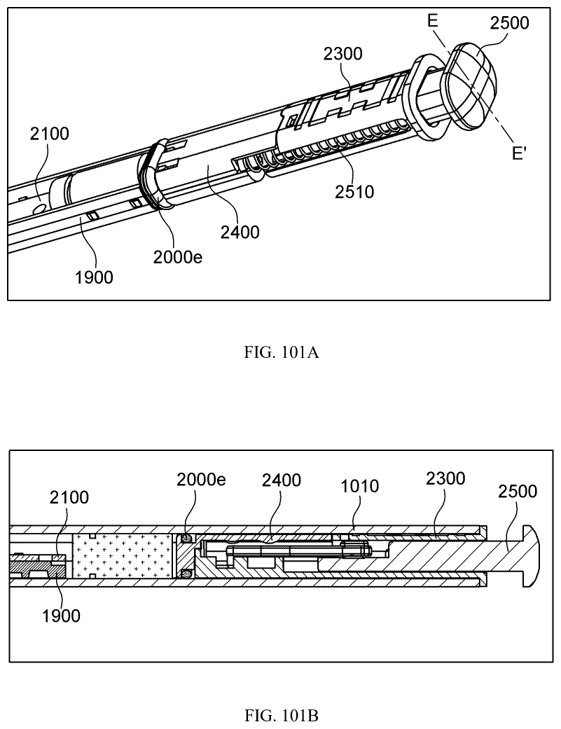

FIGS. 101A and 101B are views illustrating an embodiment of the sealing member for blocking the fourth moisture ingress path in the stylus pen in FIGS. 99A and 99B. Specifically, FIG. 10lA is a partial perspective view illustrating the sealing member in the stylus pen from which the housing is removed. Also, FIG. 101B is a partial cross-sectional view obtained by cutting FIG. 101A along line E-E′.

As illustrated in FIG. 10lA, the stylus pen 1000 in FIG. 34 may include a fifth sealing member 2000e for blocking the fourth moisture ingress path P4′ in FIGS. 99A and 99B. Specifically, the fifth sealing member 2000e may be disposed in a groove (not shown) defined in the clicker cover 2400 around a portion at which the clicker cover 2400 is coupled to the substrate bracket 1900. The fifth sealing member 2000e may surround an outer surface of the clicker cover 2400 in the groove (not shown) defined in the clicker cover 2400.

As illustrated in FIG. 101B, the fifth sealing member 2000e may be in close contact with the inner wall of the housing 1010 in FIG. 34. Accordingly, the fifth sealing member 2000e may prevent moisture from entering through the fourth moisture ingress path P4′.

### Embodiment of Stylus Pen Including a Plurality of Sealing Members

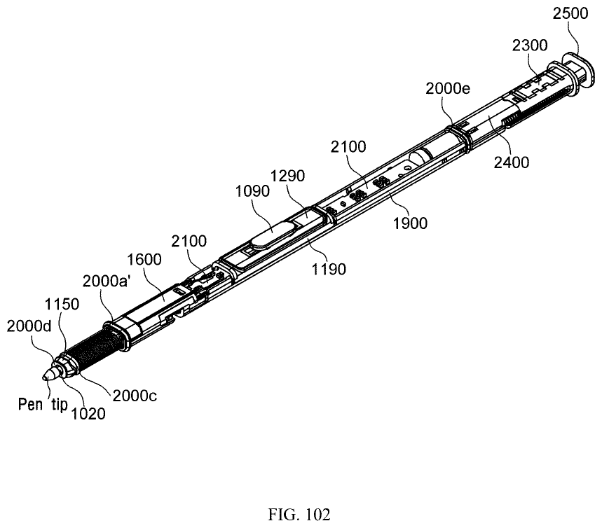

FIG. 102 is a view illustrating a plurality of waterproof units of the stylus pen in FIG. 34.

As illustrated in FIG. 102, the stylus pen 1000 in FIG. 34 may include a plurality of waterproof units. Specifically, the waterproof unit is for blocking a moisture ingress path into the stylus pen 1000.

For example, the moisture ingress path may include at least one path selected from the group consisting of the first moisture ingress path P1′, the second moisture ingress path P2′, the third moisture ingress path P3′, and the fourth moisture ingress path P4′, which are described above. However, the embodiment of the present disclosure is not limited thereto.

For example, the waterproof unit may include at least one selected from the group consisting of the first sealing members 2000a and 2000a′, the second sealing member 2000b, the third sealing member 2000c, the buffer member 1150 including the fourth sealing member 2000d, the fifth sealing member 2000e, and the packing member 1290. However, the embodiment of the present disclosure is not limited thereto.

As illustrated in FIG. 102, the stylus pen 1000 in FIG. 34 may include the first sealing member 2000a′, the third sealing member 2000c, the buffer member 1150 including the fourth sealing member 2000d, the packing member 1290, and the fifth sealing member 2000e. Accordingly, the stylus pen 1000 may prevent moisture from entering through the first moisture ingress path P1′, the second moisture ingress path P2′, the third moisture ingress path P3′, and the fourth moisture ingress path P4′.

As described above with reference to FIGS. 90A and 90B, the first sealing member 2000a′ may surround at least a portion of an outer surface of the fixing bracket 1600. Also, the first sealing member 2000a′ may be in close contact with the inner wall of the housing 1010. Accordingly, the first sealing member 2000a′ may prevent moisture from entering through the first moisture ingress path P1′.

As described above with reference to FIGS. 95A and 95B, the third sealing member 2000c may surround at least a portion of an outer surface of the ferrite core 1210. Specifically, the third sealing member 2000c may surround at least a portion of the outer surface of the ferrite core 1210 around the core opening (not shown). Although the third sealing member 2000c may be in contact with the coil 1230, the embodiment of the present disclosure is not limited thereto.

Also, the third sealing member 2000c may be in close contact with the inner wall of the housing 1010. Thus, the third sealing member 2000c may prevent moisture from entering through the first moisture ingress path P1′.

As described above with reference to FIGS. 96A and 96B, the stylus pen 1000 may include the buffer member 1150. Specifically, the buffer member 1150 may surround at least a portion of an outer surface of each of the core 1020 and the ferrite core 1210 around the core opening (not shown).

Also, the buffer member 1150 may include the fourth sealing member 2000d. Although the fourth sealing member 2000d may have a ring shape, the embodiment of the present disclosure is not limited thereto. The fourth sealing member 2000d may be coupled to one end disposed at the core opening (not shown) of the buffer member 1150.

More specifically, the fourth sealing member 2000d may block the first moisture ingress path P1′. As illustrated in FIG. 96B, the outer portion 2000d-1 of the fourth sealing member 2000d may be in close contact with the inner wall of the housing 1010. Thus, the fourth sealing member 2000d may prevent moisture from entering through the first moisture ingress path P1′.

Also, the fourth sealing member 2000d may block the second moisture ingress path P2′. As illustrated in FIG. 96B, the inner portion 2000d′-2 of the fourth sealing member 2000d may be in close contact with the core 1020 and/or the ferrite core 1210. Thus, the fourth sealing member 2000d may prevent moisture from entering through the second moisture ingress path P2′.

According to an embodiment of the present disclosure, the fourth sealing member 2000d may be coupled to one end of the buffer member 1150 as a separate component. Alternatively, the fourth sealing member 2000d may be coupled to one end of the buffer member 1150 and integrated with the buffer member 1150. However, the embodiment of the present disclosure is not limited thereto.

According to an embodiment of the present disclosure, the fourth sealing member 2000d may be formed at one end of the buffer member 1150 through a predetermined process. For example, the fourth sealing member 2000d may be formed through at least one process selected from the group consisting of a taping process and a coating process. However, the embodiment of the present disclosure is not limited thereto.

As described above with reference to FIG. 100, the stylus pen 1000 shown in FIG. 34 may include a packing member 1290. Specifically, the packing member 1290 may be coupled to the button bracket 1190 through a predetermined groove (not shown) defined in the button bracket 1190. Also, the packing member 1290 that is for blocking the third moisture ingress path P3′ may block a hole (not shown) defined in the button bracket 1190. The packing member 1290 may be in close contact with the button bracket 1190.

Also, the packing member 1290 may include a protrusion 1291 formed at an edge thereof. Specifically, the protrusion 1291 may be in close contact with the inner wall of the housing 1010.

Thus, the packing member 1290 may prevent moisture from entering through the third moisture ingress path P3′, which passes the gap between the button part 1090 and the housing 1010 and extends until the substrate 2100 along the hole (not shown) defined in the button bracket 1190 or the outer surface of the button bracket 1190.

As described above with reference to FIGS. 101A and 101B, the stylus pen 1000 shown in FIG. 34 may include a fifth sealing member 2000e for blocking the fourth moisture ingress path P4′. Specifically, the fifth sealing member 2000e may be disposed in a groove (not shown) defined in the clicker cover 2400 around a portion at which the clicker cover 2400 is coupled to the substrate bracket 1900. The fifth sealing member 2000e may surround an outer surface of the clicker cover 2400 in the groove (not shown) defined in the clicker cover 2400.

Also, the fifth sealing member 2000e may be in close contact with the inner wall of the housing 1010. Accordingly, the fifth sealing member 2000e may prevent moisture from entering through the fourth moisture ingress path P4′.

When the electronic device according to the embodiment of the present invention is used, additional sensor for driving and/or sensing the stylus pen is not required.

Also, the double routing may be performed.

Also, the number of channels between the touch controller and the sensor unit capable of simultaneously sensing the object and the stylus pen may be reduced.

Also, The function of the stylus pen may be supported in the outer touch screen in addition to the inner touch screen.

When the ferrite core according to the embodiment of the present invention and the stylus pen including the same are used, the stylus pen may be optimized to the housing having the specific shape.

Also, the magnitude of the pen signal received by the receiver may be improved.

Also, the hover state and the contact state of the stylus pen may be clearly distinguished.

Also, the magnetic body may be synchronized with the movement of the core body.

Also, the electrical components may be electrically connected without using the inner wire.

Also, the stylus pen may be miniaturized.

Also, the inductor unit may be stably accommodated in the housing.

Also, the stylus pen may perform the drawing even in the state of being inclined at a predetermined angle.

The stylus pen according to the embodiment of the present disclosure may block the plurality of moisture ingress paths of the stylus pen to realize the waterproof function.

Also, the stylus pen may realize the additional effect of blocking the moisture ingress path by using the special shape of the sealing member.

Also, the stylus pen may minimize the size of the buffer member that performs both the buffer function and the waterproof function.

Features, structures, and effects described in the above embodiments are incorporated into at least one embodiment of the present disclosure, but are not limited to only one embodiment. Moreover, features, structures, and effects exemplified in one embodiment can easily be combined and modified for another embodiment by those skilled in the art. Therefore, these combinations and modifications should be construed as falling within the scope of the present disclosure. Moreover, features, structures, and effects exemplified in one embodiment can easily be combined and modified for another embodiment by those skilled in the art. Therefore, these combinations and modifications should be construed as falling within the scope of the present invention.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An input system comprising:
an electronic device including a sensor unit and a controller configured to control the sensor unit; and
a stylus pen configured to interact with the electronic device,
wherein the sensor unit comprises:
a plurality of first patterns extending in a first direction, wherein both ends of each of the plurality of first patterns are electrically connected to the controller;
a plurality of second patterns extending in a second direction different from the first direction so as to cross the plurality of first patterns, wherein at least one of both ends of each of the plurality of second patterns is electrically connected to the controller; and
a plurality of third patterns extending in the second direction, wherein each of the plurality of third patterns is disposed adjacent to a respective one of the plurality of second patterns, and wherein one ends of the plurality of third patterns are electrically connected to each other,
wherein the stylus pen comprises:
a core body disposed inside a housing and configured to move along a longitudinal direction of the housing by an external force applied to one end of the core body;
an inductor unit including a ferrite core fixedly disposed inside the housing and having a through-hole through which the core body passes, and a coil wound around an outer surface of the ferrite core;
a capacitor unit electrically connected to the inductor unit to form a resonant circuit; and
a magnetic body coupled to the other end of the core body inside the housing and configured to move in conjunction with the core body,
wherein an inductance of the inductor unit is configured to vary as a distance between the magnetic body and the ferrite core increases due to the external force acting on the one end of the core body,
wherein the controller is configured to apply a touch driving signal to the plurality of first patterns and receive a touch sensing signal from the plurality of second patterns,
wherein the controller is configured to apply a stylus pen driving signal to at least one pattern among the plurality of first to third patterns, and
wherein the controller is configured to receive stylus pen sensing signals from at least one pattern among the plurality of first to third patterns.

2. The input system of claim 1,
wherein the other ends of the plurality of third patterns of the sensor unit are electrically floating or electrically connected to the controller.

3. The input system of claim 1,
wherein at least two of the other ends of the plurality of third patterns of the sensor unit are connected in parallel to each other and electrically connected to the controller.

4. The input system of claim 1,
wherein the electronic device further comprises a display panel on which the sensor unit is disposed,
wherein the display panel includes an active area in which the plurality of first patterns, the plurality of second patterns, and the plurality of third patterns are disposed, and a dead space disposed at one side of the active area, and
wherein the sensor unit further comprises at least one uplink channel disposed in the dead space,
wherein the uplink channel includes:
an uplink trace extending in the first direction; and
a connection trace connecting the uplink trace to the controller.

5. The input system of claim 1,
wherein the ferrite core has a first cross-sectional shape in a first vertical direction perpendicular to the longitudinal direction, and a second cross-sectional shape in a second vertical direction perpendicular to both the longitudinal direction and the first vertical direction,
wherein the first cross-sectional shape is different from the second cross-sectional shape,
wherein the ferrite core includes a curved portion disposed at one end of the ferrite core, and
wherein the curved portion includes at least two curved surfaces curved in a direction toward the through-hole from one side surface of the one end of the ferrite core to a portion adjacent to the through-hole of the ferrite core.

6. The input system of claim 1, wherein the stylus pen further comprises:
a moving part configured to cover at least a portion of the other end of the core body inside the housing, and configured to operate in conjunction with the core body to be synchronized with a movement of the core body;
a fixed part fixedly disposed inside the housing, coupled to the other end of the ferrite core, and configured to provide a space therein in which the moving part is movable;
a protection member disposed inside the moving part, surrounding the other end of the core body together with the magnetic body, and configured to press the core body between the core body and the moving part;
an elastic member fixedly disposed within the space of the fixed part; and
an elastic body made of a conductive material and disposed between the moving part and the elastic member within the space of the fixed part.

7. The input system of claim 1, wherein the stylus pen further comprises:
a moving part configured to cover at least a portion of the other end of the core body inside the housing, and configured to operate in conjunction with the core body to be synchronized with a movement of the core body; and
a fixed part fixedly disposed inside the housing, coupled to the other end of the ferrite core, and configured to provide a space therein in which the moving part is movable,
wherein the fixed part includes a pair of electrode patterns disposed on an outer surface thereof to face each other, and
wherein the moving part includes an electrode pattern configured to come into contact with the pair of electrode patterns or be spaced apart from the pair of electrode patterns according to the movement of the core body.

8. The input system of claim 1,
wherein the stylus pen further comprises a moving part configured to cover at least a portion of the other end of the core body inside the housing, and configured to operate in conjunction with the core body to be synchronized with a movement of the core body,
wherein a resonant frequency of the resonant circuit changes according to a movement of the moving part synchronized with the movement of the core body, and
wherein, at a timing when a hover state and a contact state of the stylus pen are distinguished, a capacitance of the capacitor unit is configured to change relatively more dominantly than the inductance of the inductor unit.

9. The input system of claim 1,
wherein the stylus pen further comprises at least one sealing member configured to block a plurality of moisture inflow paths passing through a core body opening of the housing.

10. The input system of claim 9,
wherein the plurality of moisture inflow paths include:
a first moisture inflow path through which moisture flows into the stylus pen through a space between the housing and the inductor unit after passing through the core body opening of the housing; and
a second moisture inflow path through which moisture flows into the stylus pen through the through-hole of the ferrite core after passing through the core body opening of the housing, and
wherein the at least one sealing member comprises:
a first sealing member configured to block the first moisture inflow path; and
a second sealing member configured to block the second moisture inflow path.

11. The input system of claim 10,
wherein the first sealing member is disposed to surround at least a portion of an outer surface of the ferrite core and is disposed in close contact with an inner wall of the housing.

12. The input system of claim 10,
wherein the stylus pen further comprises a fixing bracket fixedly disposed inside the housing and coupled to one end of the ferrite core, and
wherein the first sealing member is disposed to surround at least a portion of an outer surface of the fixing bracket and is disposed in close contact with an inner wall of the housing.

13. The input system of claim 10,
wherein the stylus pen further comprises a fixing bracket fixedly disposed inside the housing and coupled to one end of the ferrite core,
wherein the fixing bracket includes a partition wall contacting the ferrite core, and
wherein the second sealing member is disposed on the partition wall to fill an outside of a through-hole of the partition wall through which the core body passes, and is disposed in close contact with the core body at a portion where the core body passes through the through-hole of the partition wall.

14. The input system of claim 1,
wherein the stylus pen comprises a sealing member configured to block a path through which moisture flows into the stylus pen through the through-hole of the ferrite core after passing through a core body opening of the housing.

15. The input system of claim 14,
wherein the stylus pen further comprises a fixing bracket fixedly disposed inside the housing and coupled to one end of the ferrite core,
wherein the fixing bracket includes a partition wall contacting the ferrite core,
wherein the sealing member is disposed on the partition wall to fill an outside of a through-hole of the partition wall through which the core body passes, and is disposed to be in close contact with the core body at a portion where the core body passes through the through-hole of the partition wall,
wherein the sealing member includes a contact portion having a cylindrical shape with a height in the longitudinal direction of the core body, and is disposed to be in close contact with the core body at the contact portion, and
wherein the contact portion maintains a state of being in close contact with the core body at at least a portion thereof when the core body moves in the longitudinal direction.

16. The input system of claim 1, wherein the stylus pen comprises:
a buffer member disposed between an inner surface of the housing and the other end of the ferrite core, and disposed to surround at least a portion of the other end of the ferrite core; and
a sealing member capable of blocking a path through which moisture flows into the stylus pen through a space between the housing and the inductor unit after passing through a core body opening of the housing.

17. The input system of claim 16,
wherein the buffer member is disposed to be in close contact with the housing and the other end of the ferrite core.

18. The input system of claim 17,
wherein the sealing member is disposed to surround an outer surface of the ferrite core and is disposed in close contact with an inner wall of the housing.

19. The input system of claim 1, wherein the stylus pen comprises:
a buffer member disposed between the housing and the other end of the ferrite core, disposed to surround at least a portion of the other end of the ferrite core, and including a fourth sealing member at one end thereof,
wherein an outer periphery of the buffer member is disposed in close contact with an inner wall of the housing.

20. The input system of claim 19,
wherein the fourth sealing member is taped or coated on one surface of the buffer member.

21. The input system of claim 19,
wherein an inner periphery of the fourth sealing member is disposed to be in close contact with the core body or the ferrite core, or is spaced apart therefrom by a predetermined distance.

22. The input system of claim 19, wherein the stylus pen comprises:
a third sealing member disposed to surround at least a portion of an outer surface of the ferrite core and to be in close contact with the housing,
wherein the third sealing member is disposed to abut the coil.

23. The input system of claim 19, wherein the stylus pen comprises:
a fixing bracket fixedly disposed inside the housing and coupled to one end of the ferrite core; and
a first sealing member disposed to surround at least a portion of an outer surface of the fixing bracket and disposed in close contact with the housing.

24. The input system of claim 19, wherein the stylus pen comprises:
a button unit disposed on an outer surface of the housing;
a button bracket fixedly disposed inside the housing and coupled to the button unit; and
a packing member coupled to the button bracket and disposed in close contact with the button bracket.

25. The input system of claim 19, wherein the stylus pen comprises:
a board bracket fixedly disposed inside the housing and surrounding the capacitor unit;
a clicker button configured to move along the longitudinal direction by an external force acting on one end thereof,
a clicker housing having one end coupled to the housing and disposed to surround the clicker button inside the housing;
a clicker cover connecting the board bracket and the clicker housing inside the housing; and
a fifth sealing member disposed to surround a predetermined groove formed in the clicker cover in a vicinity of a portion where the clicker cover and the board bracket are coupled,
wherein the fifth sealing member is disposed in close contact with the housing.
